(19) United States
(12) Patent Application Publication
(10) Pub. No.: US 2007/0099146 A1
(43) Pub. Date: May 3, 2007

(54) SYSTEM AND METHOD FOR POSITIONING ORTHODONTIC BRACKETS ON A VIRTUAL MODEL OF A PATIENT'S TEETH

(76) Inventor: Brian C. Reising, Atlanta, GA (US)

Correspondence Address: GARDNER GROFF SANTOS & GREENWALD, P.C., 2018 POWERS FERRY ROAD, SUITE 800, ATLANTA, GA, 30339, US

(21) Appl. No.: 11/566,925

(22) Filed: Dec. 5, 2006

Related U.S. Application Data
(63) Continuation-in-part of application No. 10/749,918, filed on Dec. 31, 2003.
Application No. 10/749,918 is a continuation-in-part of application No. 10/750,194, filed on Dec. 31, 2003.
(60) Provisional application No. 60/437,546, filed on Dec. 31, 2002.
(60) Provisional application No. 60/742,311, filed on Dec. 5, 2005.

(51) Int. Cl. A61C 3/00

(52) U.S. Cl. 433/24

(57) ABSTRACT

A computer-based system and method facilitate placing virtual orthodontic brackets with respect to a virtual model of a set of teeth. The teeth are displayed for the user, who places reference points, lines, or other reference features on the depiction, such as interproximal contact points, cusp tip points, tangent lines that define facio-lingual angles, etc. The system then computes a position of the virtual model with respect to a reference system of three mutually perpendicular (X, Y and Z) axes from the reference points, lines or other reference features. The brackets can then be positioned in accordance with the reference system. The system generates data representing the positions of the brackets with respect to the virtual model. That data can be output in the form of a data file. In addition, that data can be used to generate a data file representing a virtual model of a transfer tray conforming to the set of teeth. The transfer tray data file can then be used as input to a rapid prototyping machine to enable the machine to make a real transfer tray. A transfer tray made in this manner has voids with slot-like portions in which the real (non-virtual) brackets are to be received so that the brackets can be transferred to the patient's mouth and adhered to the teeth.

### CROSS-REFERENCE TO RELATED APPLICATIONS

This application is a continuation-in-part of U.S. patent application Ser. No. 10/749,918, filed Dec. 31, 2003, entitled “ORTHODONTIC BRACKET AND METHOD OF ATTACHING ORTHODONTIC BRACKETS TO TEETH,” and U.S. patent application Ser. No. 10/750,194, filed Dec. 31, 2003, entitled “ORTHODONTIC BRACKET POSITIONING DEVICE AND METHOD,” both of which claim the priority benefit of U.S. Provisional Patent Application Ser. No. 60/437,546, filed Dec. 31, 2002, and this application claims the priority benefit of U.S. Provisional Patent Application Ser. No. 60/742,311, filed Dec. 5, 2005, entitled “ORTHODONTIC BRACKET AND METHOD OF ATTACHING ORTHODONTIC BRACKETS TO TEETH,” which in their entireties are herein incorporated by reference. Co-pending U.S. patent application Ser. No. ______, filed Dec. 5, 2006, entitled “ORTHODONTIC BRACKET AND METHOD OF ATTACHING ORTHODONTIC BRACKETS TO TEETH,” is related by subject matter.

### TECHNICAL FIELD

The present invention relates generally to dentistry and orthodontics and, in particular, to positioning orthodontic brackets to be attached to teeth for repositioning the teeth.

### BACKGROUND OF THE INVENTION

Orthodontists commonly correct the position of mal-occluded and mal-aligned teeth by therapeutic tooth movement. Therapeutic tooth movement is accomplished by the application of force to teeth to reposition them. Many orthodontic appliances have been used to apply force to teeth. The most commonly used orthodontic appliance for tooth movement is commonly known as the “edgewise appliance” or more specifically the “fixed pre-adjusted edgewise appliance”—also known as the “straight-wire appliance.” The name “edgewise” refers to the general mechanism of a rectangular slot engaged by a force-generating rectangular wire. The terms “straight-wire”, “pre-adjusted”, and “pre-programmed” refer to an elective, though highly desirable, feature of an edgewise appliance system that will be described as follows.

An edgewise appliance system is a combination of many individual pieces designed to function in a coordinated fashion. The two primary components are tooth “attachments” that are attached to the teeth and “arch-wires” that engage the attachments. The attachments (brackets or bands) are semi-permanently and rigidly attached to the teeth. Typically, the attachments are fabricated of stainless steel, porcelain (ceramic), plastic, or combinations of these materials. The attachments serve as a standardized “handle” by which the tooth may be engaged by a force.

Each attachment in a system (generally referred to as a “bracket”) possesses a rectangular slot that receives the arch-wire component. Typically, all the attachments of a particular system will have the same rectangular slot dimensions of about 0.018×0.025 inches, 0.020×0.025 inches or 0.022×0.025 inches. Some operators prefer to use a combination of various size slots. The slot shape is rectangular to accommodate a wire with a rectangular or square cross section, which permits application of forces and hence control of tooth position in three dimensions.

Typically, arch-wires are made of metal alloys capable of varying degrees of elastic deflections depending on their size, cross-sectional shape, and composition. The elastic deflections in the arch-wire generate forces on the brackets, which in turn translate the forces to the teeth, thereby causing the teeth to move to a desired position.

The human teeth are arranged spatially in the upper or lower jaw (the maxillary or mandibular dental arches respectively) in the shape of an arch with their long axes generally perpendicular to the plane of the arch. The precise shape of the arch varies among individuals from more U-shaped arches to V-shaped arches to parabolic arch forms. The precise shape of any particular arch can vary substantially.

Given that the teeth are naturally arranged in this relatively flat-plane arch-form, it is commonly recognized as an objective of orthodontic therapy that this plane should be made relatively flat and that the teeth should be aligned precisely to form an arch-form shape that is similar (but improved) to the pre-existing condition of the dentition. To serve this objective, the “straight-wire”, “pre-adjusted”, or “pre-programmed” concept of appliance design was derived as a means of executing orthodontic therapy with greater ease, efficiency, and quality. The basic concept of “straight-wire” is that, if the objective of orthodontic therapy is to position teeth in a flat plane, then the force generated by elastic deformations in a flat, straight wire shaped in the form of an arch is an ideal mechanism for producing those results. In theory, the attachments are rigidly fixed to teeth at a precise “pre-adjusted” or “pre-programmed” position on the mid-facial or lingual aspect of a tooth at their respective mal-aligned state. A straight (flat) arch-shaped wire is then deflected to engage the mal-aligned attachments slots. The force generated by the elastic deformation of the wire then “pulls” the teeth along with it as it moves back towards its original shape. The attachment position on each tooth then determines the ultimate and final relative position of each tooth relative to the other teeth upon achievement of the “straight-wire” condition (the theoretical end-point).

Traditionally, the vast majority of orthodontic therapy has been performed with attachment slots placed primarily on the facial aspect of the teeth. It can be readily deduced via casual observation of an arch of teeth that the mid-facial aspects of an arch of teeth tend to align in a straight, flat arch form. However, it is also readily observed upon closer inspection that these mid-facial surfaces do not exactly line up in a straight line with their long axes residing at identical orientations. In fact, one can readily observed consistent deviations in the spatial relations of an arch of tooth crowns and roots. Each tooth type tends to deviate in a specific consistent “average” way relative to the horizontal plane. As such, early pioneers of appliance design theorized that compensations in bracket slot orientation relative to the bracket base could automatically compensate for these differences.

They also realized that the anatomy among types of teeth (upper right central incisor, versus, for instance, an upper right canine, etc.) varies substantially. But because this anatomy is consistent among different individuals for each tooth type, each tooth type, therefore, could receive its own uniquely shaped “average” bracket slot and base orientation. This pre-defined shape can theoretically be used on a particular tooth type for any particular individual. Thus, while the general shape of a bracket system might be very similar, for each particular tooth type the corresponding bracket is designed with specific compensations in base shape, base size, general shape, slot angulation, base thickness, etc. to accommodate differences in tooth type anatomy and tooth type spatial relations relative to the horizontal plane.

The intention of these design specifications was to create a universally applicable appliance that will, if brackets positions are accurately coordinated, create an ideal alignment of teeth if a straight wire is deflected into each slot and if the wire is subsequently permitted to express its original straight shape. By doing so, the operator would possess a pre-programmed mechanical system. Having realized a truly pre-programmed system, theoretically, the operator could eliminate the need for manual manipulation of the system (via the placement of compensating bends in the arch-wire component) and thus produce a highly predictable and efficient outcome.

However, as mentioned, the efficient utilization of a so-called straight-wire appliance depends largely on the orthodontist's ability to coordinate the position of the brackets on mal-aligned teeth so that the forces imposed by deflections of the resilient, straight, arch-wire will result in perfect three-dimensional alignment of the teeth. If the brackets are not properly positioned, then the degree of mal-positioning will be reflected as a proportional degree of mal-positioning of the teeth. Correcting these mal-positions would then require the operator to manually manipulate the shape of the arch-wire component via the placement of compensating arch-wire bends. This is recognized as a comparatively laborious, slow, unpredictable, and inefficient method.

Most orthodontists position the brackets on the patient's teeth using a “direct” method. “Direct” refers to the positioning of each bracket on each tooth directly, inside the patient's mouth. But when working directly inside the mouth it is very difficult to visualize precise bracket positioning and extremely cumbersome to utilize measuring instruments for determining vertical position. Because accurate positioning is so difficult, getting the bracket “close enough” is widely regarded as an acceptable compromise. Because precise positioning of an entire arch of brackets is the exception rather than the norm, the result is a huge compromise in treatment quality and efficiency.

To improve the accuracy of bracket positioning in a typical private practice setting, “indirect” positioning methods have been developed. Rather than positioning brackets directly inside the patient's mouth, the brackets are positioned on a three-dimensional model of the patient's teeth, outside the patient's mouth. In this way, improved visualization and the utilization of measuring devices are permitted, so accurate positioning becomes much more simple and attainable. Once the brackets are positioned on the model and rigidly attached, a “transfer tray” is fabricated and utilized to transfer the brackets from the model to the patient's mouth. The tray preserves the brackets position during the transfer. There are a number of known variations of indirect methods, including those described in U.S. Pat. No. 5,971,754 to Sondhi et al. and U.S. Pat. No. 4,952,142 to Nicholson, which are hereby incorporated herein by reference.

There are drawbacks to conventional bracket systems, regardless of the attachment method used. Typical brackets (both facial and lingual types) are composed of two basic structures. The first, a broad, flat base. Second, is a structure(s) protruding perpendicular to the base that forms the “open face” rectangular slot and the “tie-wings” that are used to anchor a disposable ligature that, in turn, maintains engagement of the wire component in the slot.

Generally, with a facial or lingual bracket system, all anterior and premolar brackets are designed with an open-face slot that allows the arch-wire component to be inserted into the slot along a facio-lingual vector. This bracket design requires the presence of tie-wings to engage and maintain engagement of the wire component. Because of the necessity of tie-wings, these brackets must possess a certain degree of structural profile height and shape irregularity that facilitates overall effectiveness and simple operation of the ligature/tie-wing ligation system by the operator.

Generally, with a facial or lingual bracket system, it is also common to use a tube attachment on molar teeth, rather than an open-face-slot bracket design. The tube type of attachment receives the arch-wire component via threading of the wire through the mesial or distal ends of the tube. This type of attachment has the benefit of not requiring the protruding, bulky, irregularly shaped tie-wings that are required of an open-face design. However, their applications are limited to the posterior teeth due to the necessity of threading the wire through the mesial or distal ends. It would be an impractical endeavor to attempt threading an arch-shaped wire through an entire dental arch starting from the most distal molar. Not only would the wire initial need to extend into the patients throat but the lack of a continuously consistent degree of curvature of the wire segment would preclude insertion of a wire of significant stiffness. In addition, the closed-face tube attachment precludes the placement of significant arch-wire bends, therefore, it is only practical if the attachment system is positioned with high precision and coordination.

As such, conventional bracket systems are designed to accommodate one bracket per tooth on either the facial or lingual side, but, as a practical matter, not both. They use open-face slots on anterior and most premolar teeth with tube attachments on the molar teeth. Note that many tube attachments designed for molars are also designed with a removable facial wall that allows the tube to be converted into an open-face bracket. Such designs also require the presence of tie-wings to hold the wire in place once the tube is converted to an open-face bracket.

The relatively large flat base characteristic of most conventional brackets serves several purposes. First, the relatively flat base is intended to rest against each tooth parallel to a tangent plane at the center of its mid-facial surface. This allows the operator the opportunity to use the surface of the tooth as a means of reference for establishing the properly coordinated position of each bracket—the operator simply must fully seat the bracket base against the tooth at its mid-facial surface. Doing so orients the slot at its recommended three-dimensional pre-programmed (pre-coordinated) position. Second, the base serves as the bonding interface for rigid attachment to the tooth. As such, the “tooth-side” of the base generally possesses mechanical retentive features (such as a mesh pad, particle micro-etched surface, laser-etched surface, etc.) that facilitates durable bonding to the tooth by facilitating mechanical interlocking between an adhesive and the bracket via penetration of the adhesive into the retentive features. Some brackets, depending on their material composition, may also possess a base that bonds chemically to an adhesive. The base is relatively flat and large to provide a sufficient surface area for creating a durable bond to the tooth.

But a base of any substantial length compromises the ability to custom-coordinate positioning of a bracket in particular ways. For example, if the operator desires to place the slot at an alternative facio-lingual angle, the base interferes and creates an undesirable lever arm that necessitates displacement of the slot in an unfavorable way, a greater distance from the tooth surface. As such, to achieve coordination of the remaining bracket slots would require positioning them with an equal degree of offset away from the tooth surface. Moreover, with the bracket now positioned farther from the tooth, that is, creating a higher, more protruding profile, the bracket is more prominent and protruding so as to physically annoy a patient. And even when the bracket can be positioned with the base flat against the tooth, the width of conventional brackets alone makes them comparably protrusive, when most patients would prefer them to be minimally protrusive.

In addition, because lingual side tooth anatomy is more highly variable among individual tooth types compared with facial side anatomy, using a “base-dependent” positioning system to achieve a “straight-wire” result is even less efficient than the traditional facial bracket system. That is, a “fixed bracket shape with a base” designed for the lingual tooth surface is remarkably less efficient at achieving coordination of slot positions such that a straight wire could then deflect the teeth to the desired positions. Because of this inefficiency, greater effort and greater unpredictability are realized by the operator who attempts to bend arch-wire to compensate for poorly coordinated lingual bracket slots.

If an operator desires the efficiency of a straight wire mechanical system to be used on the lingual side of teeth, this requires the ability to customize slot position for each patient. While this can theoretically be accomplished using a traditional bracket with a base and protruding tie-wings, the degree of protrusion and irregularity of shape (roughness) creates substantial discomfort for the patient. For this reason and others, lingual bracket systems have seen only very limited applications in orthodontics.

In addition, the desirability of adjustability has lead to the predominant use of open-faced slots. In fact, open-faced slots are a practical necessity because of the obvious problem that a wire possessing compensating bends of significant size cannot be threaded through tubes of small cross-section and the obvious problems with insertion of full-length arch-wires through a closed-face bracket system. But with open-faced slots, the arch-wires must be secured, which is conventionally done by using ligature tie-wings. And the tie-wings create a relatively bulky, high profile bracket system and generally result in a highly irregular surface against which lips, cheeks, and tongue will rub and create discomfort.

Because of the cost associated with the vast inventory of brackets required, most operators use a manufacturer-specified shape (not a shape customized to the unique dental anatomy of the patient) for each tooth. Existing brackets do not allow for minimizing the profile and protuberances, which would create a far more comfortable lingual bracket system. The necessity of having tie-wings to engage ligature ties for the purpose of holding the wire engaged in the slot means that uncomfortably large, irregular protuberances are unavoidable.

To address the above-described problems and deficiencies of the prior art, the assignee of the present invention has developed a novel orthodontic appliance and method, as described in co-pending U.S. patent application Ser. No. 10/749,918, filed Dec. 31, 2003, entitled “ORTHODONTIC BRACKET AND METHOD OF ATTACHING ORTHODONTIC BRACKETS TO TEETH,” and U.S. patent application Ser. No. ______, filed Dec. 5, 2006, entitled “ORTHODONTIC BRACKET AND METHOD OF ATTACHING ORTHODONTIC BRACKETS TO TEETH,” the specifications of which are incorporated by reference into this patent specification (“herein”). In the novel appliance, a series of orthodontic attachments, each having a body with an opening that extends the length of the body, are attached to the teeth along a selected dentition segment and receive a wire through the openings. Some of the attachments can be attached to lingual surfaces of the front teeth, while others, such as those applied to back teeth, can be attached to the lingual or facial tooth surfaces. The body of the novel bracket does not have a base with a significant surface area to facilitate use of a direct method of positioning and bonding to the tooth, as in the prior art, but rather has sidewalls that define a slotted opening. As the bracket does not possess a base that would facilitate direct positioning, an indirect method of precise positioning relative to a model tooth's anatomic features has been developed that avoids any part of the bracket creating a significant lever arm that would cause the bracket to have a higher effective profile. In exemplary embodiments of the bracket, the body has a gingival sidewall, an occlusal sidewall, and a lingual sidewall that together form the above-mentioned slotted opening, with the open side facing the tooth after positioning on the model or actual tooth. The bracket has a very a low profile with a width that is equal to the depth of the opening plus the thickness of the lingual sidewall. The bracket can not only be positioned against or adjacent to the tooth but, alternatively, can be positioned offset from it. A blob or mass of adhesive can serve to both attach the bracket to the tooth and encapsulate it in a manner that positions it against or, alternatively, offset from the tooth. In an offset position, the bracket is actually suspended in the adhesive mass, thereby allowing great freedom in positioning it in three-dimensional space with respect to the tooth. These features are all described in the above-referenced co-pending patent applications and are therefore not described in similar detail herein.

Methods for using the appliance and its constituent elements are likewise described in the above-referenced co-pending patent applications. One such exemplary method includes the steps of creating a model of the teeth and providing orthodontic brackets with openings for the wire, and then positioning the brackets relative to the model teeth, occluding the bracket openings using novel clips, bonding the brackets to the model teeth with an adhesive, fabricating a transfer tray by applying an impression material to the model teeth and the brackets, removing the tray containing the impression material and the brackets from the model teeth with the brackets held in position by the impression material, positioning the tray with the brackets on the teeth, bonding the brackets to the teeth with an adhesive, removing the tray from the brackets and teeth, and unoccluding the bracket openings by removing the clips. Upon the completion of the method, the adhesive is bonded to the teeth, preferably using the same adhesive, and the brackets are embedded in the adhesive with the openings unobstructed.

It would be desirable to provide a computer-based system and computer-implemented method for positioning the brackets relative to model teeth to facilitate making a corresponding transfer tray. The present invention addresses such problems and deficiencies and others in the manner described below.

### SUMMARY OF THE INVENTION

The present invention relates to positioning orthodontic brackets with respect to a virtual model of a set of teeth. The virtual model of a set of teeth can be provided to a computing system by, for example, well-known methods and systems that scan the patient's teeth or a model or impression of the patient's teeth. With the aid of the computing system, operating in accordance with suitable software, reference features or landmarks are determined on the teeth and then used to compute the position of the virtual model with respect to a reference system, such as a system of three mutually perpendicular (e.g., X, Y and Z) axes. The bracket slots can then be positioned with respect to the reference system with six degrees of freedom, at any position along the X, Y and Z axes and in any rotational position with respect to each axis. Such freedom from constraints allows a bracket slot to be positioned, for example, offset from the teeth, such that it is essentially suspended in free space and does not contact the teeth.

In an exemplary embodiment, the user (e.g., an orthodontist) can work on a tooth-by-tooth basis, until a reference system is determined for each tooth. The computing system can display a depiction of at least the tooth on which the user is working and, in an exemplary embodiment, a depiction of a plurality of teeth, such as those of a user-defined segment of teeth. In the exemplary embodiment, the user can use an input device such as a mouse to place reference points, lines, or other markings on reference features of the tooth, such as interproximal contact points, cusp tip points, tangent lines that define facio-lingual angles, etc. The computing system can compute a reference system from the positions of the reference features as marked by the user.

Each bracket (or portion thereof, such as a slot) is positioned with respect to a corresponding reference system and the position recorded in a data file. For example, the X, Y and Z coordinates of points on or in the bracket can be recorded. In an exemplary embodiment, the center point of the bracket slot is recorded. The computing system can also use the reference system and reference features to describe properties of the teeth, such as torque, offset, width values, etc.

The computing system can perform some or all of the steps in an automated manner, such as computing the reference system in response to the reference features, positioning the bracket slots, etc. Alternatively or in addition, some steps can be performed with minimal aid of the computing system. For example, the user can use a mouse, joystick or other input device or can type in numerical coordinates to position or re-position a bracket.

The computing system generates data representing the positions of brackets (or portions thereof, such as slots) with respect to the virtual model. Although that data can itself be output in the form of a data file, in an exemplary embodiment of the invention that data is then used to generate a data file comprising data representing a virtual model of a transfer tray conforming to the set of teeth and the positioned brackets. That data file can then be used, for example, as input to a rapid prototyping machine to enable the machine to make a transfer tray. A transfer tray made in this manner has voids with slot-like portions in which the real (non-virtual) brackets or bracket assemblies (including any clips or other elements that are to be included along with the brackets) are to be received so that the resulting arrangement of attachments can be transferred to the patient's mouth and adhered to the teeth.

The specific techniques and structures employed by the invention to improve over the drawbacks of the prior devices and accomplish the advantages described herein will become apparent from the following detailed description of the exemplary embodiments of the invention and the appended drawings and claims.

### BRIEF DESCRIPTION OF THE DRAWINGS

FIG. 1 is a block diagram of an exemplary computing system for positioning orthodontic brackets with respect to a virtual model of a set of teeth.

FIG. 2 is a flow diagram, illustrating an exemplary method for positioning orthodontic brackets with respect to a virtual model of a set of teeth.

FIG. 3 illustrates a screen display for adjusting the dentition.

FIG. 4 illustrates a display for defining segments of teeth and selecting a tooth on which to work.

FIG. 5 illustrates a first screen display for defining reference features on a selected tooth in accordance with a first protocol.

FIG. 6 illustrates a second screen display for defining reference features on a selected tooth in accordance with the first protocol.

FIG. 7 illustrates a third screen display for defining reference features on a selected tooth in accordance with the first protocol.

FIG. 8 illustrates a fourth screen display for defining reference features on a selected tooth in accordance with the first protocol.

FIG. 9 illustrates a fifth screen display for defining reference features on a selected tooth in accordance with the first protocol.

FIG. 10 illustrates a sixth screen display for defining reference features on a selected tooth in accordance with the first protocol.

FIG. 11 illustrates a seventh screen display for defining reference features on a selected tooth in accordance with the first protocol.

FIG. 12 illustrates an eighth screen display for defining reference features on a selected tooth in accordance with the first protocol.

FIG. 13 illustrates an ninth screen display for defining reference features on a selected tooth in accordance with the first protocol.

FIG. 14 illustrates an tenth screen display for defining reference features on a selected tooth in accordance with the first protocol.

FIG. 15 illustrates a screen display for selecting main menu options in accordance with the exemplary method.

FIG. 16 is a perspective view of an exemplary orthodontic bracket.

FIG. 17 is a side view of the exemplary orthodontic bracket of FIG. 16 positioned with respect to a three-axis reference system for a tooth.

FIG. 18 illustrates a screen display for selecting bracket positioning options in accordance with the exemplary method.

FIG. 19 illustrates a first screen display for defining reference features on a selected tooth in accordance with a second protocol.

FIG. 20 illustrates a second screen display for defining reference features on a selected tooth in accordance with the second protocol.

FIG. 21 illustrates a third screen display for defining reference features on a selected tooth in accordance with the second protocol.

FIG. 22 illustrates a fourth screen display for defining reference features on a selected tooth in accordance with the second protocol.

FIG. 23 illustrates a fifth screen display for defining reference features on a selected tooth in accordance with the second protocol.

FIG. 24 illustrates a sixth screen display for defining reference features on a selected tooth in accordance with the second protocol.

FIG. 25 illustrates a seventh screen display for defining reference features on a selected tooth in accordance with the second protocol.

FIG. 26 illustrates an eighth screen display for defining reference features on a selected tooth in accordance with the second protocol.

FIG. 27 illustrates a ninth screen display for defining reference features on a selected tooth in accordance with the second protocol.

FIG. 28 illustrates a first screen display for defining reference features on a selected tooth in accordance with a third protocol.

FIG. 29 illustrates a second screen display for defining reference features on a selected tooth in accordance with the third protocol.

FIG. 30 illustrates a third screen display for defining reference features on a selected tooth in accordance with the third protocol.

FIG. 31 illustrates a fourth screen display for defining reference features on a selected tooth in accordance with the third protocol.

FIG. 32 illustrates a fifth screen display for defining reference features on a selected tooth in accordance with the third protocol.

FIG. 33 illustrates a sixth screen display for defining reference features on a selected tooth in accordance with the third protocol.

FIG. 34 illustrates a seventh screen display for defining reference features on a selected tooth in accordance with the third protocol.

FIG. 35 illustrates an eighth screen display for defining reference features on a selected tooth in accordance with the third protocol.

FIG. 36 illustrates a ninth screen display for defining reference features on a selected tooth in accordance with the third protocol.

FIG. 37 illustrates a tenth screen display for defining reference features on a selected tooth in accordance with the third protocol.

FIG. 38 illustrates a eleventh screen display for defining reference features on a selected tooth in accordance with the third protocol.

FIG. 39 illustrates a twelfth screen display for defining reference features on a selected tooth in accordance with the third protocol.

FIG. 40 illustrates a first screen display for defining reference features on a selected tooth in accordance with a fourth protocol.

FIG. 41 illustrates a second screen display for defining reference features on a selected tooth in accordance with the fourth protocol.

FIG. 42 illustrates a third screen display for defining reference features on a selected tooth in accordance with the fourth protocol.

FIG. 43 illustrates a fourth screen display for defining reference features on a selected tooth in accordance with the fourth protocol.

FIG. 44 illustrates a fifth screen display for defining reference features on a selected tooth in accordance with the fourth protocol.

FIG. 45 illustrates a sixth screen display for defining reference features on a selected tooth in accordance with the fourth protocol.

FIG. 46 illustrates a seventh screen display for defining reference features on a selected tooth in accordance with the fourth protocol.

FIG. 47 illustrates an eighth screen display for defining reference features on a selected tooth in accordance with the fourth protocol.

FIG. 48 illustrates a ninth screen display for defining reference features on a selected tooth in accordance with the fourth protocol.

FIG. 49 illustrates a tenth screen display for defining reference features on a selected tooth in accordance with the fourth protocol.

FIG. 50 illustrates a eleventh screen display for defining reference features on a selected tooth in accordance with the fourth protocol.

FIG. 51 illustrates a twelfth screen display for defining reference features on a selected tooth in accordance with the fourth protocol.

FIG. 52 illustrates a first screen display for defining reference features on a selected tooth in accordance with a fifth protocol.

FIG. 53 illustrates a second screen display for defining reference features on a selected tooth in accordance with the fifth protocol.

FIG. 54 illustrates a third screen display for defining reference features on a selected tooth in accordance with the fifth protocol.

FIG. 55 illustrates a fourth screen display for defining reference features on a selected tooth in accordance with the fifth protocol.

FIG. 56 illustrates a fifth screen display for defining reference features on a selected tooth in accordance with the fifth protocol.

FIG. 57 illustrates a sixth screen display for defining reference features on a selected tooth in accordance with the fifth protocol.

FIG. 58 illustrates a seventh screen display for defining reference features on a selected tooth in accordance with the fifth protocol.

FIG. 59 illustrates an eighth screen display for defining reference features on a selected tooth in accordance with the fifth protocol.

FIG. 60 illustrates a ninth screen display for defining reference features on a selected tooth in accordance with the fifth protocol.

FIG. 61 illustrates a tenth screen display for defining reference features on a selected tooth in accordance with the fifth protocol.

FIG. 62 illustrates a eleventh screen display for defining reference features on a selected tooth in accordance with the fifth protocol.

FIG. 63 illustrates a twelfth screen display for defining reference features on a selected tooth in accordance with the fifth protocol.

FIG. 64 illustrates a thirteenth screen display for defining reference features on a selected tooth in accordance with the fifth protocol.

FIG. 65 illustrates a screen display of a virtual transfer tray model.

### DETAILED DESCRIPTION OF EXEMPLARY EMBODIMENTS

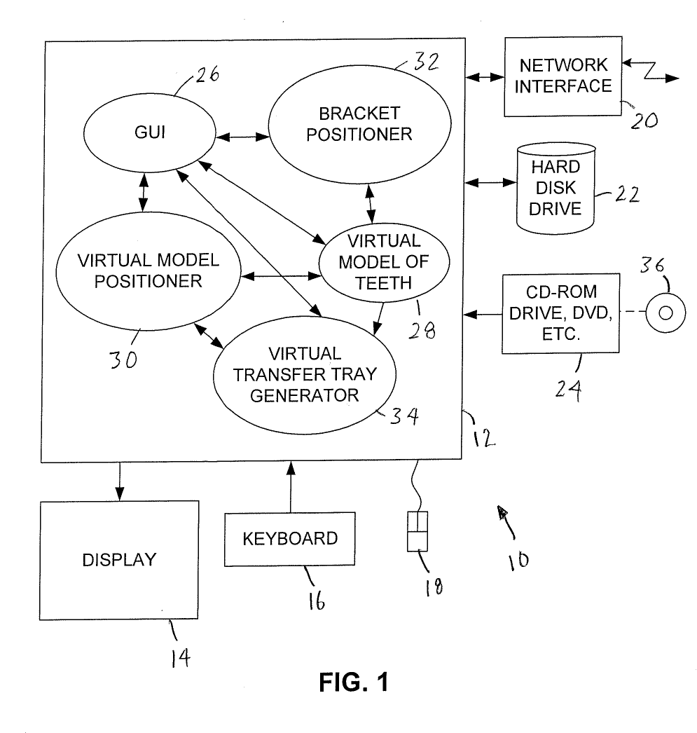

As illustrated in FIG. 1, in an exemplary embodiment of the present invention, an exemplary computing system 10 can be used by an orthodontist or other user to position orthodontic brackets with respect to a virtual model of a set of teeth. Three-dimensional (3D) computer modeling, manipulation and rendering of solid objects is well understood by persons skilled in the art to which the invention relates, and therefore the underlying principles, manipulation algorithms, data structures, etc., are not described in detail herein. Computing system 10 can comprise a general-purpose computer such as a personal computer. Such a computing system 10 includes a programmed processor system 12, a display 14, a keyboard 16, mouse 18 or similar pointing device, network interface 20, fixed-medium data storage device 22 such as a magnetic disk drive, and a removable-medium data storage device 24 such as a CD-ROM or DVD drive. Other elements commonly included in personal computers can also be included but are not shown for purposes of clarity. Although not shown individually for purposes of clarity, programmed processor system 12 includes one or more processors, memories and other logic that together define the overall computational and data manipulation power of computing system 10.

Although in the exemplary embodiment of the invention computing system 10 comprises a personal computer or similar general-purpose computer, in other embodiments it can comprise any other suitable system. In some embodiments, portions of such a computing system can be distributed among a number of networked computers. It should be noted that software elements, described below, can be stored in a distributed manner and retrieved via network interface 20 from multiple sources on an as-needed basis. Similarly, they can be stored on multiple disks or other media and retrieved or otherwise loaded into computing system 10 on an as-needed basis.

The methods of the invention, described below, are largely effected through the operation of programmed processor system 12 operating under control of suitable application software. Conceptually illustrated as stored in or otherwise residing in programmed processor system 12 are the following software elements: a graphical user interface 26, a virtual model of a patient's teeth 28, a reference system generator 30, a bracket positioner 32, and a virtual transfer tray generator 34. As persons skilled in the art to which the invention relates can appreciate, these software elements are shown in this conceptual manner for purposes of illustration and may not reside in memory simultaneously or in their entireties. Rather, in the manner in which computers are known to operate, the software elements or portions thereof can be retrieved on an as-needed basis from storage devices 22 or 24 or from a remote computer or storage device (not shown) via network interface 20. Also, in other embodiments of the invention the functions of software elements 26, 28, 30, 32 and 34 can be distributed over a greater number of elements or, alternatively, combined or condensed into fewer elements. Additional software elements commonly included in computing systems, such as an operating system (e.g., MICROSOFT WINDOWS), utilities, device drivers, etc., are included but not shown for purposes of clarity. In view of the descriptions herein, persons skilled in the art will readily be capable of providing suitable software and otherwise programming or configuring computing system 10 to perform the methods described herein.

A user can work locally at computing system 10 (using display 14, keyboard 16, mouse 18, etc.) as described herein for purposes of clarity. Alternatively, or in addition, a user can use computing system 10 as a server computer, where the user controls the system from a remote client computer (not shown) connected to computing system 10 via network interface 20 and a network such as the Internet. Other arrangements, such as distributed arrangements in which various inter-networked elements of the system are located in various places, will also occur readily to persons skilled in the art in view of the teachings herein.

Virtual model 28 represents the set of teeth or dentition of a patient to whom the orthodontic therapy is to be applied. As used herein, the term “virtual” means simulated in electronic form by computer or similar digital means. For example, virtual model 28 refers to a data set that describes the patient's set of teeth in three dimensions and is stored in a manner accessible to computing system 10. Such a 3D model is sometimes referred to in the art as a solid model. Persons skilled in the art to which the invention relates will appreciate that various 3D modeling schemes are known in the art and that any suitable scheme can be employed in embodiments of the invention. As known in the art, such schemes can be based upon 3D representation concepts such as constructive solid geometry, boundary representation, spatial decomposition (e.g., voxels) and other well-known ways in which 3D objects can be represented in a computing system.

Virtual model 28 can be generated by direct or indirect three-dimensional (3D) scanning methods and systems, as described in co-pending U.S. patent application Ser. No. ______, filed Dec. 5, 2006, entitled “ORTHODONTIC BRACKET AND METHOD OF ATTACHING ORTHODONTIC BRACKETS TO TEETH.” Generally speaking, a physical impression of the patient's teeth is made, and a physical model of the patient's teeth is made from the impression. Then, a conventional digital 3D scanner and 3D modeling software are used to scan the model and generate the 3D virtual model 28 of the patient's teeth. (Alternatively, the impression itself could be scanned as an equivalent “negative” representation of the patient's teeth without using it to make a “positive” model.) The physical impression and model are typically made by the orthodontist and sent to a third party service provider who scans the physical model to create the virtual model 28. Then the service provider stores the virtual model 60 on a computer-readable medium (e.g., in a server computer) so that it can be accessed by the orthodontist. For example, the virtual model 28 can be stored on a computer server (not shown) that is connected to the Internet and downloadable or transmittable to computing system 10 via network interface 20. Alternatively, it can be stored on a CD-ROM 36 or other portable data storage medium and received by the orthodontist via overnight delivery.

In conventional direct 3D scanning methods, the virtual model 28 of the patient's teeth can also be digitally generated by scanning the teeth directly or “intra-orally.” This technique eliminates the need to make the impression of the patient's teeth and the physical model from the impression. Several systems exist for making direct intra-oral scans. One such commercially available system is provided by ORAMETRIX, Inc. of Dallas, Tex. under the brand SURESMILE. This system includes a scanner that requires coating the teeth with a powder to create a more opaque surface for scanning. Another such system has been demonstrated by CADENT, Inc. of Or Yehuda, Israel under the brand ORTHOCAD.

The orthodontist or other user can interact with computing system 10 through graphical user interface (GUI) 26 in a conventional manner. GUI 26 can operate in accordance with standard windowing and graphical user interface protocols supported by MICROSOFT WINDOWS or similar operating system. That is, the user can manipulate (e.g., open, close, resize, minimize, etc.) windows on display 14, launch application software that executes within one or more windows, and interact with pictures, icons and graphical control structures (e.g., buttons, checkboxes, pull-down menus, etc.) on display 14 using mouse 18, keyboard 16 or other input devices. For example, under software control, the user can use mouse 18 to position a cursor (not shown) on something displayed on display 14 and press (“click”) the mouse button to select it, hold the mouse button down to move (“drag”) it to another location on the screen, etc., as well known in the art. What is displayed within a window under control of an application program is generally referred to herein as a screen or screen display of the application program.

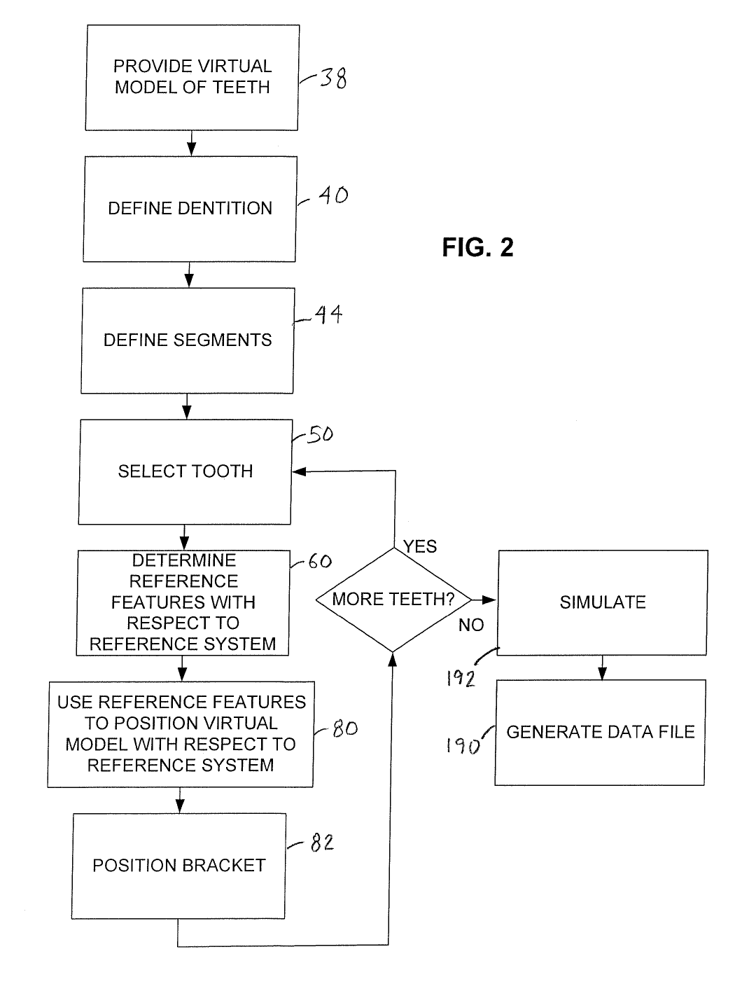

A method for positioning orthodontic brackets with respect to virtual model 28 is illustrated by the steps shown in FIG. 2. As noted above, the method is primarily effected through the operation of programmed processor system 12 (FIG. 1) operating under control of an application program (software). In view of the descriptions herein, persons skilled in the art to which the invention relates will readily be capable of creating or otherwise providing suitable software. The method begins when the user causes the software to begin executing.

The preliminary step 38 of providing virtual model 28 has been described above. The user can be prompted through GUI 26 (FIG. 1) to load or otherwise select a virtual model (data file) on which to work. Other preliminary steps of the types commonly performed by users of interactive software applications, such as setting up options, customizing user preferences, etc., are similarly not shown but can be included.

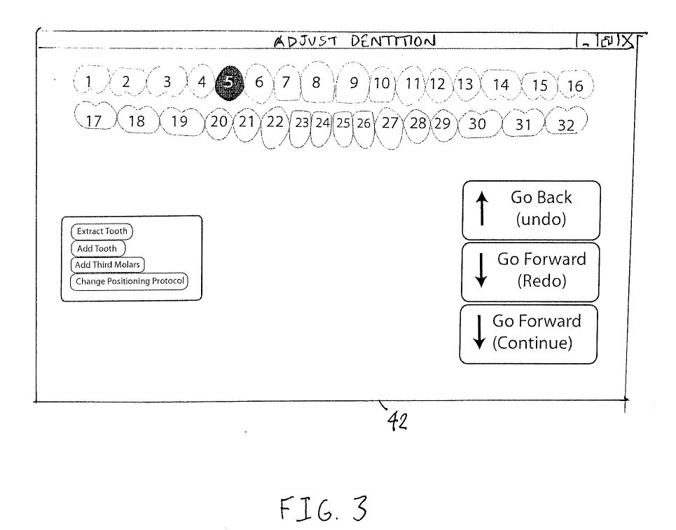

At step 40 (FIG. 2), a screen 42 is displayed through which the user can define the patient's dentition, as illustrated in FIG. 3. The normal set of 32 teeth is displayed, and the user can click on buttons to “Extract Tooth,” “Add Tooth,” “Add Third Molar,” and “Change Positioning Protocol.” The first three of these operations allow the user to adjust the dentition of virtual model 28 to account for, for example, a patient's missing teeth. The last option, “Change Positioning Protocol,” is explained below. “Undo” and “Redo” buttons are also provided to allow the user to make corrections to the operations performed. A tooth is highlighted, e.g., displayed in a different color from the other teeth, when the user clicks on it. When the user has finished adjusting the dentition, the user can click on a “Continue” button to proceed to the next step. Alternatively, as described below, a main menu can be provided through which the user can jump to any step without regard to any order of the steps. It should be noted that, unless clearly dictated otherwise by the context, the method steps that are described herein can be performed in any suitable order. The order in which they are described herein is intended only to be exemplary.

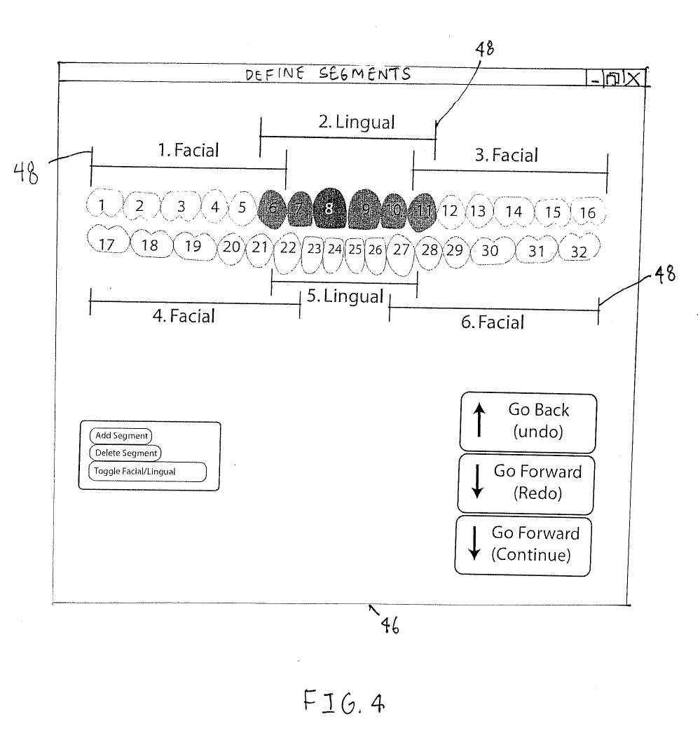

At step 44 (FIG. 2), a screen 46 is displayed through which the user can define a segment, i.e., a series of teeth to which an arch wire is to be applied, as illustrated in FIG. 4. In the exemplary embodiment, the user works on a segment-by-segment basis, selecting one segment at a time on which to work. The user can divide the dentition into as many or as few segments as judged appropriate. The user can click on buttons to “Add Segment,” “Delete Segment,” and toggle the displayed view of the teeth between a facial view and a lingual view. Initially, a default set of six segments is displayed, as illustrated in FIG. 4. However, the user can drag the endpoints 48 of the lines indicating the segments (and any others corresponding to segments that the user may add) to stretch or shrink the defined segments, i.e., to include more teeth or fewer teeth in a segment. “Undo” and “Redo” buttons are also provided to allow the user to make corrections to the operations performed. A segment is highlighted, e.g., the teeth of that segment are displayed in a different color from those of the other segments, when the user clicks on it or adjusts its endpoints 48. When the user has finished defining segments, the user can click on a “Continue” button to proceed to the next step.

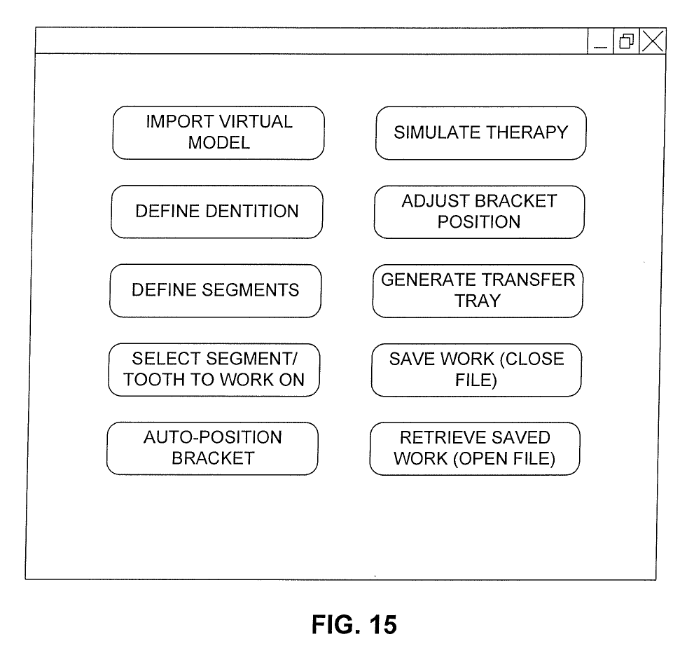

Note that other possible menu and screen navigation options are not shown in these exemplary screen displays for purposes of clarity, and that to enhance user convenience, additional buttons can be provided through which a user can, at any time, opt to, for example, return to a previous screen or previous step or jump to another step. Similarly, an option can be provided to enable the user to save his work so that he can stop and then later pick up where he left off. For example, a user can define the dentition at step 40, save his work (i.e., save and close a data file), and later open the saved file and continue with step 44. A screen offering such options is shown in FIG. 15 and described in further detail below.

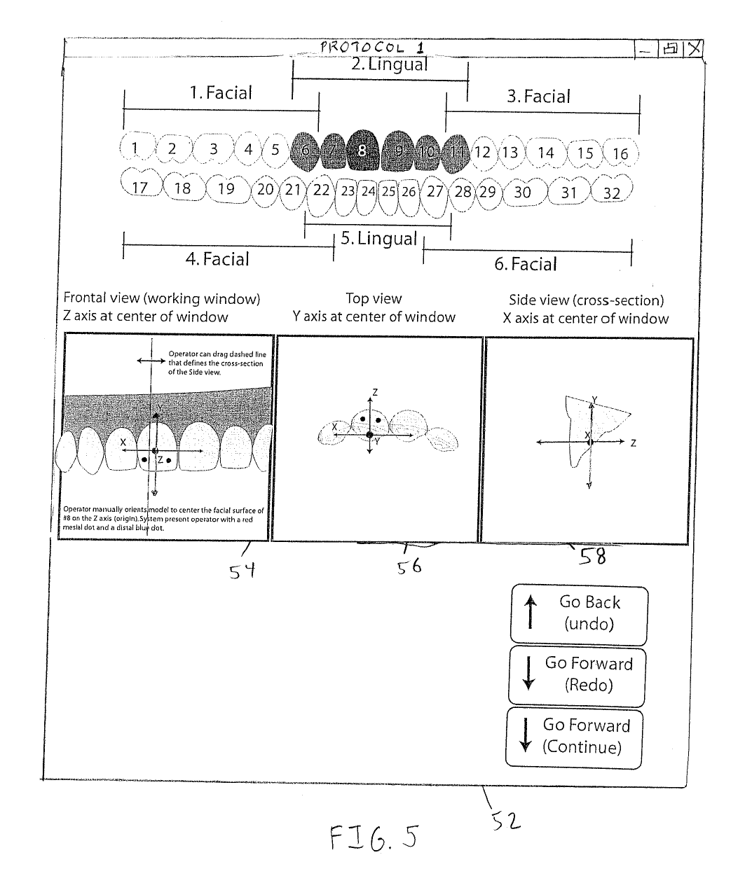

At step 50 (FIG. 2), a screen 52 is displayed through which the user can select a first tooth on which to work, as illustrated in FIG. 5. The user works in a tooth-by-tooth manner, as indicated by the line returning to step 50 in the flow diagram of FIG. 2. The user can select a tooth by clicking on it. The selected tooth is highlighted. In the exemplary embodiment of the invention, the steps or protocol involved in working on a selected tooth can depend upon the type of tooth. For example, a first protocol can be used for incisors, i.e., teeth #7, #8, #9, #10, #23, #24, #25 and #26. A second protocol can be used for canines and lower first premolars, i.e., teeth #6, #11, #21, #22, #27 and #28. A third protocol can be used for upper posterior teeth adjacent to distal of canine, i.e., teeth #3, #4, #5, #12, #13 and #14. A fourth protocol can be used for upper posterior teeth not adjacent to canine, i.e., teeth #1, #2, #3, #4, #13, #14, #15 and #16. A fifth protocol can be used for lower second premolars and molars, i.e., teeth #17, #18, #19, #20, #29, #30, #31 and #32. The method can include automatically selecting a corresponding protocol in response to the user's selection of a tooth. Alternatively or in addition, the user can select a different protocol. The “Change Positioning Protocol” button, noted above with regard to screen 46 (FIG. 4), can also be included in screen 52 and similar screens, though it is not shown for purposes of clarity. Thus, a user can change the default protocol that applies to the selected tooth if, in his or her judgment, a different protocol may be more appropriate.

Screen 52 includes, in addition to a depiction of the dentition and the segments defined at step 44, three windows 54, 56 and 58. In the depiction of the dentition, the selected tooth is highlighted, as is the segment to which the tooth belongs. The selected tooth can be highlighted in a color distinguishable from that in which the remaining teeth of the segment are highlighted. It is contemplated that in the exemplary embodiment of the invention the user work on the teeth of only one segment at a time, though in other embodiments the user can choose to work on teeth in any other suitable order. In the example shown, tooth #8 has been selected. Window 54 shows tooth #8 and several surrounding teeth in a frontal view. Window 56 shows the tooth #8 and several surrounding teeth in a top view. Window 58 shows tooth #8 by itself in a side or cross-sectional view.

Note that the explanatory text shown in windows 54, 56 and 58 throughout the drawing figures is included only for the aid of the reader of this specification and is not displayed on any screen.

The X, Y and Z axes of the three-dimensional (X, Y, Z) reference system are depicted in windows 54, 56 and 58. The three axes intersect each other at the center or approximately at the center of each window. In window 54, the X axis is horizontal, the Y axis, which is perpendicular to the X axis, is vertical, and the Z axis, which is represented by a dot, is perpendicular or normal to the plane of the window (and perpendicular to the X and Y axes). Accordingly, in window 56 the Z axis appears vertical, and the Y axis is perpendicular or normal to the plane of the window and thus represented by a dot. A dashed line is also presented to the user in window 54. Likewise, in window 58 the Z axis appears horizontal, and the X axis is perpendicular or normal to the plane of the window and thus represented by a dot. In response to the user dragging the dashed line, the cross-sectional view in window 58 changes accordingly, i.e., the cross section is taken along the dashed line. Two additional dots, which can have a readily distinguishable color (e.g., red and blue), are also presented in windows 54 and 56, and are used as described below to identify or mark reference features.

The default protocol for tooth #8 is the first protocol (“Protocol 1”). Each protocol follows a pattern of requesting the user to identify or mark reference features or landmarks on virtual model 28 with respect to the selected tooth, such as points, lines or planes, as indicated by step 60 (FIG. 2). Then, using the positions of the reference features as marked with respect to virtual model 28, the position of virtual model 28 is computed with respect to the reference system, which in the exemplary embodiment of the invention comprises the above-described three mutually perpendicular X, Y and Z axes.

In accordance with the first protocol, the user is first requested to orient the depiction of the teeth so that the center of the facial surface of tooth #8 is positioned where the X, Y and Z axes intersect one another, i.e., the origin (coordinates (0,0,0) of the reference system. As described above, the axes are displayed with the origin positioned in the center or approximately in the center of window 54. Window 54 is a “working window.” That is, the user can click on, drag, etc., the graphical elements shown in window 54. For example, the user can orient the depiction of the teeth by dragging it in window 54 until the center of the facial surface of tooth #8 is centered on the origin. In response to the user orienting the depiction of the teeth at this step, the position of virtual model 28 with respect to the reference system is recomputed. That is, in the data structure or other means by which virtual model 28 is computationally represented, the coordinates representing its position are set such that the center of the facial surface of tooth #8 are (0,0,0), i.e., the origin. The depictions in windows 56 and 58 are correspondingly updated to reflect the user having re-oriented the depiction in window 54 (the working window).

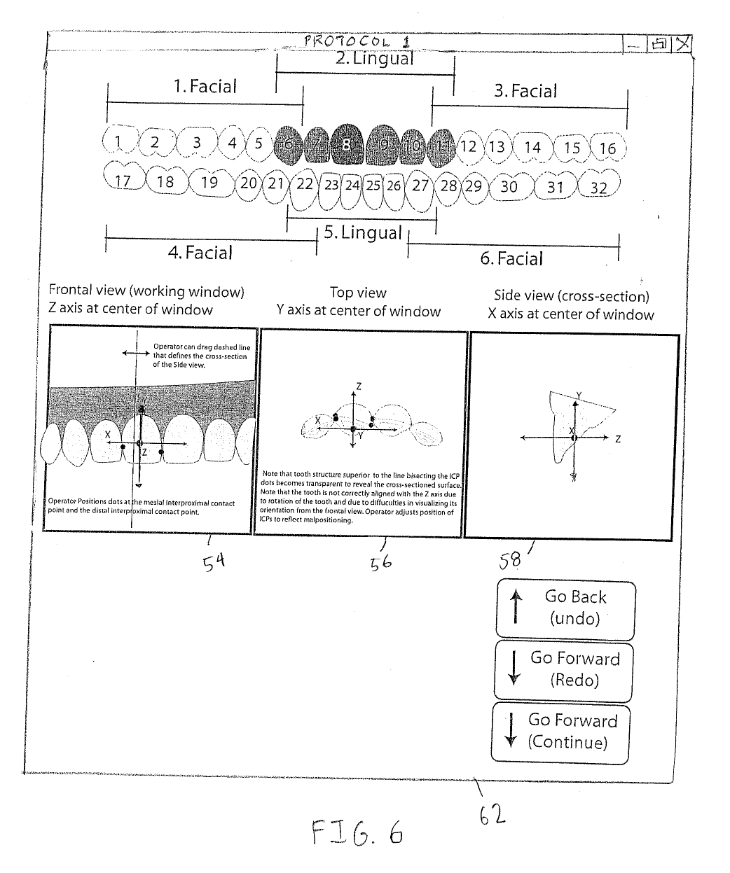

When the user clicks the “Continue” button to proceed, the screen 62 illustrated in FIG. 6 is displayed. Screen 62 is similar to screen 52, described above. The user drags the first (e.g., red) dot to a point on tooth #8 that the user judges to be the mesial interproximal contact point (ICP) and drags the second (e.g., blue) dot to a point on tooth #8 that the user judges to be the distal ICP. Note that the top view in window 56 reveals that the user has not accurately placed the dots on the mesial and distal ICPs, an error that is not readily visible through only the frontal view in window 54 due to the rotation of tooth #8.

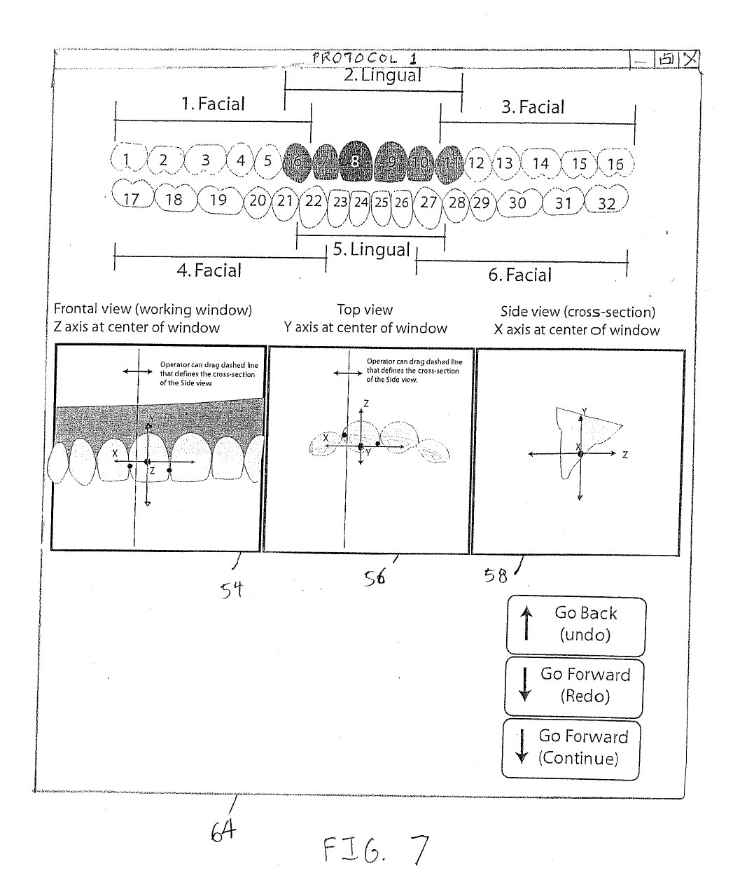

When the user clicks the “Continue” button to proceed, the screen 64 illustrated in FIG. 7 is displayed. Screen 64 is similar to the screens described above, but now both windows 54 and 56 are working windows. Another dashed line is displayed correspondingly in window 56 to indicate the plane through which the cross-section depicted in window 58 is taken. The user can drag this dashed line to adjust the cross-section. If necessary, the user can drag one or both dots in, for example, window 56, to more accurately position them on the points that the user judges to be the mesial and distal ICPs. As shown in FIG. 7, the user has adjusted their positions.

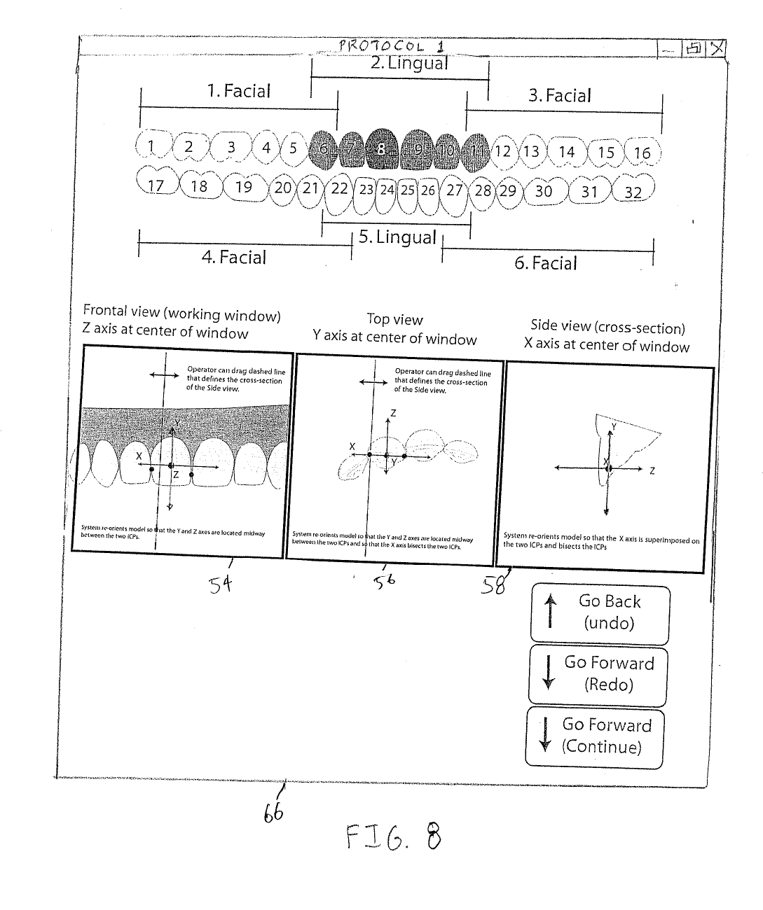

When the user clicks the “Continue” button to proceed, the orientation of virtual model 28 is recomputed, and the screen 66 illustrated in FIG. 8 is displayed. Screen 66 is similar to the screens described above, but virtual model 28 is depicted in windows 54, 56 and 58 in the recomputed orientation. Note in window 54 that the Y and Z axes are positioned mid-way between the two ICPs, and in window 56 the X axis intersects the two ICPs.

Note that although in this exemplary embodiment of the invention the user defines most of the reference features manually by clicking on points, dragging lines, etc., in other embodiments some of the features can be detected automatically, i.e., without user intervention, using conventional image recognition methods.

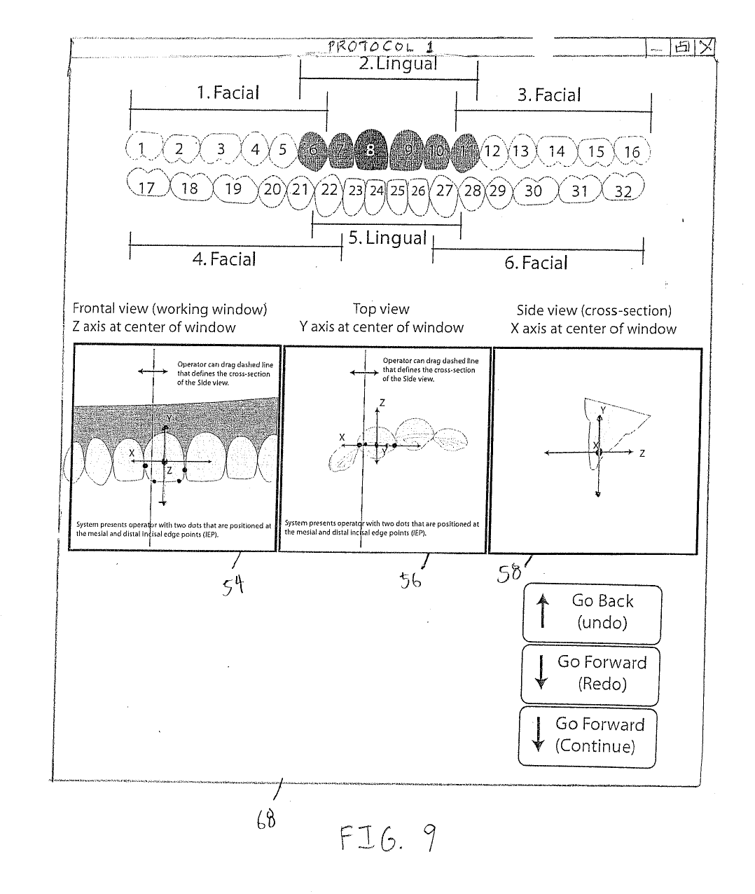

When the user clicks the “Continue” button to proceed, the screen 68 illustrated in FIG. 9 is displayed. Screen 68 is similar to the screens described above, but two additional dots (e.g., yellow and purple) are displayed for the user to drag to points on tooth #8 that the user judges to be the mesial and distal edge points (IEPs), respectively.

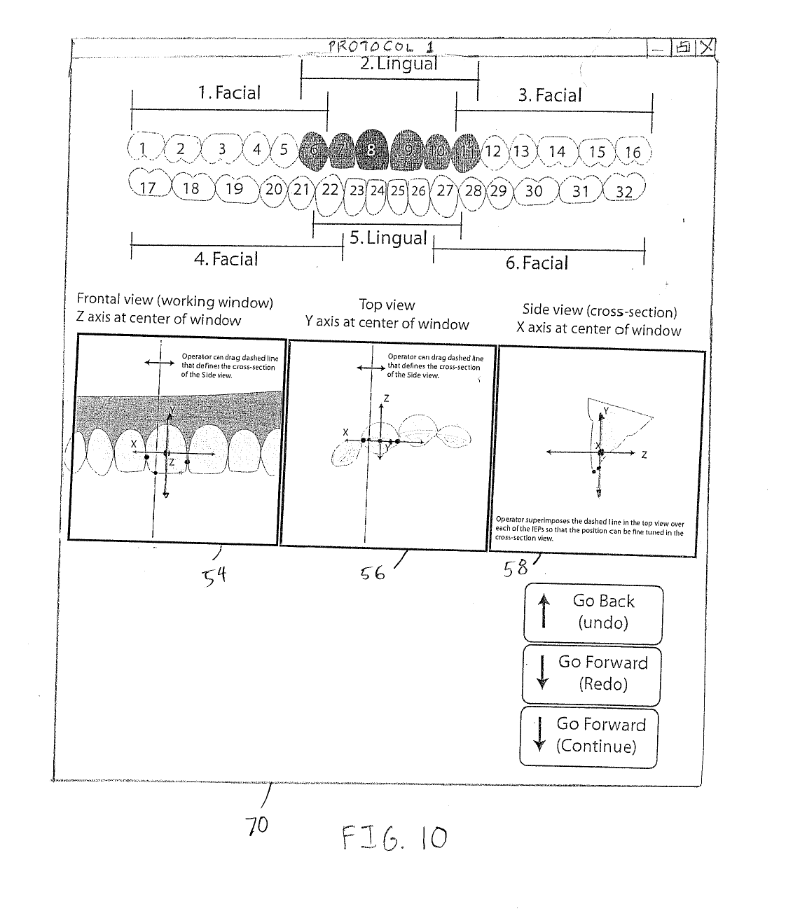

When the user clicks the “Continue” button to proceed, the screen 70 illustrated in FIG. 10 is displayed. Screen 70 is similar to the screens described above, but now all three windows 54, 56 and 58 are working windows. Another dashed line is displayed correspondingly in window 56 to indicate the plane through which the cross-section depicted in window 58 is taken. The user can drag this dashed line to adjust the cross-section. If necessary, the user can drag one or both IEP dots in, for example, window 56 or 58, to more accurately position them on the points that the user judges to be the mesial and distal IEPs. As shown in FIG. 10, the user has adjusted their positions. Note that repositioning the dashed line over the point judged to be the IEP in window 54 can help the user more accurately position the corresponding IEP dot in window 58. As an aid to the user, the dots in window 58 can behave as though they cannot be dragged into the interior of the tooth but rather only along its periphery.

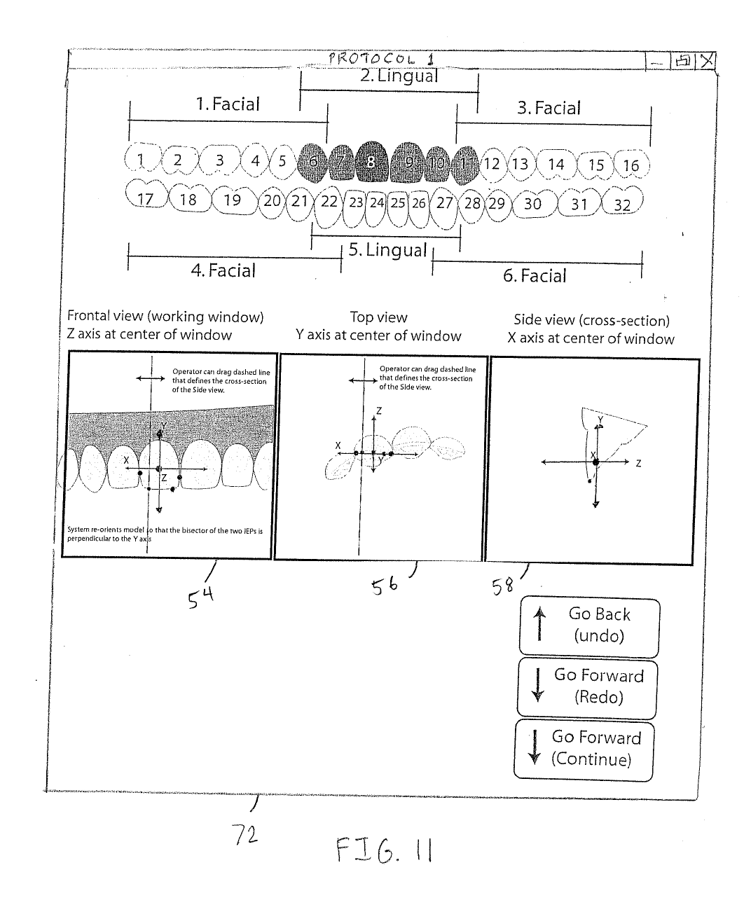

When the user clicks the “Continue” button to proceed, the orientation of virtual model 28 is recomputed, and the screen 72 illustrated in FIG. 11 is displayed. Screen 72 is similar to the screens described above, but virtual model 28 is depicted in windows 54, 56 and 58 in the recomputed orientation. Note in window 54 that a reference line (not shown) intersecting the two IEPs would be perpendicular to the Y axis.

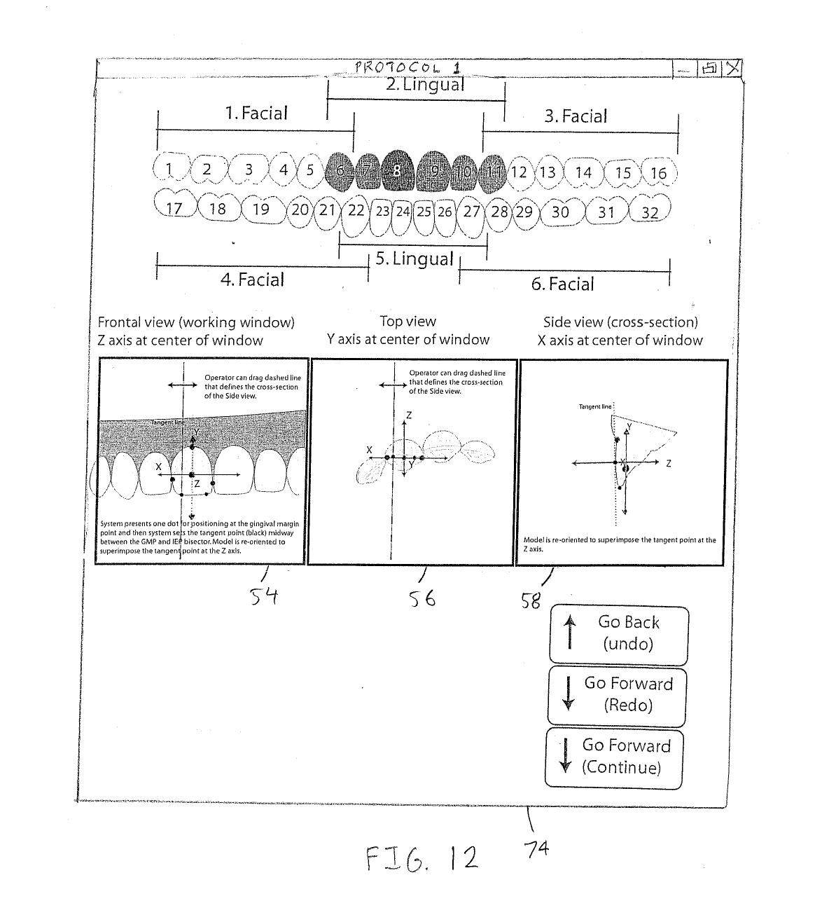

When the user clicks the “Continue” button to proceed, the screen 74 illustrated in FIG. 12 is displayed. Screen 74 is similar to the screens described above, but another dot (e.g., orange) is displayed for the user to drag to the point on tooth #8 that the user judges to be the gingival margin point (GMP). In response to the user placing the gingival margin dot in this manner, a tangent point (e.g., a black dot) is computed and displayed mid-way between the GMP and the reference line (not shown) intersecting the two IEPs. The orientation of virtual model 28 is then recomputed such that the tangent point is at the origin. Accordingly, note in window 54 that the tangent point is superimposed on the dot indicating the Z axis. The tangent point and corresponding tangent line (depicted as a dotted line) are also displayed in window 58. The tangent line defines the facio-lingual angle (commonly referred to as “torque”) of tooth #8.

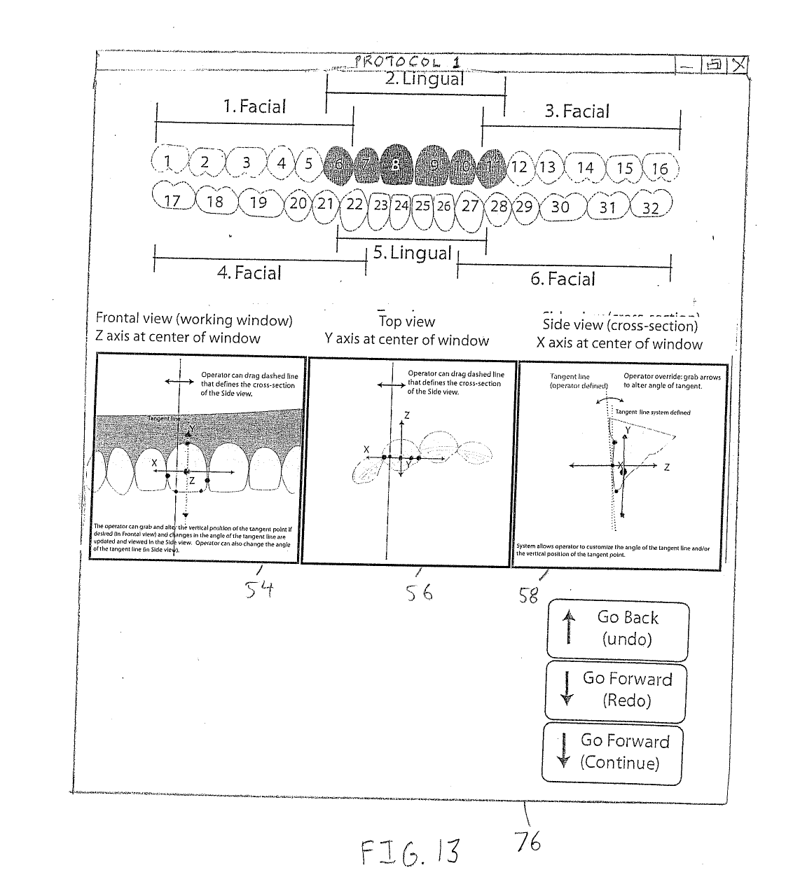

When the user clicks the “Continue” button to proceed, the screen 76 illustrated in FIG. 13 is displayed. In window 54, the user can drag the tangent point dot, if desired. Similarly, the user can drag the tangent line to rotate it about the tangent point in window 58.

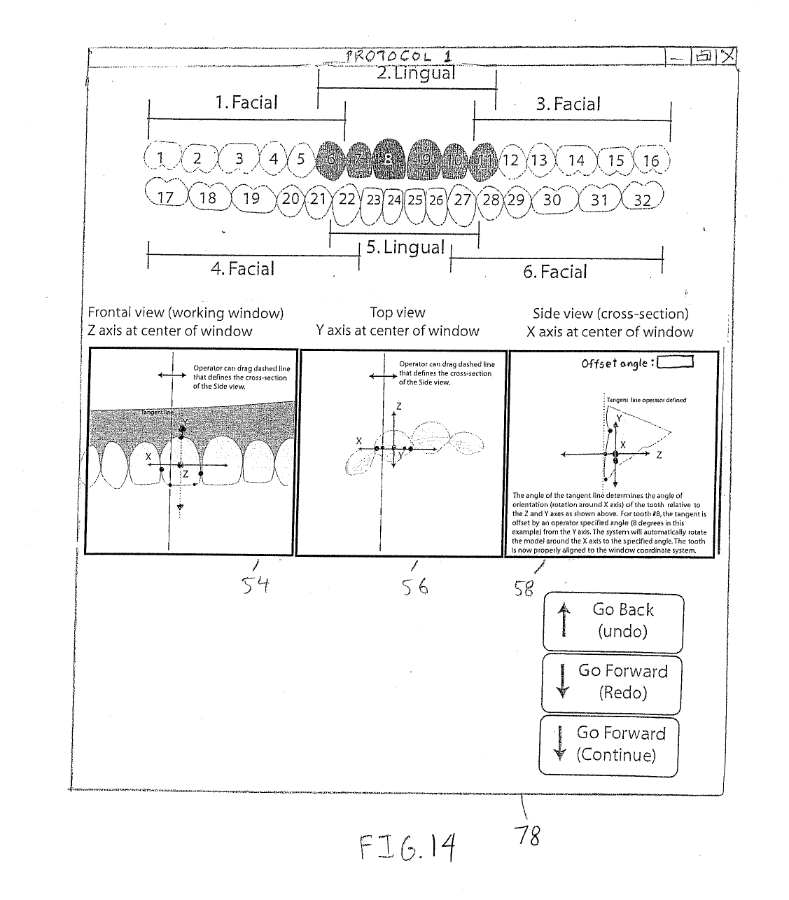

When the user clicks the “Continue” button to proceed, the screen 78 illustrated in FIG. 14 is displayed. In window 58 the user can enter an offset angle, which is the number of degrees by which the tangent line is to be offset from the Y axis. The angle of the tangent line determines the angle of orientation (rotation about the X axis) of the tooth relative to the Y and Z axes. If the user enters a nonzero offset angle, the orientation of virtual model 28 is recomputed such that it is rotated about the X axis by that number of degrees.

The steps for determining reference features and determining a reference system are described above with regard to an example involving a first protocol (“Protocol 1”) and tooth #8, and similar steps are described below with regard to other examples involving other protocols and teeth. Referring briefly again to FIG. 2, the step 60 of determining reference features has been described above with regard to an exemplary embodiment in which the user marks them using dots, a tangent line, etc. The step 80 of using the determined (e.g., marked) reference features to determine a position of the virtual model with respect to the reference system occurs each time the orientation of virtual model 28 is recomputed.

Once the position of the virtual model with respect to the reference system has been determined for a tooth, a bracket can be positioned relative to that tooth in accordance with step 82 (FIG. 2). It is contemplated, however, that a user orients each tooth of a segment with respect to the reference system before positioning brackets on that segment. Nevertheless, as described above, the steps described herein are not required to be performed in any particular order. Thus, for example, although clicking the “Continue” button following the marking of reference features and determination of the reference system can cause the method to proceed to step 82, alternatively, the user can opt to return to a main menu of options, such as that illustrated in FIG. 15. Some of the steps described above are represented in FIG. 15 with buttons that can be used to invoke those steps: “Load Virtual Model,” “Define Dentition,” “Define Segments,” “Select Segment/Tooth To Work On,” and “Save Work.” Indeed, FIG. 15 can represent a main menu that is displayed upon initially invoking or launching (i.e., executing) the software application. Although the controls are buttons in the exemplary embodiment for purposes of illustration, in other embodiments the controls can comprise pull-down menus of the type common in MICROSOFT WINDOWS-based software. For example, instead of a “Save Work” button, a “Save As” (filename) option can be included in a pull-down menu under a “File” tab heading, as can an “Open” (filename) button for opening files previously created.

A button is also provided for “Auto-Position Brackets.” Clicking on this button invokes algorithms that determine optimal positions for brackets with respect to the reference systems that have been determined. Another button, “Simulate Therapy,” can be used after the bracket positioning step 82 (FIG. 2) to cause the system to perform a simulation that shows the predicted results of the therapy with the appliance. If the user is not satisfied with the predicted results, an “Adjust Bracket Position” button is provided that the user click on to invoke a manual bracket repositioning method. Although no screens are shown relating to manual bracket repositioning, the user can, for example, use the mouse or a joystick to drag a bracket into a new position or enter numerical coordinates or offsets to cause the bracket to be moved to the new coordinates or to be moved by the specified offset.

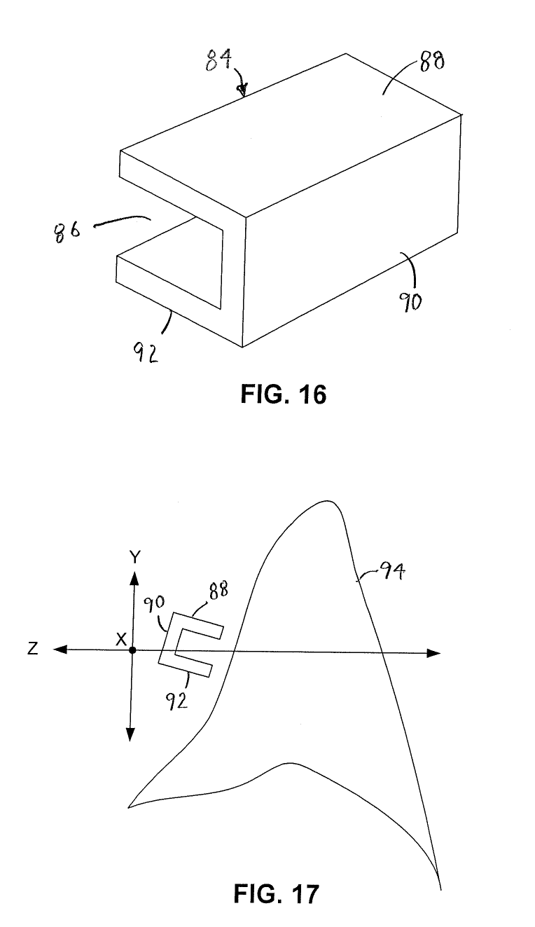

Regardless of whether the bracket positioning step 82 is reached by clicking the “Continue” button following the step of virtual model positioning step 62 or by clicking an “Auto-Position Brackets” button or “Adjust Bracket Position Button,” step 82 can be performed as follows. As a preliminary matter, FIGS. 16-17 illustrate in generalized form the type of bracket to which the positioning method is applied in the exemplary embodiment of the invention. As noted above, various embodiments of such brackets are described in the above-referenced co-pending patent applications and are therefore not described in further detail herein. Nevertheless, it can be noted that the bracket has a body 84 with an opening 86 for receiving an arch wire in it. Opening 86 is coextensive with body 84; that is, it extends the length of body 84 so that the opening is open at both ends of body 84. Preferably, body 84 has a gingival sidewall 88, an occlusal sidewall 90, and a lingual sidewall 92 that together define opening 86 as a rectangular slot with its open side facing the tooth 94. As can be seen in FIG. 17, and as described in the above-referenced co-pending patent applications, the bracket can advantageously be positioned offset (along the Z axis) from tooth 94, i.e., without contacting it (or any other tooth). In effect, the bracket is positioned suspended in free space. (When a real, i.e., non-virtual, transfer tray is fabricated from virtual model 28 and used to transfer the arrangement of brackets to a patient as described below, the space in which each bracket is suspended will also be occupied by a mass of adhesive, with the bracket encapsulated in the adhesive.) Six degrees of freedom in the positioning method allow a bracket to be positioned adjacent the tooth anywhere along the X, Y and Z axes (shown in FIG. 15) of the reference system for the tooth and in any rotational position with respect to each axis. (The bracket is shown in FIG. 17 in a slightly rotated position about the X axis to illustrate selection of a rotational position.) Note that FIGS. 16-17 are intended only to illustrate an exemplary bracket and that various other embodiments of the bracket are described in the co-pending patent application. The methods and systems described herein can be applied to all such bracket embodiments and any other suitable orthodontic brackets.

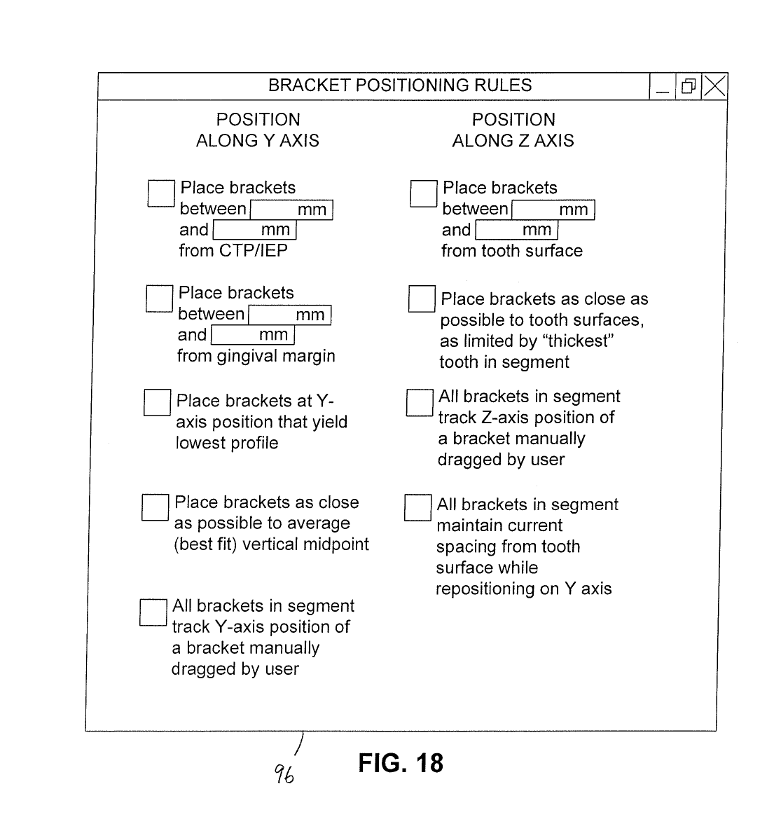

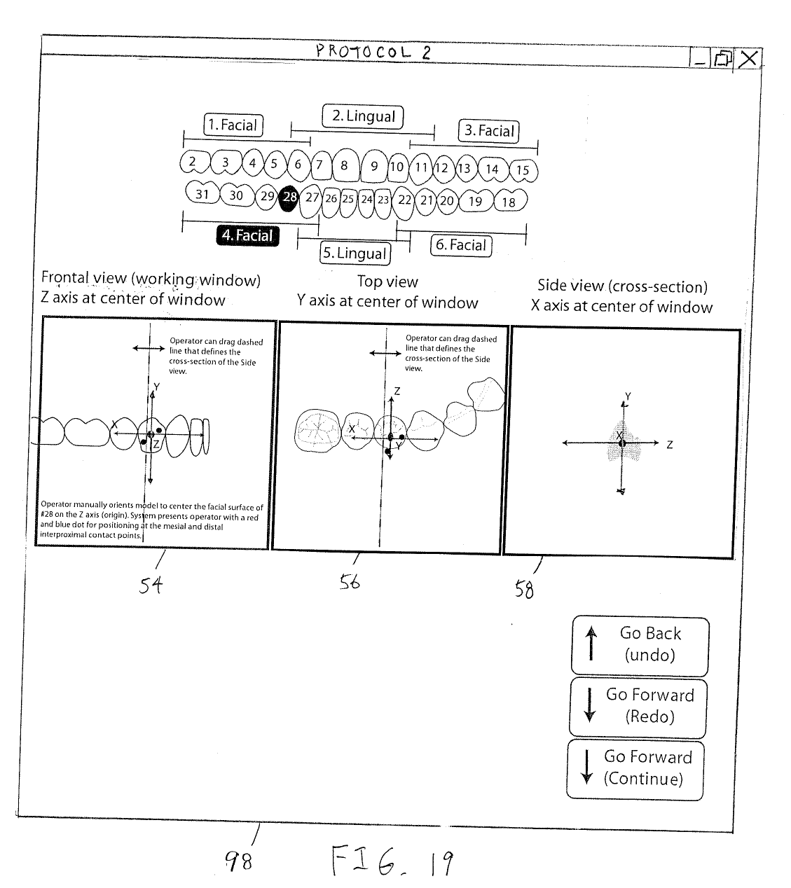

As described above, the bracket positioning step 82 (FIG. 2) can be performed automatically, manually, or through a combination of manual and automatic steps. The steps can include rules or algorithms that use the reference features, reference system and properties determined as described above. As illustrated in FIG. 18, a screen 96 is displayed upon beginning the bracket positioning step, listing rules as options from which the user can select by checking corresponding boxes. If a box is checked, the corresponding rule is applied in determining the positions of the brackets. (In the case of mutually inconsistent rules, one can take precedence over the other.) The rules shown in screen 96 are intended as examples, and others will occur readily to persons skilled in the art in view of the teachings herein.

The rules indicated as options on screen 96 relate to positioning a bracket only along the Y and Z axes because positioning along the X axis and about the rotational axes is preferably performed in accordance with predetermined rules or performed essentially manually. For example, with regard to the X axis, each bracket is preferably at least initially positioned mid-way between the mesial and distal ICPs of a tooth. A user can manually change the position of a bracket along the X axis in the same manner as that in which the user can change the position of a bracket in any of other five degrees of freedom (for example, by dragging it or by entering a numerical value), but preferably the X coordinate of each bracket is at least initially positioned at a point mid-way between the ICPs. With regard to the rules for positioning brackets along the Y and Z axes, within the constraints imposed by any of the rules that may be selected, the algorithm will position the brackets of a segment in a manner that aligns them sufficiently with one another to receive the arch wire.

The rules shown in screen 96 from which the user can choose for positioning a bracket along the Y axis are:

(1) Place each bracket between a user-input or predetermined minimum number of millimeters (or other units of distance) and a user-input or predetermined maximum number of millimeters (or other units of distance) from the cusp tip points (CTP) or incisal edge points (IEP). This rule can be applied, for example, in conjunction with other rules, such as a rule that determines the lowest profile arrangement, i.e., the arrangement in which each bracket is positioned as closely as possible to the tooth surface while maintaining all brackets in the segment in sufficient alignment with one another to receive the arch wire. Alternatively, by setting both the minimum and maximum to the same values, the user can position the brackets at a specific Y coordinate.

(2) Place each bracket between a user-input or predetermined minimum number of millimeters (or other units of distance) and a user-input or predetermined maximum number of millimeters (or other units of distance) from the gingival margin. This rule can be applied, for example, in conjunction with other rules, such as a rule that determines the lowest profile arrangement, i.e., the arrangement in which each bracket is positioned as closely as possible to the tooth surface while maintaining all brackets in the segment in sufficient alignment with one another to receive the arch wire. Alternatively, by setting both the minimum and maximum to the same values, the user can position the brackets at a specific Y coordinate.

(3) Place each bracket at the vertical (Y-axis) position that yields the lowest profile. In other words, place the brackets of the segment at a vertical position that results in one or more of them being as close as possible (i.e., Z-axis distance) to a tooth surface (while maintaining all brackets in the segment in sufficient alignment with one another to receive the arch wire).

(4) Place each bracket as close as possible to an average (or best fit) vertical midpoint between the CTPs (or IEPs) and gingival margins of the teeth in the segment.

(5) If a user drags or otherwise manually repositions a bracket, the other brackets in the segment are automatically moved in response to track the Y-axis movement of the manually repositioned bracket. In other words, if a user drags a bracket along the Y axis, the other brackets automatically move along with it on the screen.

The rules shown in screen 96 from which the user can choose for positioning a bracket along the Z axis are:

(1) Place each bracket between a user-input or predetermined minimum number of millimeters (or other units of distance) and a user-input or predetermined maximum number of millimeters (or other units of distance) from the nearest point on the tooth surface. This rule can be applied, for example, in conjunction with other rules, such as a rule that determines the lowest profile arrangement, i.e., the arrangement in which each bracket is positioned as closely as possible to the tooth surface while maintaining all brackets in the segment in sufficient alignment with one another to receive the arch wire. Alternatively, by setting both the minimum and maximum to the same values, the user can position the brackets at a specific Z coordinate.

(2) Place each bracket as close as possible to the tooth surface (while maintaining all brackets in the segment in sufficient alignment with one another to receive the arch wire). The tooth in the segment having the thickest profile at the arch plane will limit how close the other brackets can be placed to their respective teeth and still be aligned in the arch. Thus, the bracket having the greatest Z-axis offset or distance between it and the tooth will be that of tooth having the thinnest profile at the arch plane.

(3) If a user drags or otherwise manually repositions a bracket, the other brackets in the segment are automatically moved in response to track the Z-axis movement of the manually repositioned bracket. In other words, if a user drags a bracket along the Z axis, the other brackets automatically move along with it on the screen.

(4) If a user drags or otherwise manually repositions a bracket along the Y axis, the current spacing (i.e., Z-axis distance) between each bracket in the segment and the corresponding tooth is maintained. In other words, if a user drags the bracket (or brackets) along the Y axis, the bracket (or brackets) automatically move along the Z axis, following the profile of the tooth, to keep the spacing constant.

As described above, five protocols, referred to as “Protocol 1,” “Protocol 2,” “Protocol 3,” “Protocol 4,” and “Protocol 5,” can be used to define the reference system for various tooth types. Protocol 1 was described above. The following is a similar description for Protocol 2. Descriptions for the remaining protocols follow.

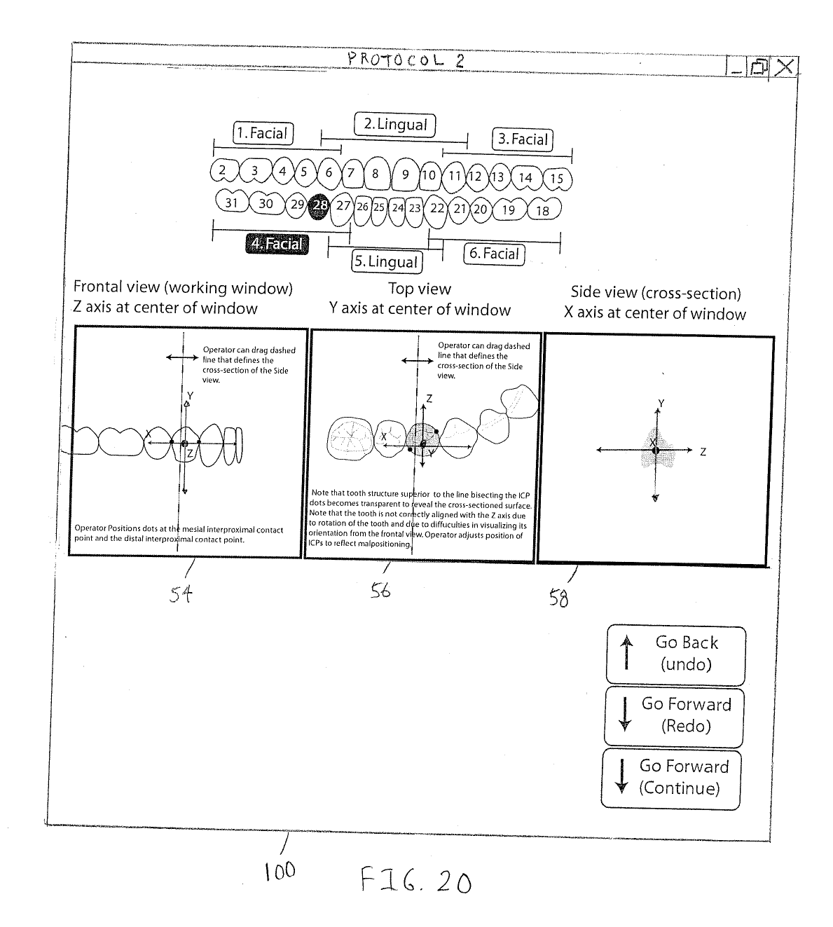

As illustrated in FIG. 19, a screen 98 is displayed in response to the user having selected, for example, tooth #28. As described above, Protocol 2 can be the default protocol that is invoked when the user selects tooth #28 or a similar tooth, or, alternatively or in addition, can be the protocol that the user selects through a menu. Screen 98 includes, in addition to a depiction of the dentition and the segments as defined, the three windows 54, 56 and 58 as described above. As in the screens described above relating to Protocol 1, window 54 shows tooth #28 and several adjacent teeth of the segment in a frontal view; window 56 shows tooth #28 and several adjacent teeth in a top view; and window 58 shows tooth #28 by itself in a side or cross-sectional view. A vertical dashed line is also presented to the user in window 54. As in the windows described above, in response to the user dragging the dashed line in window 54 or 56, the cross-sectional view in window 58 changes accordingly. A “Continue” button as well as “Redo” and “Undo” buttons are provided, as described above with regard to other such screens. Also, the X, Y and Z axes of the three-dimensional (X, Y, Z) reference system are depicted in windows 54, 56 and 58, as described above with regard to Protocol 1 screens. In addition, two dots (e.g., red and blue) are displayed in window 54 and used as described below.

As in the Protocol 1 screens described above, the user can click on, drag, etc., the graphical elements shown in window 54. For example, the user can orient the depiction of the teeth by dragging it in window 54 until the center of the facial surface of tooth #28 is centered on the origin (0,0,0). In response to the user orienting the depiction of the teeth at this step, the position of virtual model 28 with respect to the reference system is computed. That is, in the data structure or other means by which virtual model 28 is computationally represented, the coordinates representing its position are set such that the center of the facial surface of tooth #28 are (0,0,0), i.e., the origin. The depictions in windows 56 and 58 are correspondingly updated to reflect the user having re-oriented the depiction in window 54 (the working window).

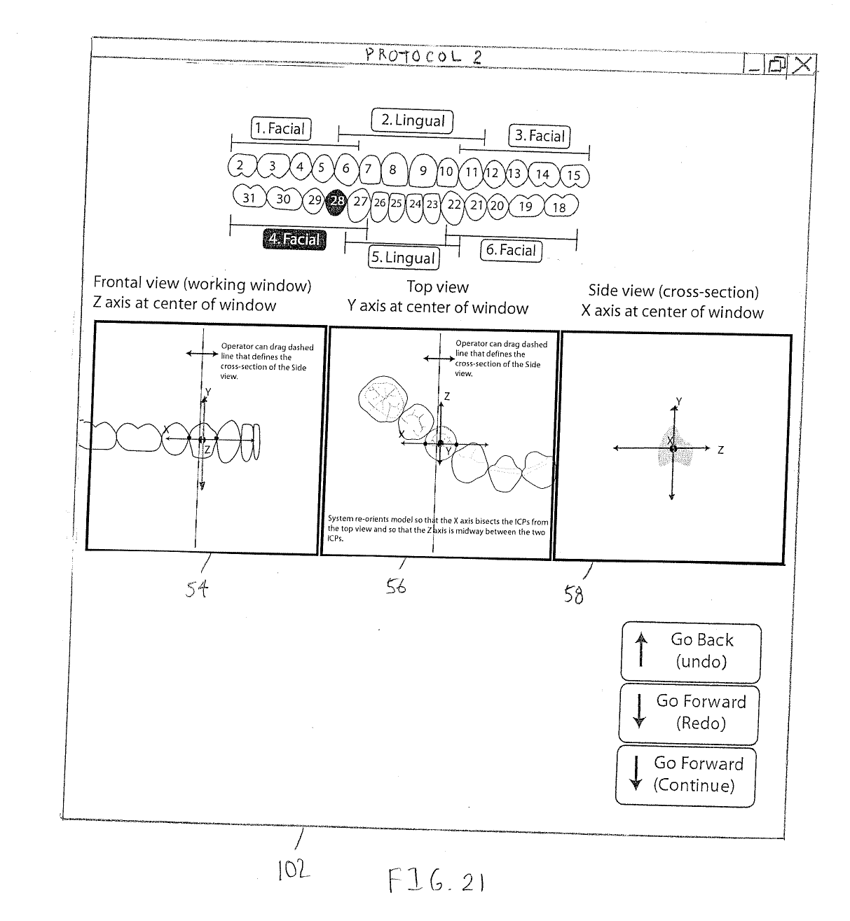

When the user clicks the “Continue” button to proceed, the screen 100 illustrated in FIG. 20 is displayed. Screen 100 is similar to screens described above. The user drags the first (e.g., red) dot to a point on tooth #28 that the user judges to be the mesial ICP and drags the second (e.g., blue) dot to a point on tooth #28 that the user judges to be the distal ICP. Note that the top view in window 56 reveals that the user has not accurately placed the dots on the mesial and distal ICPs, an error that is not readily visible through only the frontal view in window 54 due to the rotation of tooth #28.

When the user clicks the “Continue” button to proceed, the screen 102 illustrated in FIG. 21 is displayed. Screen 102 is similar to screens described above, but now both windows 54 and 56 are working windows. If necessary, the user can drag one or both dots in, for example, window 56, to more accurately position them on the points that the user judges to be the mesial and distal ICPs. As shown in FIG. 21, the user has adjusted their positions. Also, the orientation of virtual model 28 has been recomputed. Virtual model 28 is depicted in windows 54, 56 and 58 in the recomputed orientation. Note in window 54 that the Y and Z axes are positioned mid-way between the two ICPs, and in window 56 the X axis intersects the two ICPs.

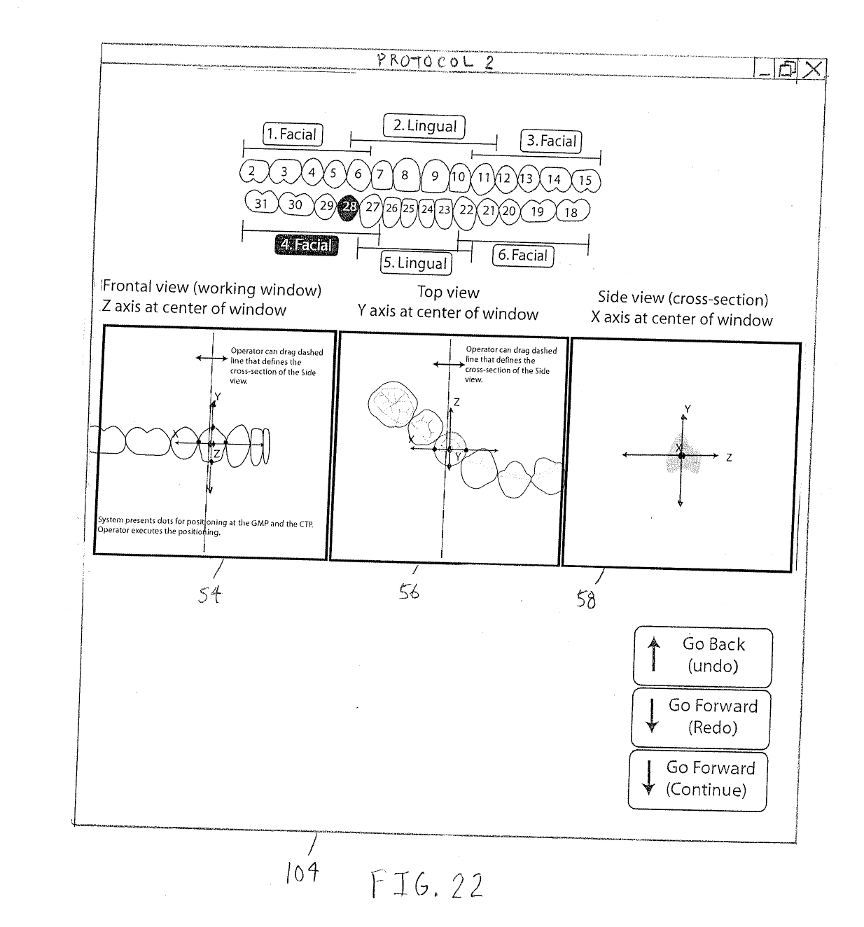

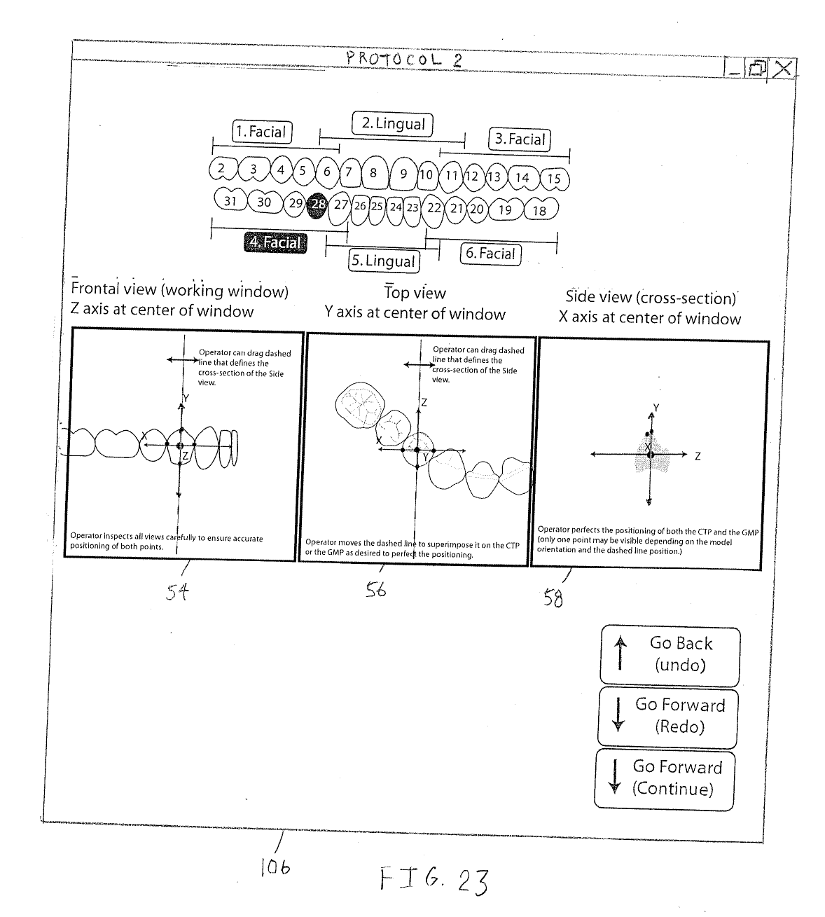

When the user clicks the “Continue” button to proceed, the screen 104 illustrated in FIG. 22 is displayed. Screen 104 is similar to screens described above, but two additional dots (e.g., yellow and purple) are displayed for the user to drag to points on tooth #28 that the user judges to be the gingival margin point (GMP) and cusp tip point (CTP), respectively.

When the user clicks the “Continue” button to proceed, the screen 106 illustrated in FIG. 23 is displayed. Screen 106 is similar to screens described above, but now all three windows 54, 56 and 58 are working windows. If necessary, the user can drag one or both of the GMP and CTP dots in, for example, window 56 or 58, to more accurately position them on the points that the user judges to represent the GMP and CTP. As shown in FIG. 23, the user has adjusted their positions. Note that repositioning the dashed lines over the points judged to be the GMP or CTP in window 54 or 56 can help the user more accurately position the corresponding GMP or CTP dot in window 58. As an aid to the user, the dots in window 58 can behave as though they cannot be dragged into the interior of the tooth but rather only along its periphery.

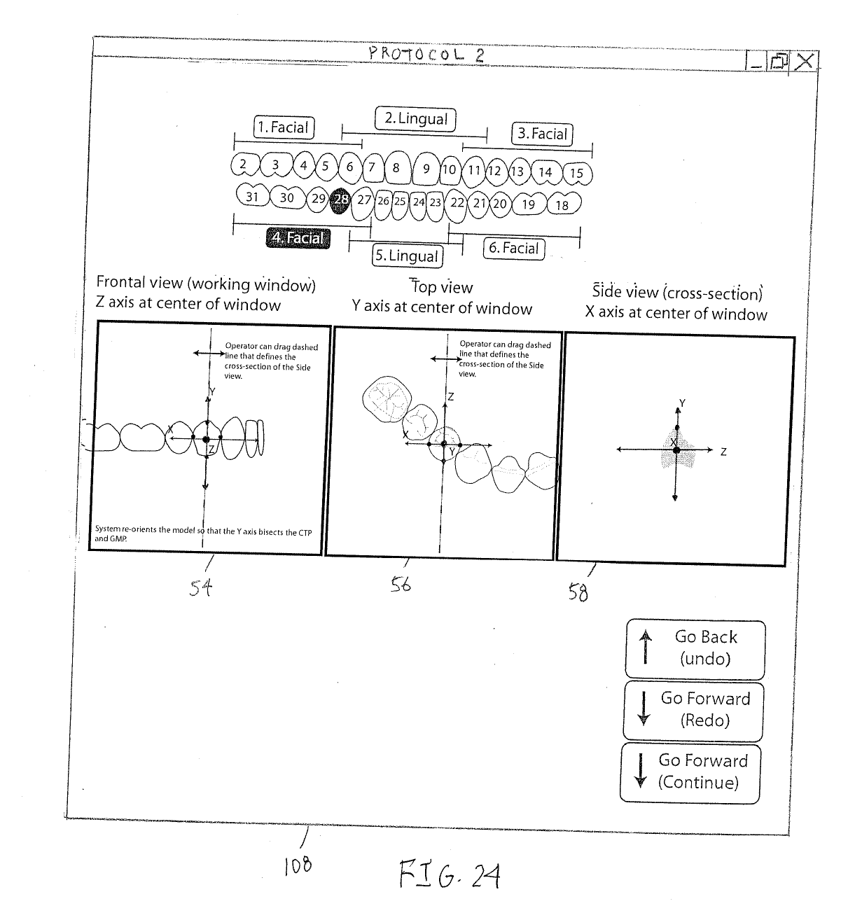

When the user clicks the “Continue” button to proceed, the orientation of virtual model 28 is recomputed, and the screen 108 illustrated in FIG. 24 is displayed. Screen 108 is similar to screens described above, but virtual model 28 is depicted in windows 54, 56 and 58 in the recomputed orientation. Note in window 54 that, if not already so oriented, in the recomputed orientation the Y axis has been made to intersect the GMP and CTP dots.

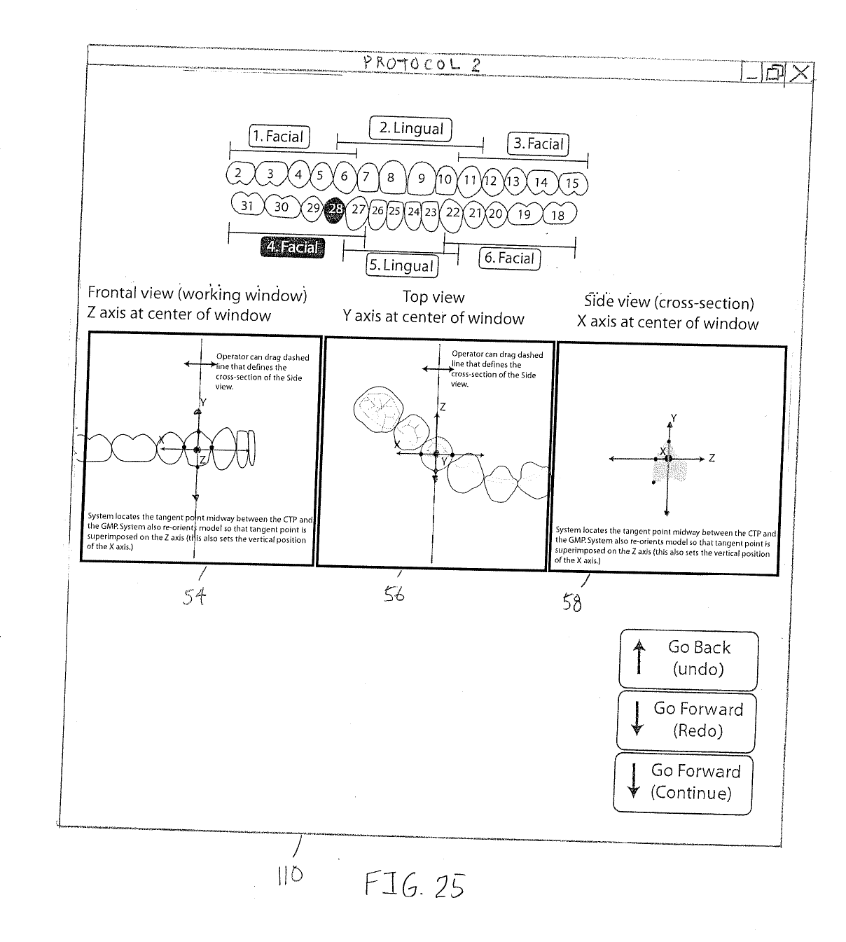

When the user clicks the “Continue” button to proceed, the screen 110 illustrated in FIG. 25 is displayed. Screen 74 is similar to screens described above, and window 54 is the working window. A tangent point (e.g., a black dot) is computed and displayed in the windows mid-way between the GMP and CTP dots on the Y axis. The orientation of virtual model 28 is then recomputed such that the tangent point is on the Z axis. Accordingly, note in windows 54 and 58 that the tangent point is superimposed on the dot indicating the Z axis. The vertical position of the X axis is also set accordingly.

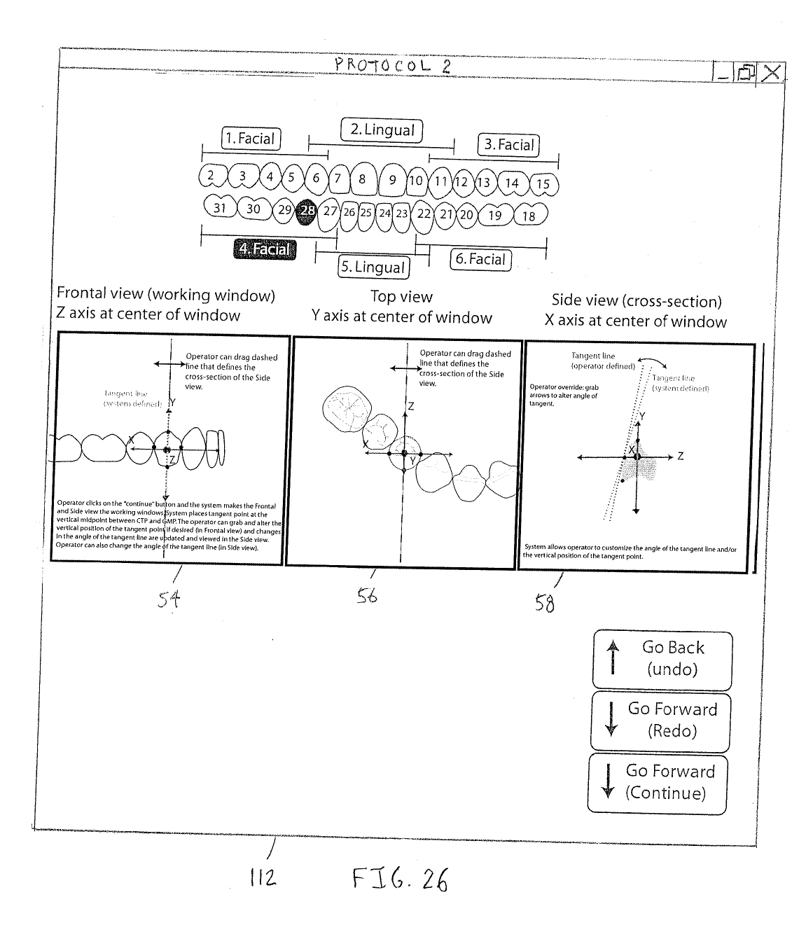

When the user clicks the “Continue” button to proceed, the screen 112 illustrated in FIG. 26 is displayed. The tangent point and corresponding tangent line (depicted as a dotted line) are displayed in window 58. The tangent line defines the facio-lingual angle (commonly referred to as “torque”) of tooth #28. In window 54, the user can drag the tangent point dot, if desired. Similarly, the user can drag the tangent line to rotate it about the tangent point in window 58.

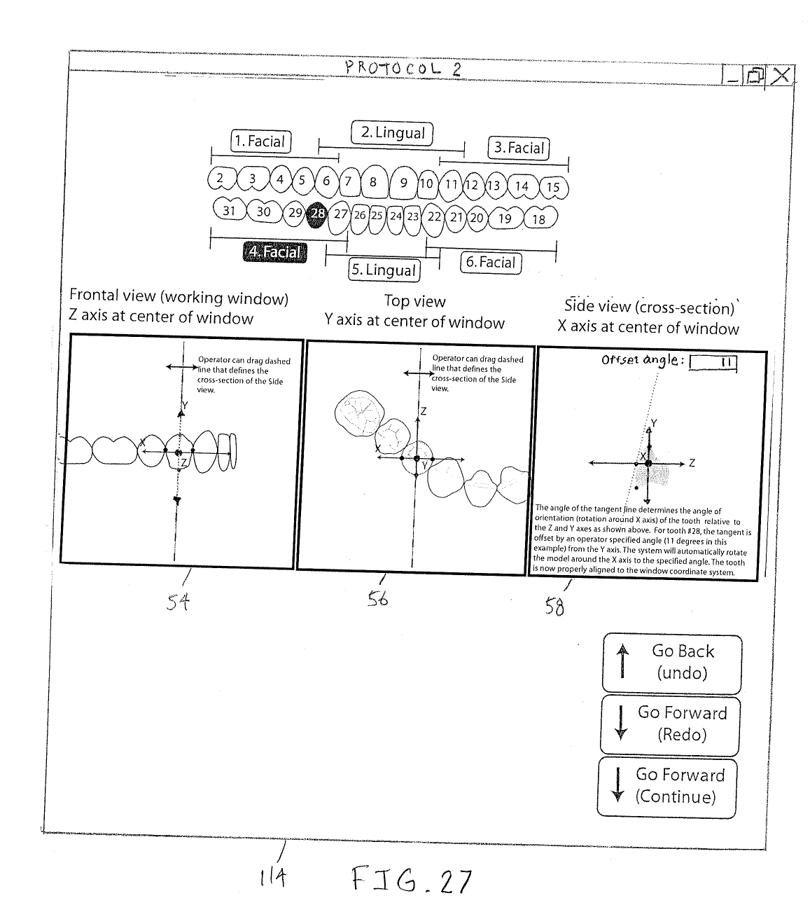

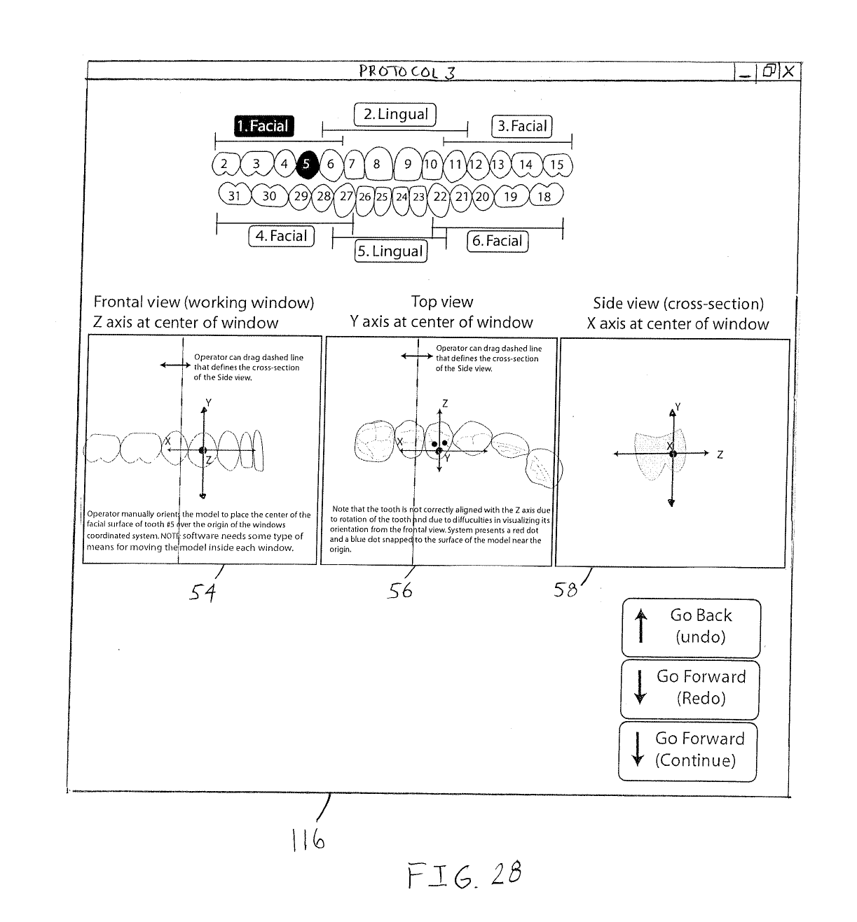

When the user clicks the “Continue” button to proceed, the screen 114 illustrated in FIG. 27 is displayed. In window 58, the user can enter an offset angle, which is the number of degrees by which the tangent line is to be offset from the Y axis. The angle of the tangent line determines the angle of orientation (rotation about the X axis) of the tooth relative to the Y and Z axes. If the user enters a nonzero offset angle, the orientation of virtual model 28 is recomputed such that it is rotated about the X axis by that number of degrees. An offset angle of 11 degrees has been entered as an example.

The following is a similar description for Protocol 3. As illustrated in FIG. 28, a screen 116, similar to those described above, is displayed in response to the user having selected, for example, tooth #5. As described above, Protocol 3 can be the default protocol that is invoked when the user selects tooth #5 or a similar tooth, or, alternatively or in addition, can be a protocol that the user selects through a menu. Screen 116 is similar to screens described above. Two dots (e.g., red and blue) are displayed in window 56 and used as described below. Window 54 is the working window. The user can orient the depiction of the teeth by dragging it in window 54 until the center of the facial surface of tooth #5 is centered on the origin (0,0,0). In response to the user orienting the depiction of the teeth at this step, the position of virtual model 28 with respect to the reference system is recomputed. The depictions in windows 56 and 58 are correspondingly updated to reflect the user having re-oriented the depiction in window 54 (the working window), as described above with regard to other screens.

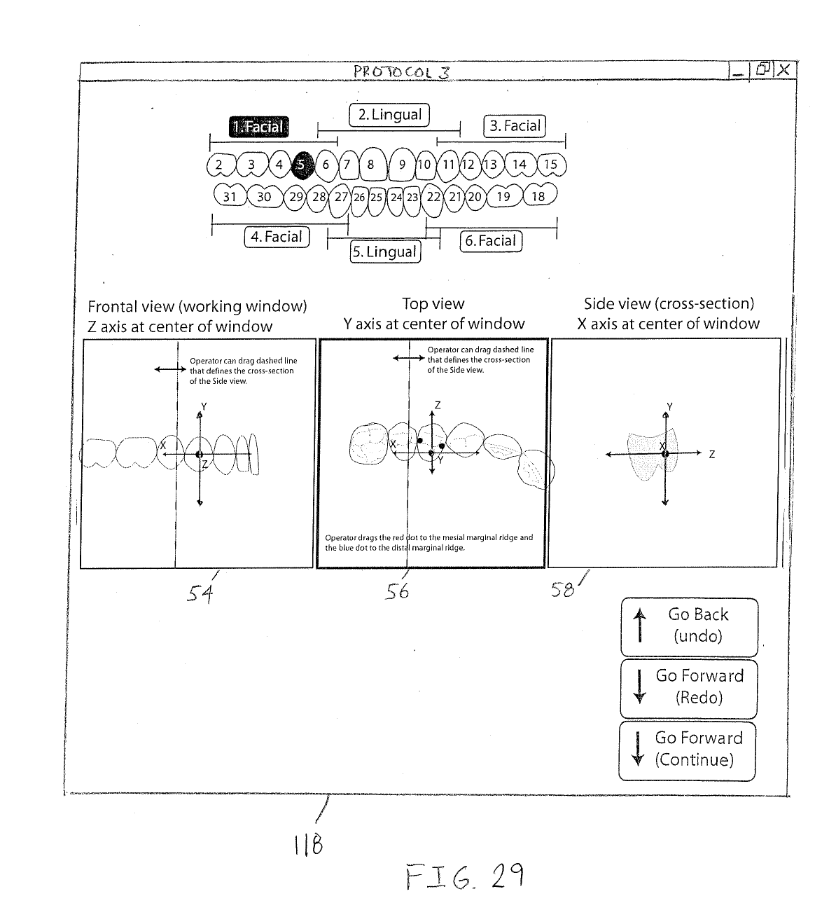

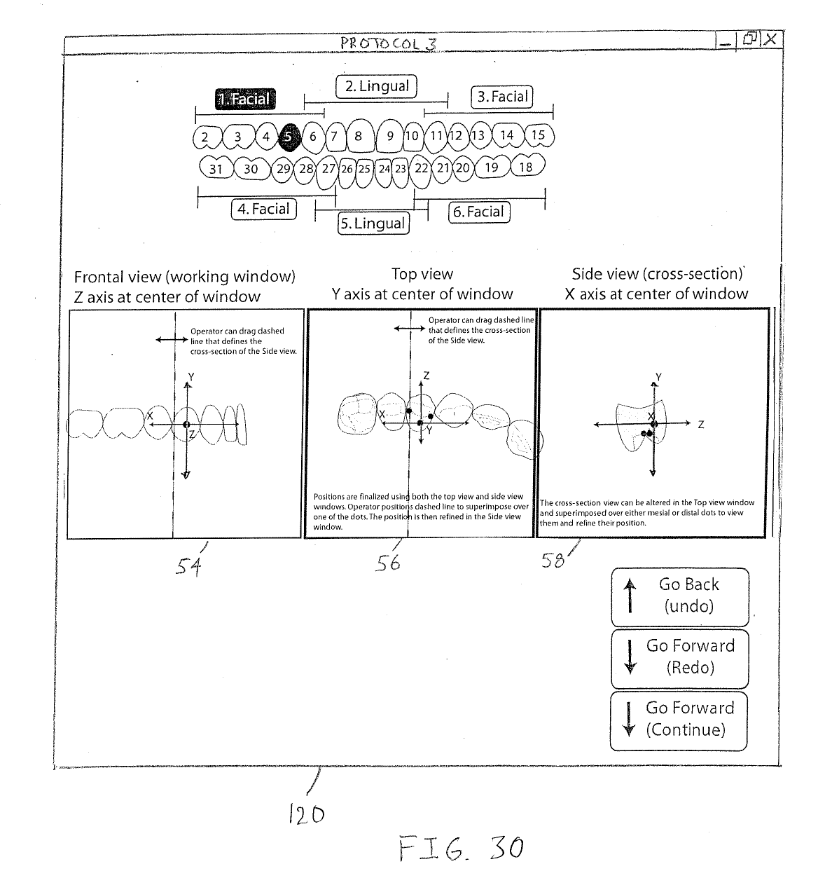

When the user clicks the “Continue” button to proceed, the screen 118 illustrated in FIG. 29 is displayed. The user can drag the red and blue dots to the points on tooth #5 that the user judges to be the mesial and distal marginal ridge points (MRPs), respectively.

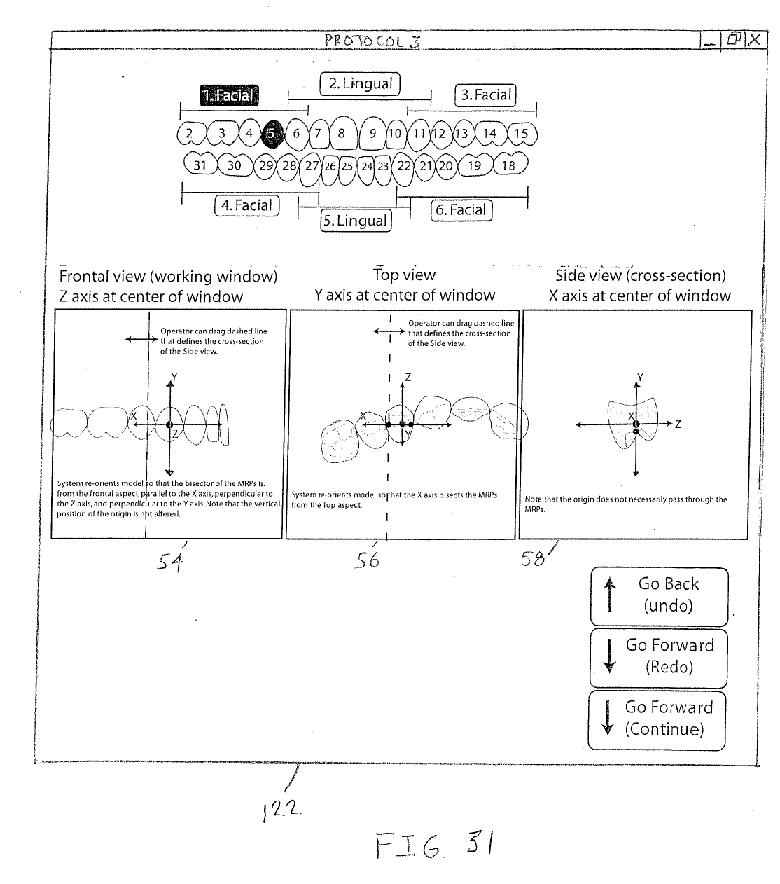

When the user clicks the “Continue” button to proceed, the screen 120 illustrated in FIG. 30 is displayed. Windows 56 and 58 become working windows, and the user can adjust the positions of the marginal ridge point dots in those windows, if necessary, as described above with regard to other screens.

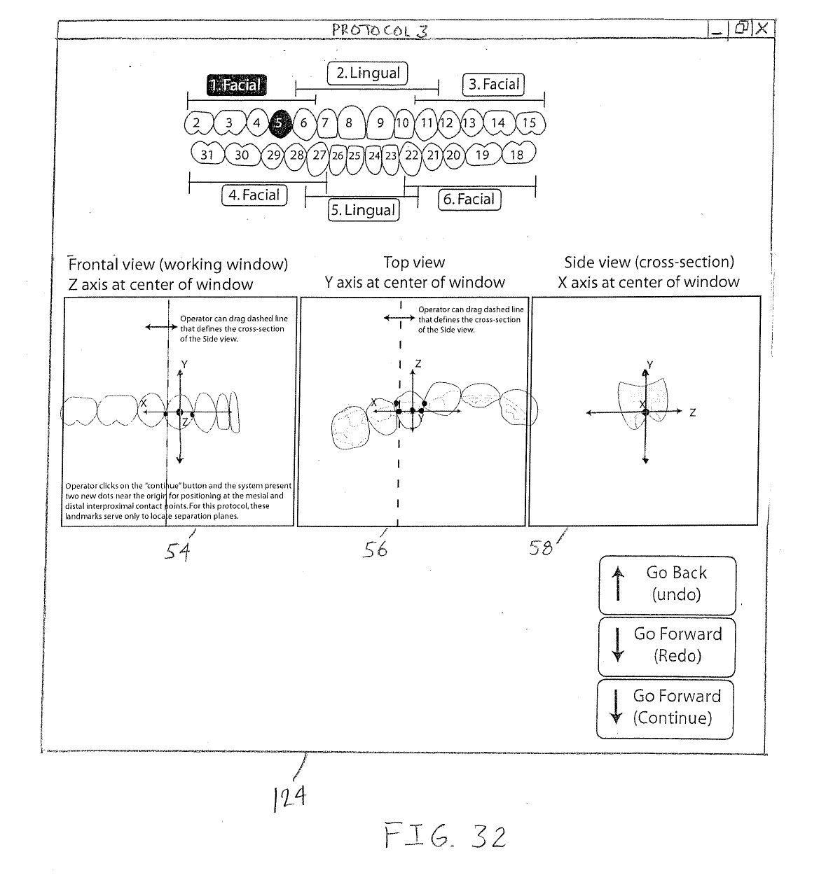

When the user clicks the “Continue” button to proceed, the position of virtual model 28 with respect to the reference system is recomputed, and the screen 122 illustrated in FIG. 31 is displayed. Screen 122 is similar to screens described above, but virtual model 28 is depicted in windows 54, 56 and 58 in the recomputed orientation. Note in window 56 that in the recomputed orientation the X axis intersects the two MRP dots. Note in window 58 that the original does not necessarily pass through the MRPs.

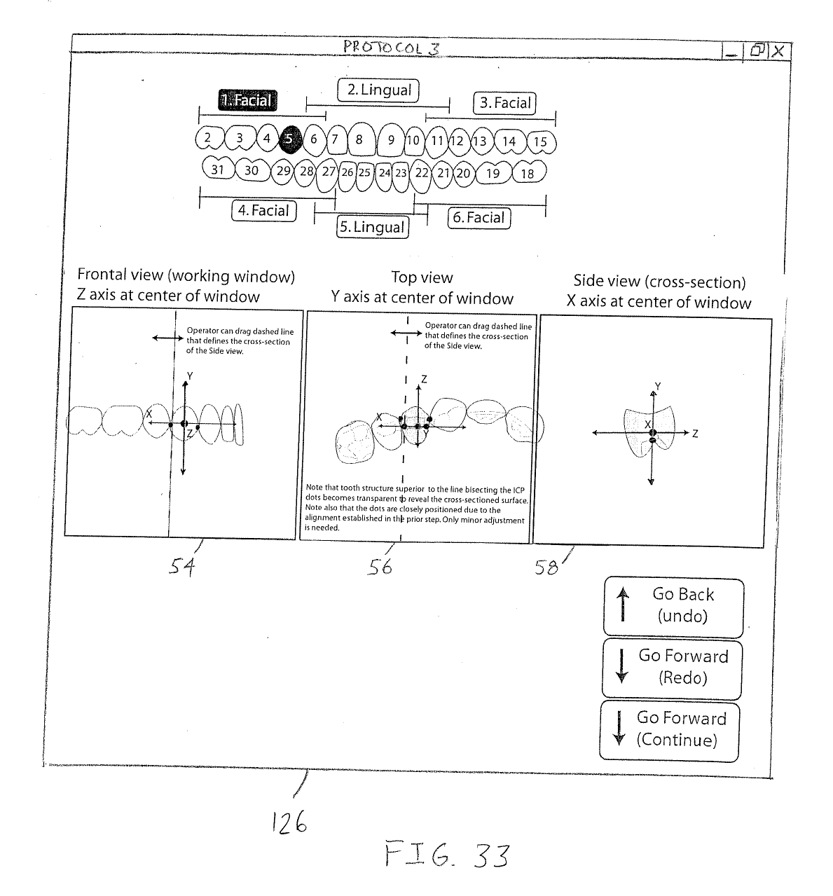

When the user clicks the “Continue” button to proceed, the screen 124 illustrated in FIG. 32 is displayed. Two additional dots are displayed. The user drags these dots to point on tooth #5 that the user judges to be the mesial and distal ICPs.

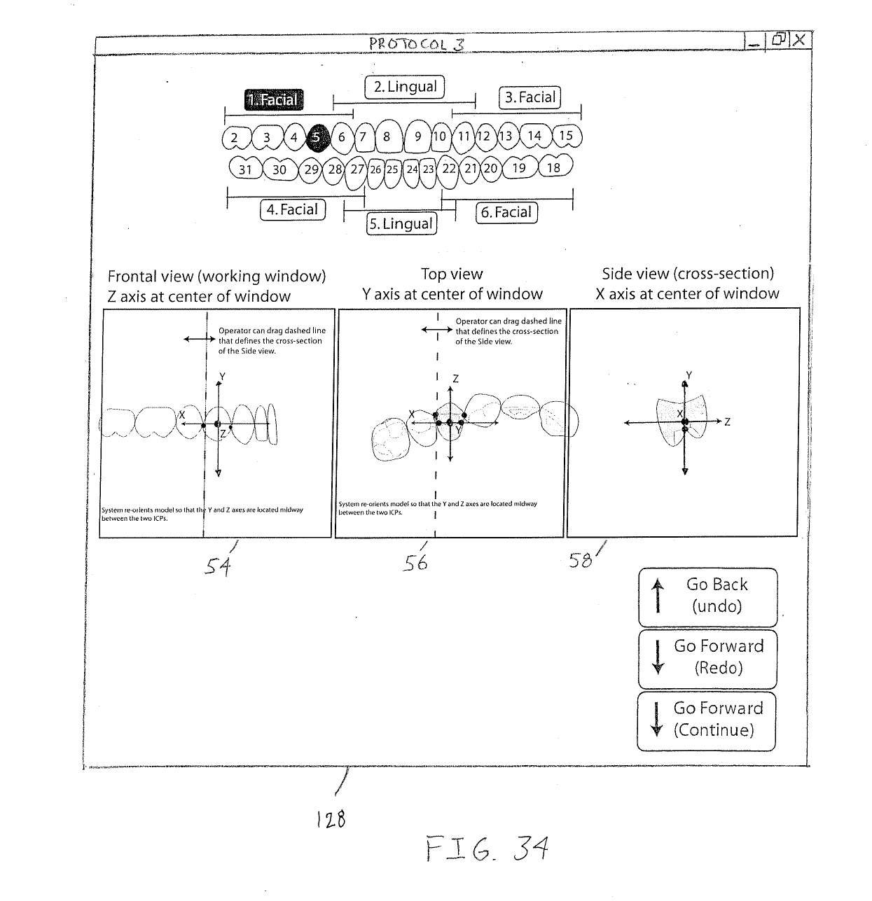

When the user clicks the “Continue” button to proceed, the screen 126 illustrated in FIG. 33 is displayed. Screen 126 is similar to screens described above, but now both windows 54 and 56 are working windows. If necessary, the user can drag one or both dots in, for example, window 56, to more accurately position them on the points that the user judges to be the mesial and distal ICPs.

When the user clicks the “Continue” button to proceed, the orientation of virtual model 28 is recomputed, and the screen 128 illustrated in FIG. 34 is displayed. Note in windows 54 and 56 that the Y and Z axes are positioned mid-way between the two ICPs, and in window 56 that the X axis intersects the two ICPs.

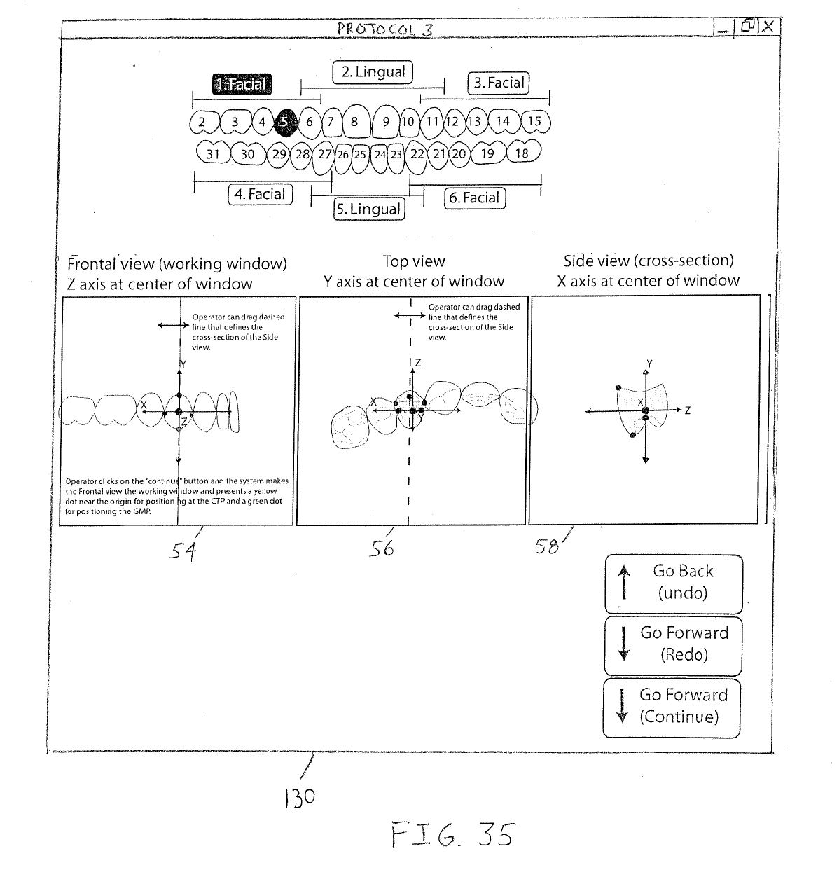

When the user clicks the “Continue” button to proceed, the screen 130 illustrated in FIG. 35 is displayed. Two additional dots are displayed for the user to drag to points on tooth #5 that the user judges to be GMP and CTP, respectively.

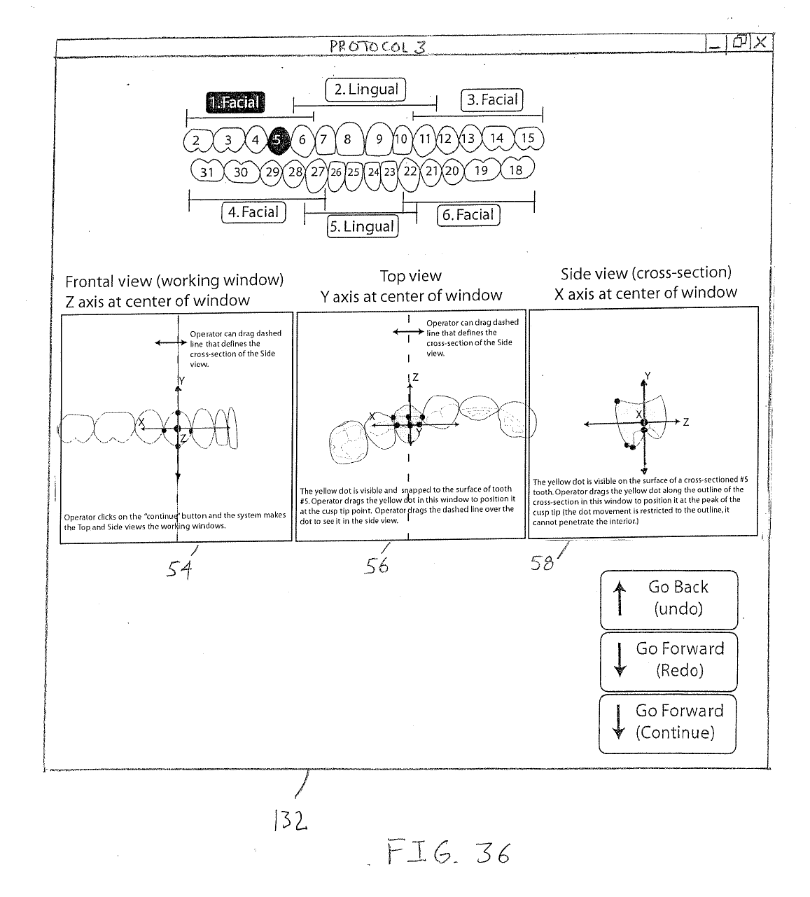

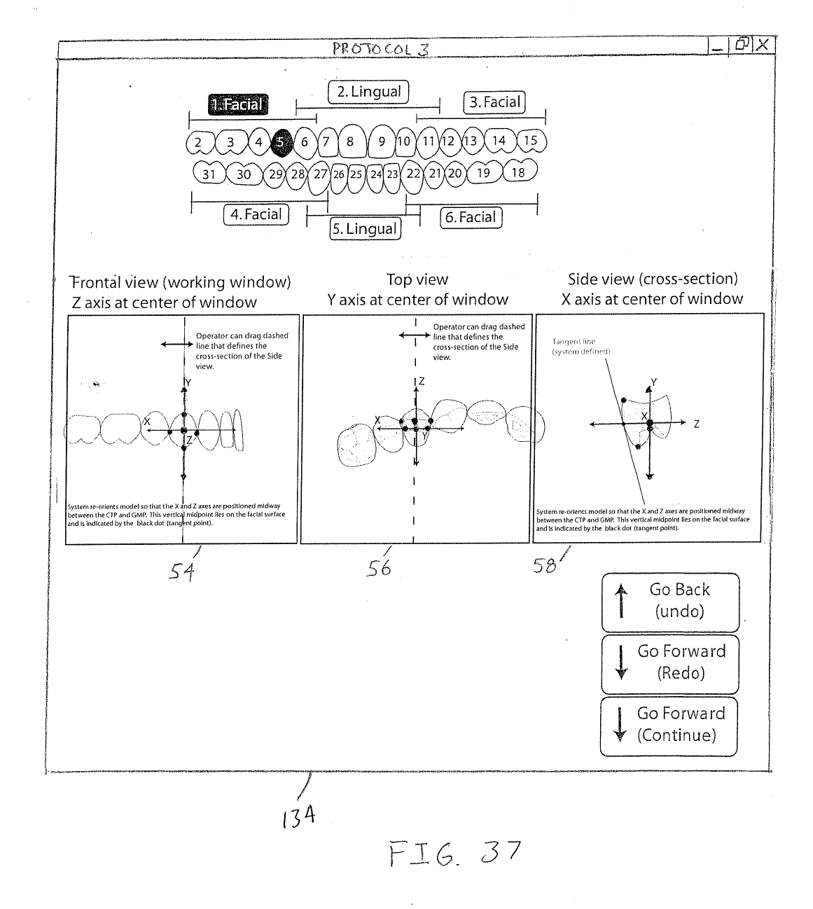

When the user clicks the “Continue” button to proceed, the screen 132 illustrated in FIG. 36 is displayed. If necessary, the user can drag one or both of the GMP and CTP dots in window 56 or 58, to more accurately position them. As shown in FIG. 36, the user has adjusted their positions. Note that repositioning the dashed lines over the points judged to be the GMP or CTP in window 54 or 56 can help the user more accurately position the corresponding GMP or CTP dot in window 58. As an aid to the user, the dots in window 58 can behave as though they cannot be dragged into the interior of the tooth but rather only along its periphery.

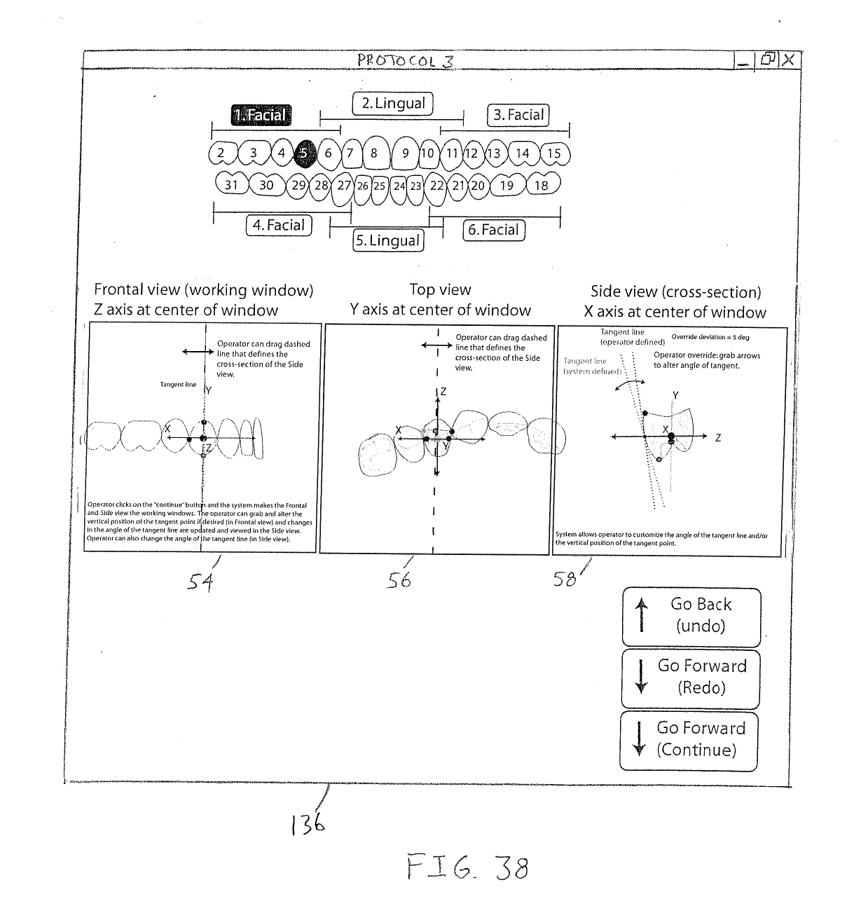

When the user clicks the “Continue” button to proceed, the orientation of virtual model 28 is recomputed, and the screen 134 illustrated in FIG. 37 is displayed. Screen 134 is similar to screens described above, but virtual model 28 is depicted in windows 54, 56 and 58 in the recomputed orientation. Note in window 54 that, if not already so oriented, in the recomputed orientation the X and Z axes have been made to intersect the GMP and CTP dots. Also, a tangent point (e.g., a black dot) has been computed and is displayed in the windows mid-way between the GMP and CTP dots on the Y axis. The orientation of virtual model 28 is then recomputed such that the tangent point is on the Z axis. Note that the tangent point and corresponding tangent line are also displayed in window 58. The tangent line defines the facio-lingual angle (commonly referred to as “torque”) of tooth #5.

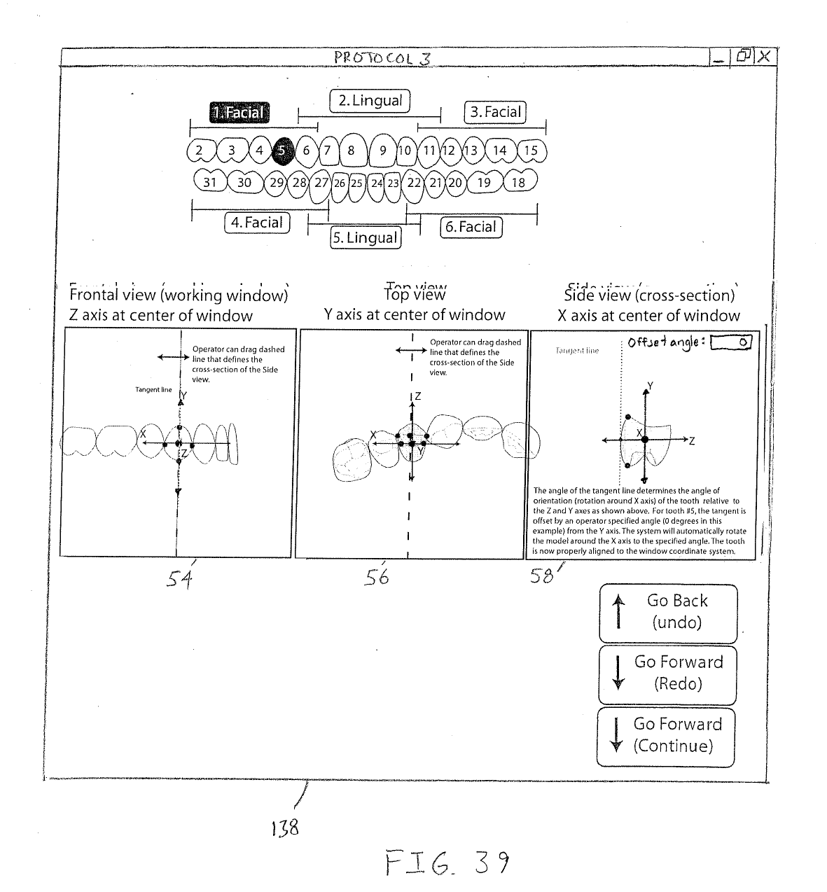

When the user clicks the “Continue” button to proceed, the screen 136 illustrated in FIG. 38 is displayed. In window 54, the user can drag the tangent point dot, if desired. Similarly, the user can drag the tangent line to rotate it about the tangent point in window 58.

When the user clicks the “Continue” button to proceed, the screen 138 illustrated in FIG. 39 is displayed. In window 58, the user can enter an offset angle, which is the number of degrees by which the tangent line is to be offset from the Y axis. The angle of the tangent line determines the angle of orientation (rotation about the X axis) of the tooth relative to the Y and Z axes. If the user enters a nonzero offset angle, the orientation of virtual model 28 is recomputed such that it is rotated about the X axis by that number of degrees.

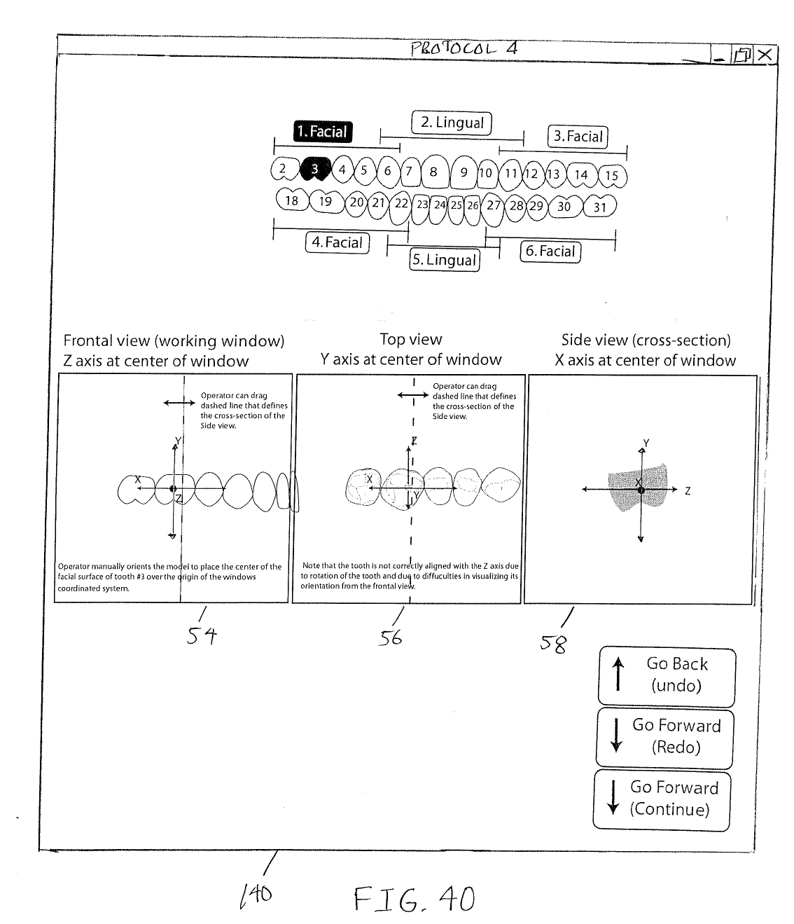

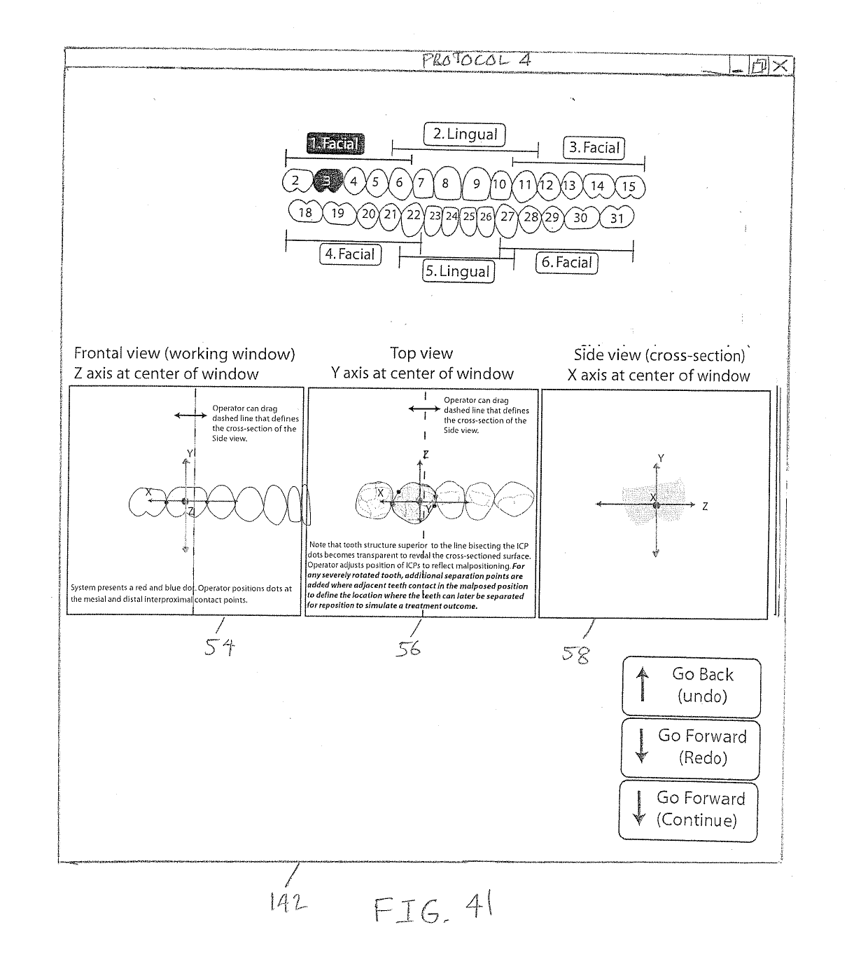

The following is a similar description for Protocol 4. As illustrated in FIG. 40, a screen 140, similar to those described above, is displayed in response to the user having selected, for example, tooth #3. As described above, Protocol 4 can be the default protocol that is invoked when the user selects tooth #3 or a similar tooth, or, alternatively or in addition, can be a protocol that the user selects through a menu. Window 54 is the working window. The user can orient the depiction of the teeth by dragging it in window 54 until the center of the facial surface of tooth #3 is centered on the origin (0,0,0). In response, the position of virtual model 28 with respect to the reference system is recomputed. Note in window 56 that tooth #3 is not correctly aligned with the Z axis due to rotation of the tooth and difficulties visualizing its orientation from the front view (window 54).

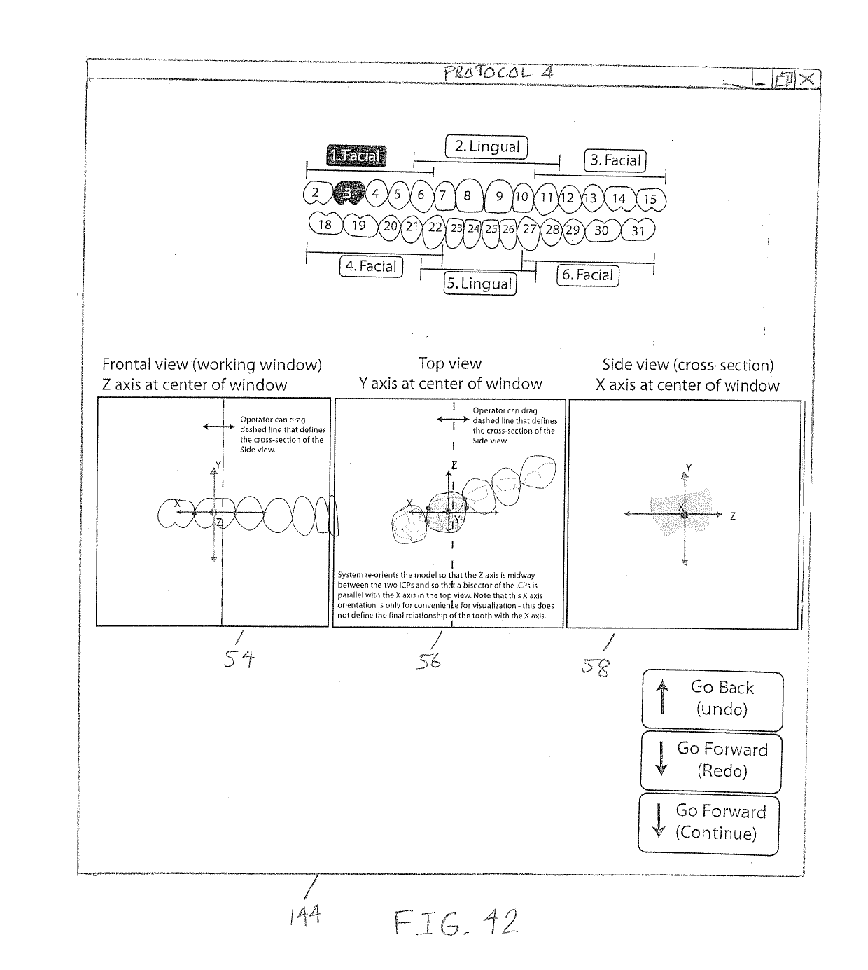

When the user clicks the “Continue” button to proceed, the screen 142 illustrated in FIG. 41 is displayed. Two dots are displayed that the user can drag to point on tooth #3 that the user judges to be the mesial and distal ICPs. If necessary, the user can adjust the ICP dots in window 56 to more accurately position them. An additional feature is illustrated in which the user can mark additional separation points between adjacent teeth, which a user may wish to do if, for example, a tooth is severely rotated. A user can, for example, click on a button (not shown) to request additional dots to position on the tooth. The user drags these additional dots to the points where the severely rotated tooth contacts adjacent teeth. Marking these separation points can be useful for facilitating other operations, such as simulating a treatment outcome, in which the algorithm needs to know the boundaries of individual teeth. In the case of teeth that are not severely rotated, such an algorithm can determine the boundaries of individual teeth from the ICPs that the user has marked. Alternatively, the method can include an additional step in which the user defines planes that separate each tooth from adjacent teeth. Any part of virtual model 28 that lies between two such separation planes can be represented as belonging to the same tooth for purposes of simulating a treatment or performing other operations.

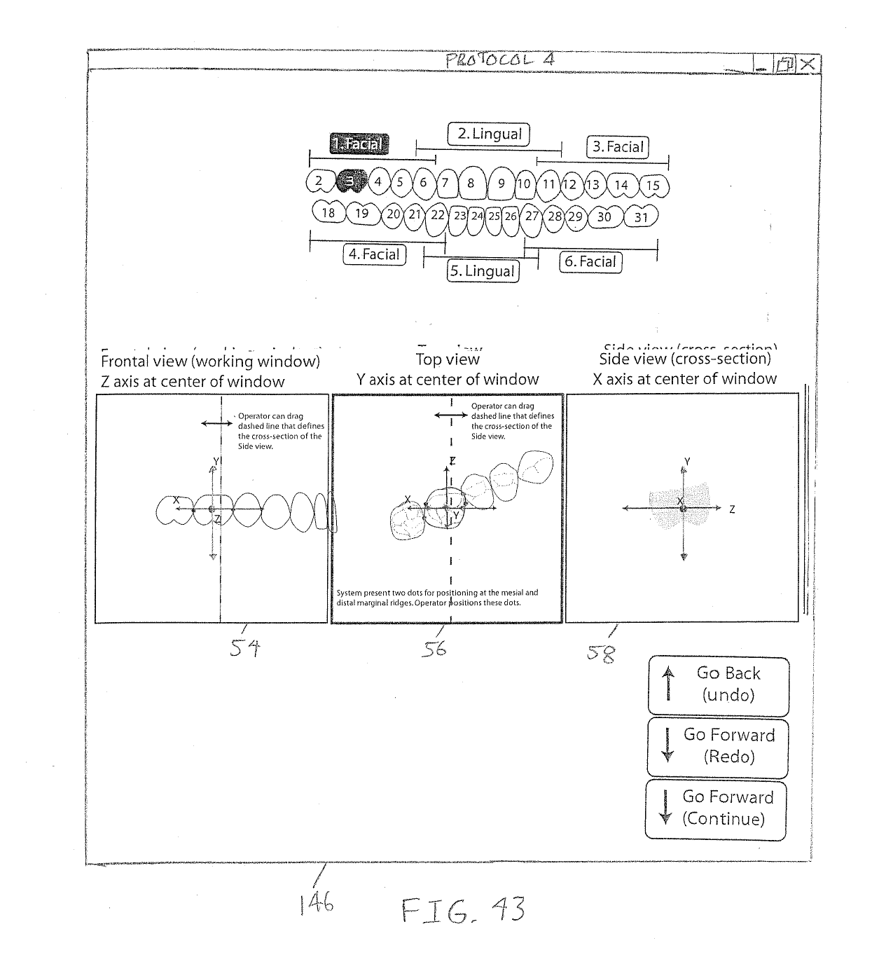

When the user clicks the “Continue” button to proceed, the position of virtual model 28 with respect to the reference system is recomputed, and the screen 144 illustrated in FIG. 42 is displayed. In the recomputed orientation, as seen in window 56, the Z axis is mid-way between the two ICPs such that a reference line (not shown) intersecting the ICPs is parallel with the X axis, as shown in window 56. Note that this re-orientation is mainly performed as a visualization aid and does not define the final relationship of the tooth with the X axis.

When the user clicks the “Continue” button to proceed, the screen 146 illustrated in FIG. 43 is displayed. Two dots are displayed that the user can drag to points on tooth #3 that the user judges to be the mesial and distal marginal ridge points (MRPs).

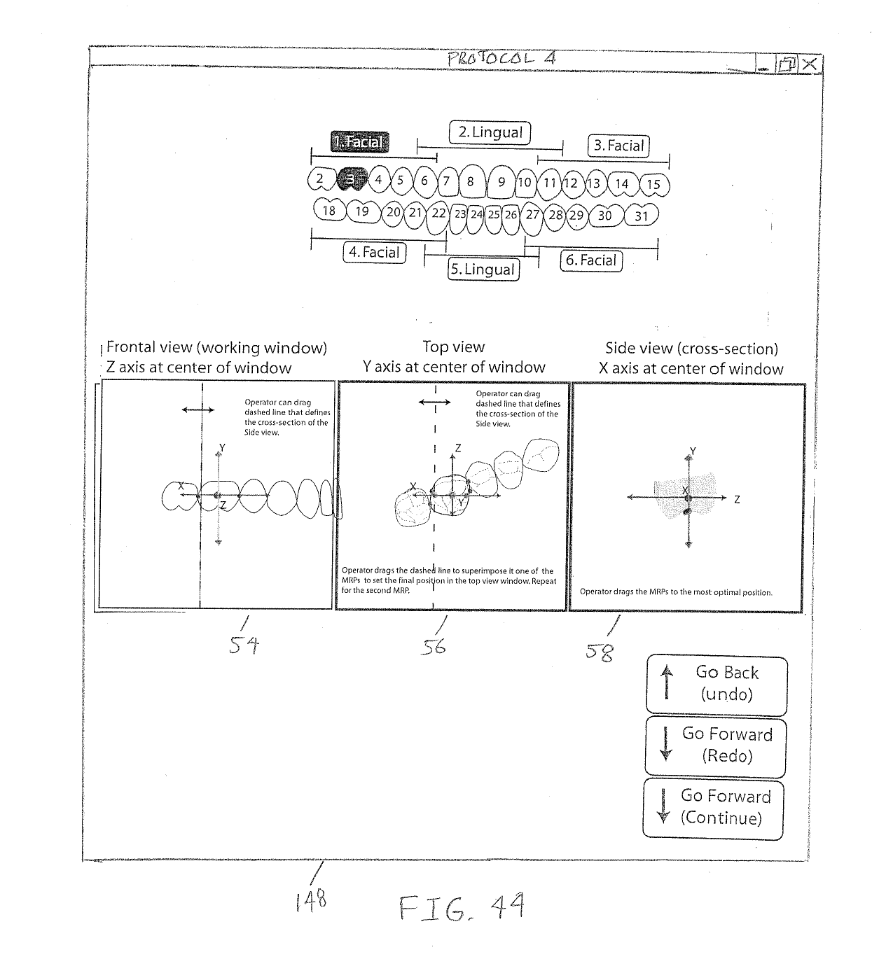

When the user clicks the “Continue” button to proceed, the screen 148 illustrated in FIG. 44 is displayed. If necessary, the user can adjust the MRP dots in window 58 to more accurately position them. The user can drag the dashed line to superimpose it on an MRP dot to provide a cross-section that aids positioning it in window 58.

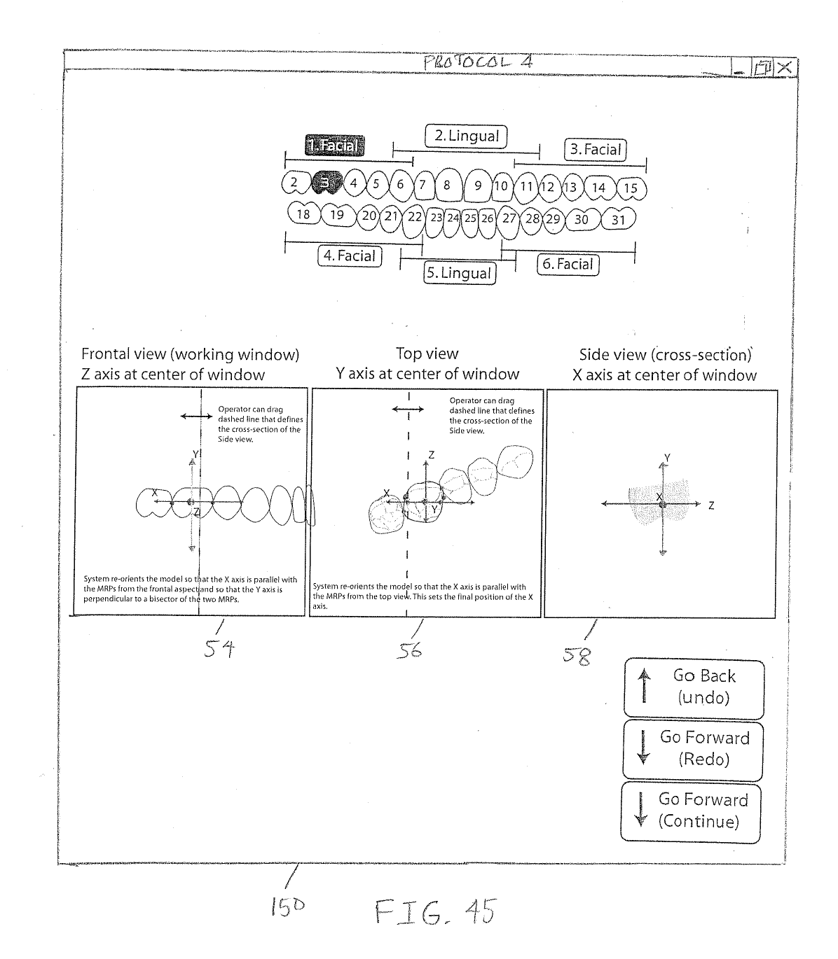

When the user clicks the “Continue” button to proceed, the position of virtual model 28 with respect to the reference system is recomputed, and the screen 150 illustrated in FIG. 45 is displayed. In the recomputed orientation, the X axis is parallel to a reference line (not shown) that intersects the two MRPs (as can be seen in window 56), and the Y axis is perpendicular to the reference line.

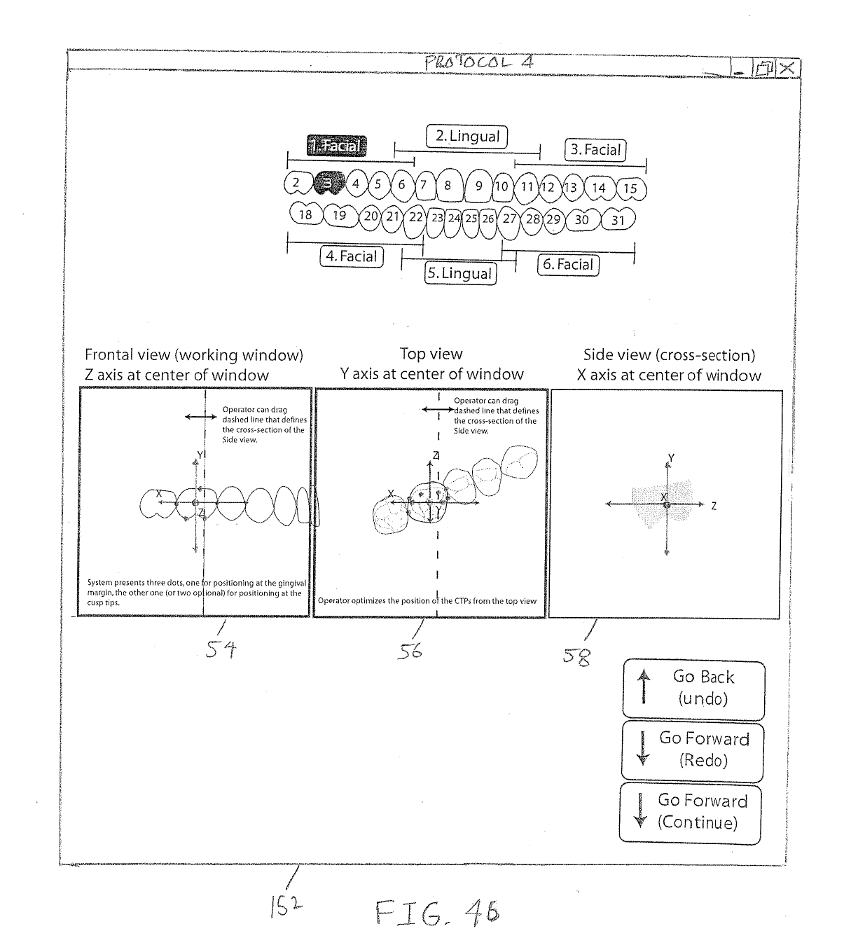

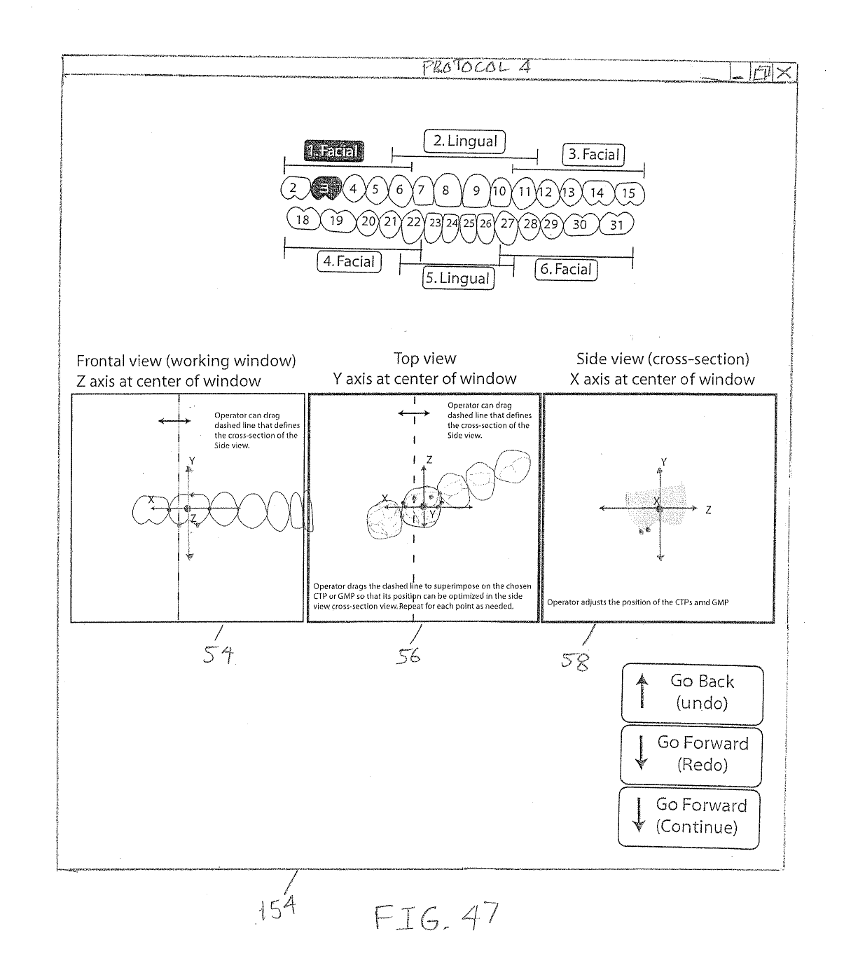

When the user clicks the “Continue” button to proceed, the screen 152 illustrated in FIG. 46 is displayed. Three additional dots are displayed. The user can drag one dot to the point the user judges to be the GMP and drag the other two dots to the points the user judges to be the CTPs. Both windows 54 and 56 are working windows, and the user can drag the dots in either window. As in every case, the positions in which the same dots are depicted in the other windows change automatically in response to the user dragging them in one window. Although there are several dots displayed, it should be kept in mind that each dot can have a distinct color to distinguish it from the others, as described above.

When the user clicks the “Continue” button to proceed, the screen 154 illustrated in FIG. 47 is displayed. If necessary, the user can adjust the CTP and GMP dots in window 58 to more accurately position them. The user can drag the dashed line to superimpose it on a CTP or GMP dot to provide a cross-section that aids positioning it in window 58.

When the user clicks the “Continue” button to proceed, the position of virtual model 28 with respect to the reference system is recomputed, and the screen 156 illustrated in FIG. 48 is displayed. In the recomputed orientation, the Z axis is equidistant along the Y axis from the GMP and a point positioned at the average of the two distances from the two CTPs. (In other embodiments of the invention, only a single CTP dot may be provided, and in such embodiments the Z axis would be equidistant from the GMP and the CTP.)

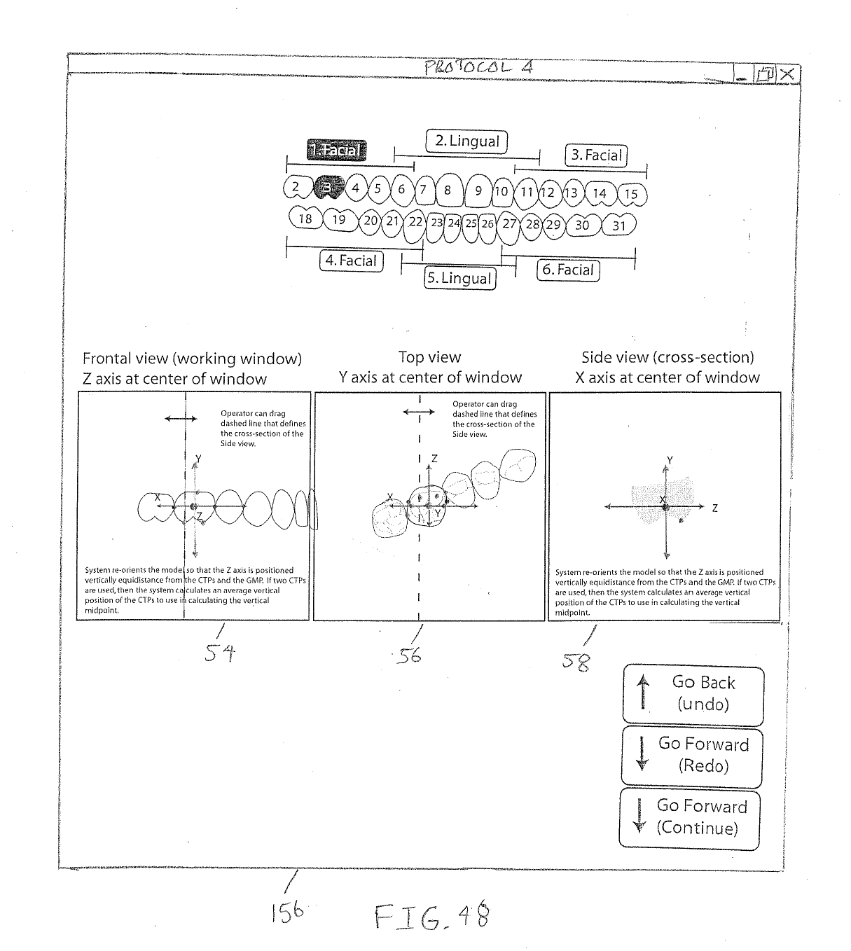

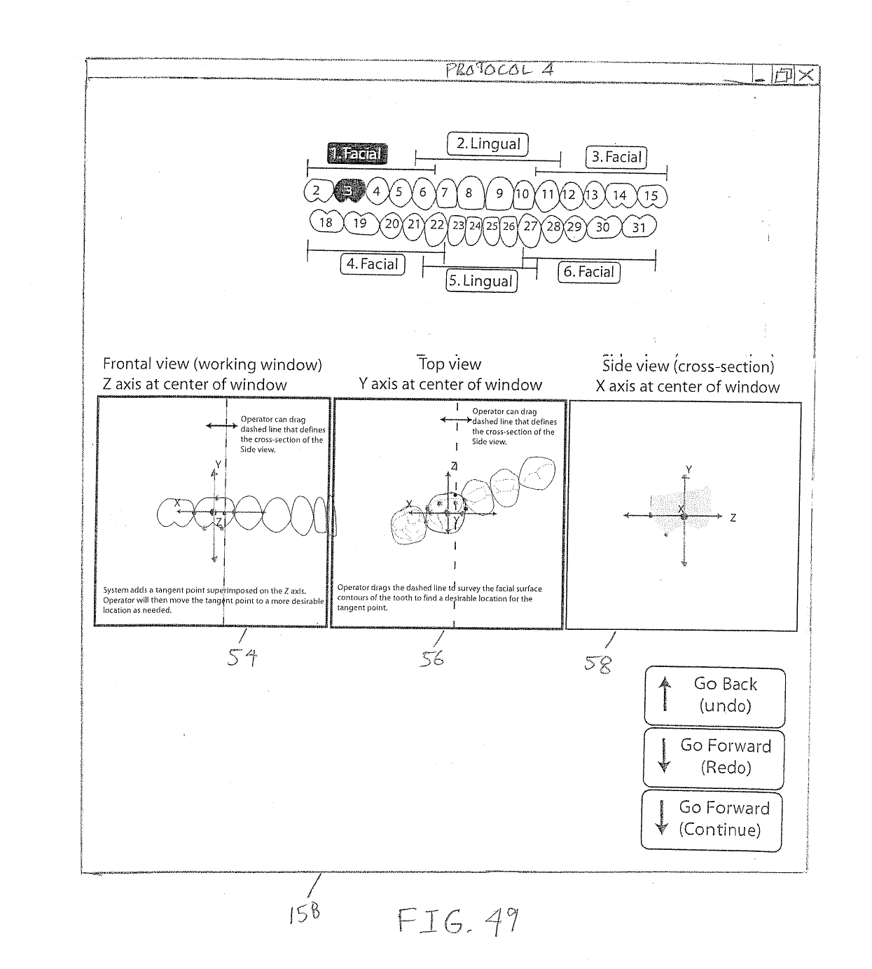

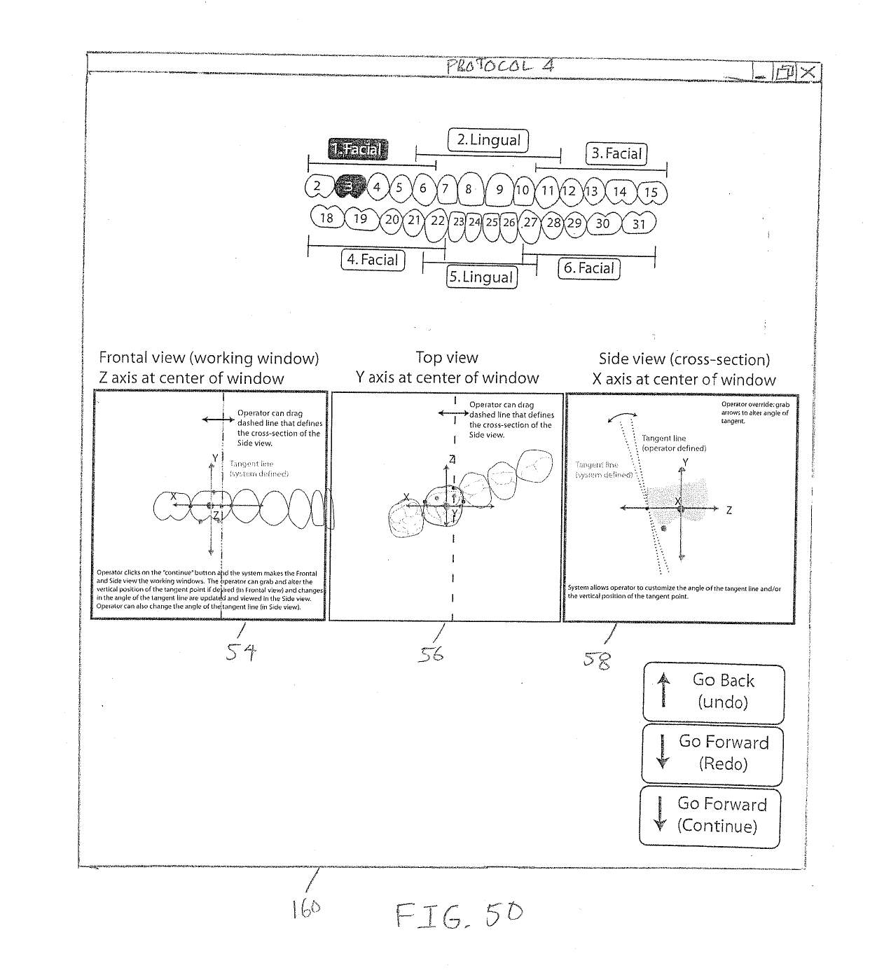

When the user clicks the “Continue” button to proceed, the screen 158 illustrated in FIG. 49 is displayed. A tangent point has been computed and is displayed in window 54 as superimposed on the Z axis. The user can drag the tangent point in window 54, if desired. Dragging the dashed line in window 56 to view the contours of the tooth in window 58 can aid the user in determining where to mark the tangent point.

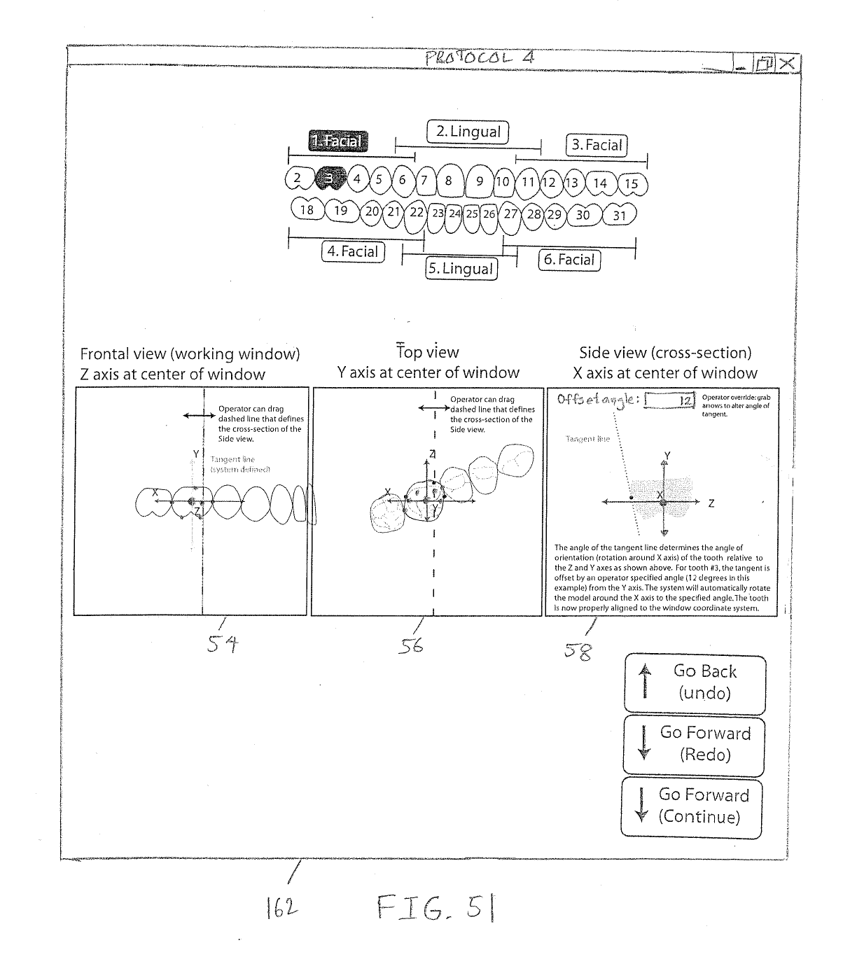

When the user clicks the “Continue” button to proceed, the screen 160 illustrated in FIG. 50 is displayed. A tangent line has been computed, tangent to the surface of tooth #3 at the tangent point. The tangent line defines the facio-lingual angle or torque of tooth #3. The user can drag the tangent line to rotate it about the tangent point in window 58, if desired. The user can drag the tangent point in window 54, if desired to, for example, change its vertical position.

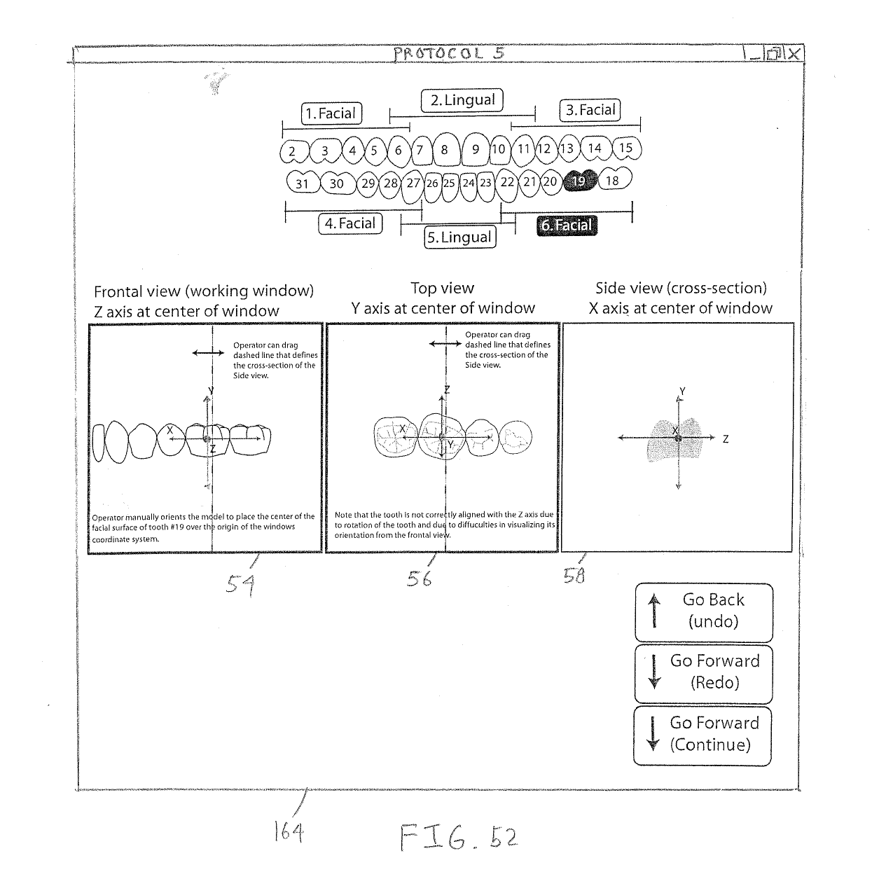

When the user clicks the “Continue” button to proceed, the screen 162 illustrated in FIG. 51 is displayed. In window 58, the user can enter an offset angle, which is the number of degrees by which the tangent line is to be offset from the Y axis. The angle of the tangent line determines the angle of orientation (rotation about the X axis) of the tooth relative to the Y and Z axes. If the user enters a nonzero offset angle, the orientation of virtual model 28 is recomputed such that it is rotated about the X axis by that number of degrees. An offset angle of 12 degrees has been entered as an example.

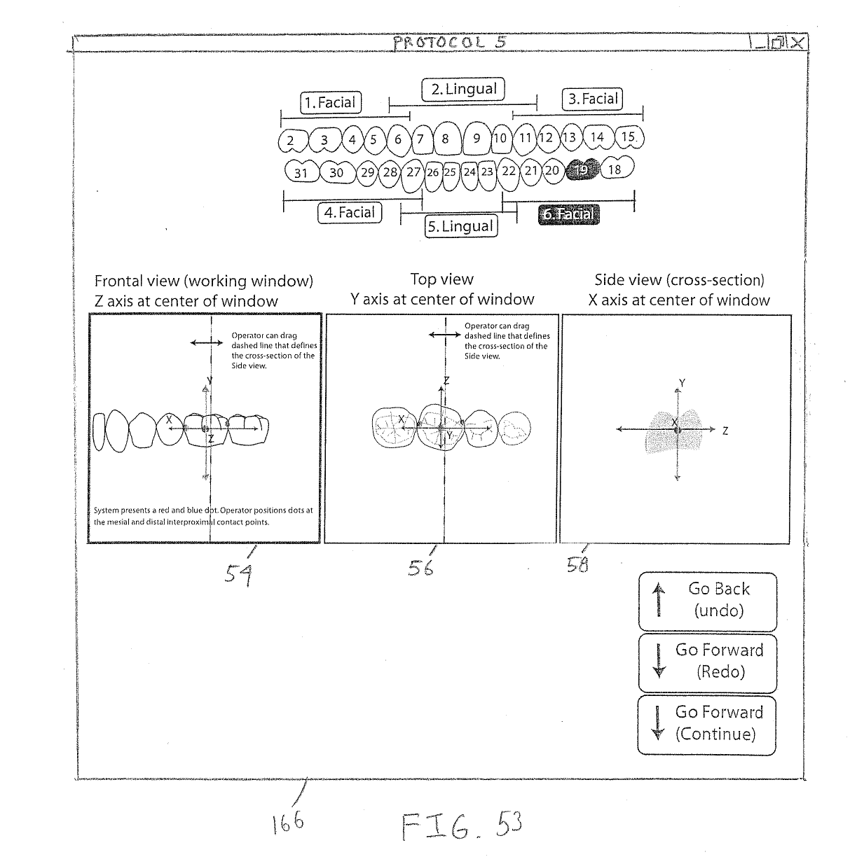

The following is a similar description for Protocol 5. As illustrated in FIG. 52, a screen 164, similar to those described above, is displayed in response to the user having selected, for example, tooth #19. As described above, Protocol 5 can be the default protocol that is invoked when the user selects tooth #19 or a similar tooth, or, alternatively or in addition, can be a protocol that the user selects through a menu. Window 54 is the working window. As in the initial screens relating to the other protocols described above, the user can orient the depiction of the teeth by dragging it in window 54 until the center of the facial surface of tooth #19 is centered on the origin (0,0,0). In response to the user orienting the depiction of the teeth at this step, the position of virtual model 28 with respect to the reference system is recomputed. Note in window 56 that tooth #19 is not correctly aligned with the Z axis due to rotation of the tooth and difficulties visualizing its orientation from the front view (window 54).

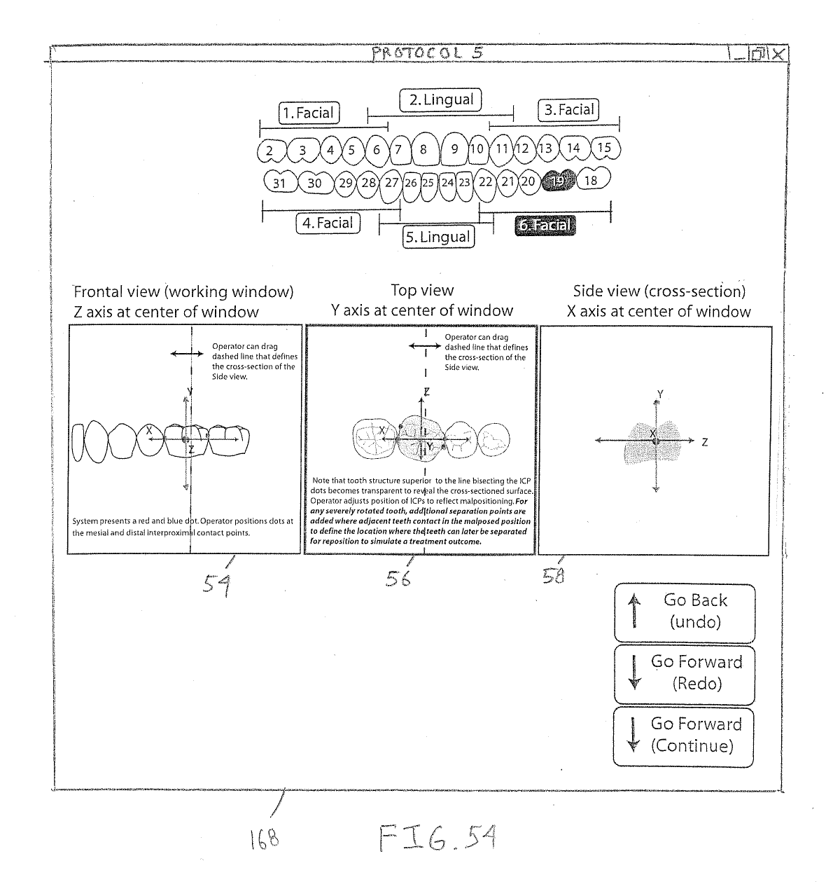

When the user clicks the “Continue” button to proceed, the screen 166 illustrated in FIG. 53 is displayed. Two dots (e.g., red and blue) are displayed, which the user can drag to points on tooth #19 that the user judges to be the mesial and distal ICPs, respectively.

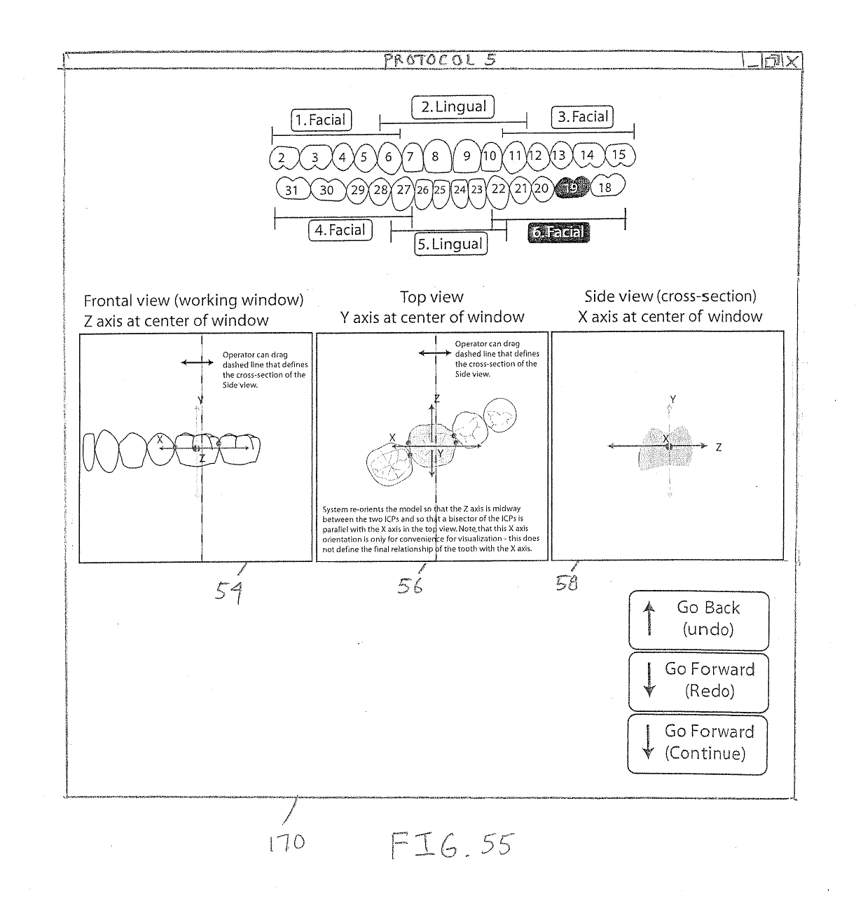

When the user clicks the “Continue” button to proceed, the screen 168 illustrated in FIG. 54 is displayed. If necessary, the user can drag one or both dots in window 56 to more accurately position them. As described above with regard to other protocols, the user can mark additional separation points or planes between adjacent teeth because tooth #19 in this example is severely rotated, and the ICPs may not represent the tooth contacts or boundaries. The user indicates the need for such additional marking dots (e.g., by clicking on a button or menu option (not shown)), and then drags them to the points where the severely rotated tooth contacts adjacent teeth.

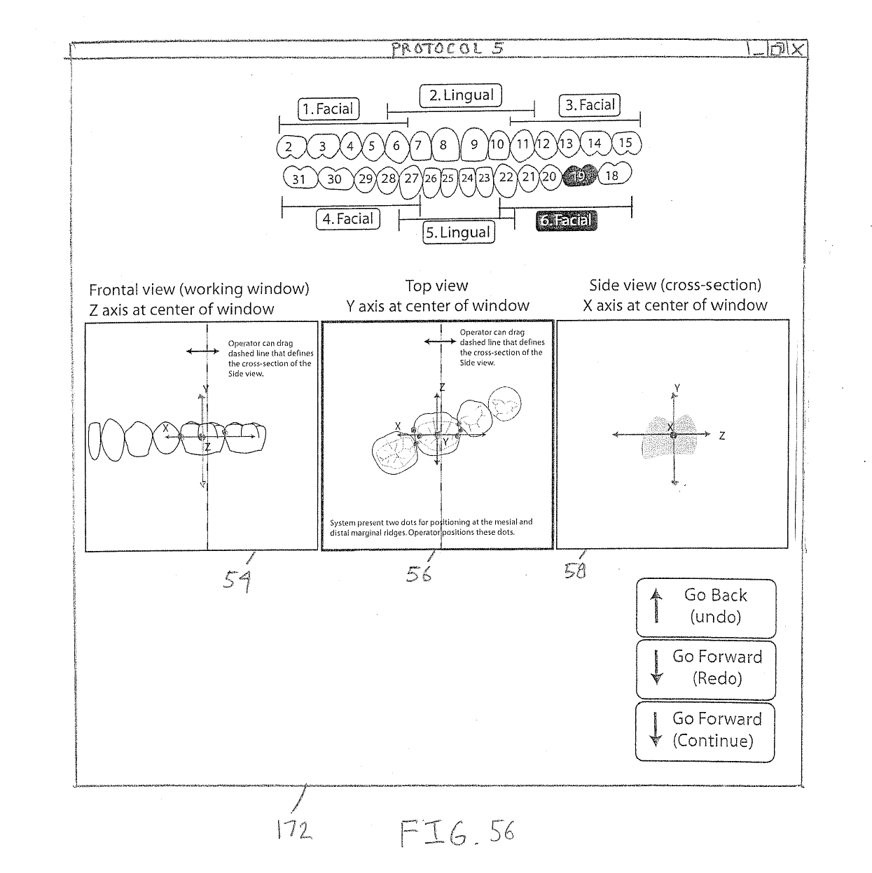

When the user clicks the “Continue” button to proceed, the orientation of virtual model 28 is recomputed, and the screen 170 illustrated in FIG. 55 is displayed. Virtual model 28 is depicted in windows 54, 56 and 58 in the recomputed orientation. Note in window 56 that the X axis is positioned mid-way between the two ICPs, and that X axis is parallel to a reference line (not shown) intersecting the two ICPs. This orientation is provided to facilitate visualization by the user and does not define the final orientation of the tooth with respect to the X axis.

When the user clicks the “Continue” button to proceed, the screen 172 illustrated in FIG. 56 is displayed. Two dots are displayed that the user can drag to points on tooth #19 that the user judges to be the mesial and distal MRPs.

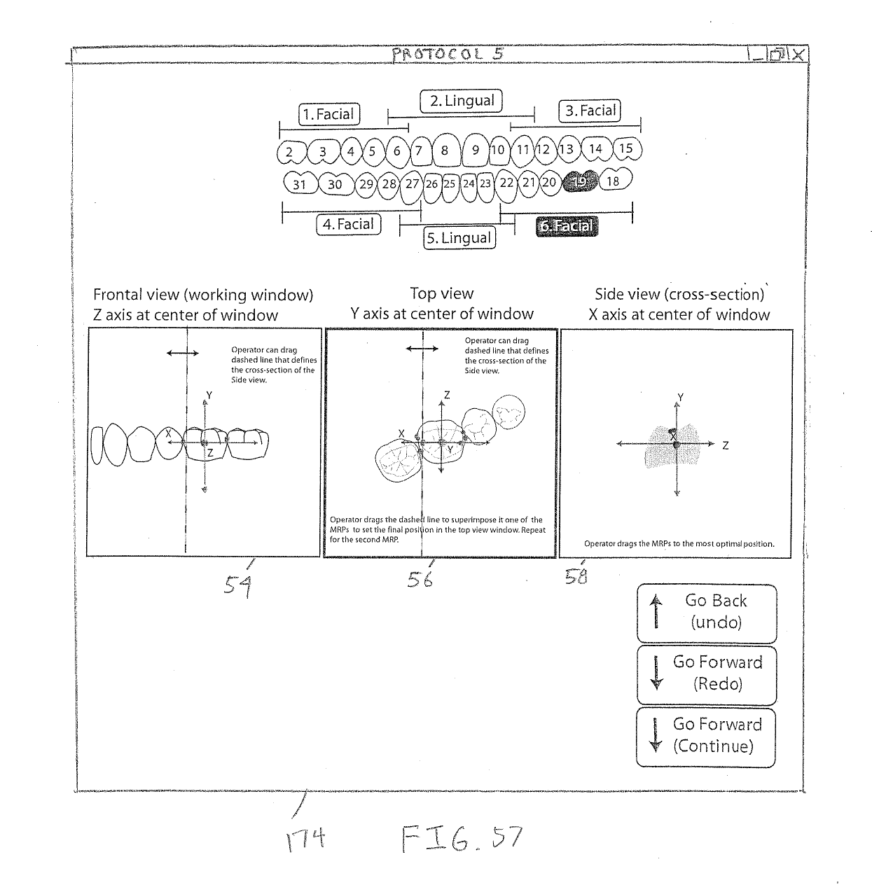

When the user clicks the “Continue” button to proceed, the screen 174 illustrated in FIG. 57 is displayed. If necessary, the user can adjust the MRP dots in window 58 to more accurately position them. The user can drag the dashed line to superimpose it on an MRP dot to provide a cross-section that aids positioning it in window 58.

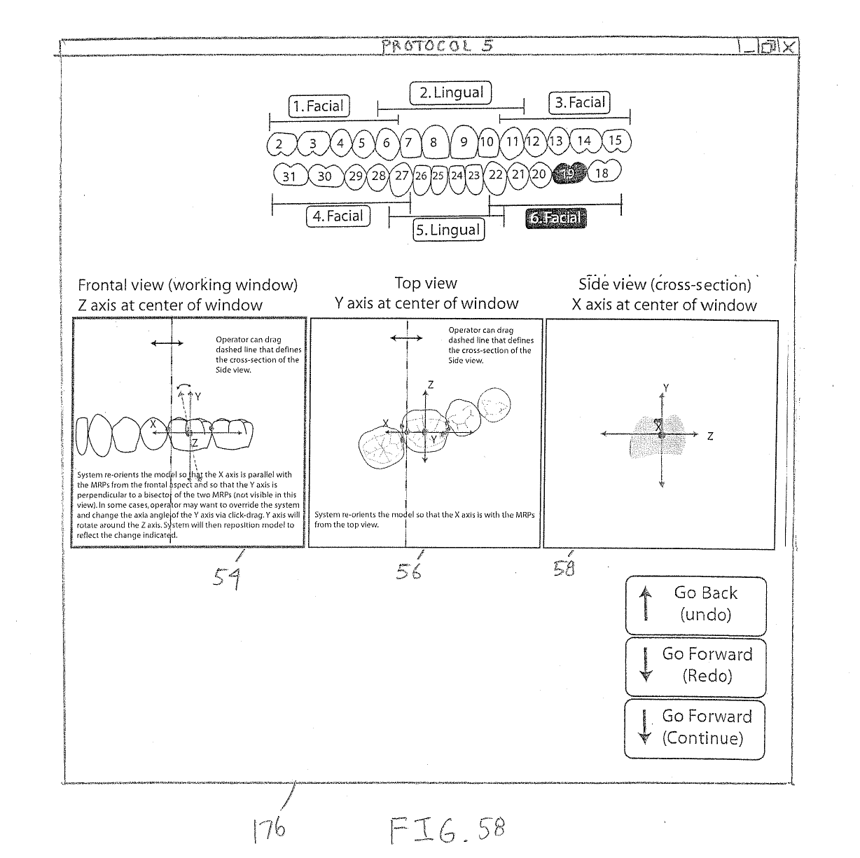

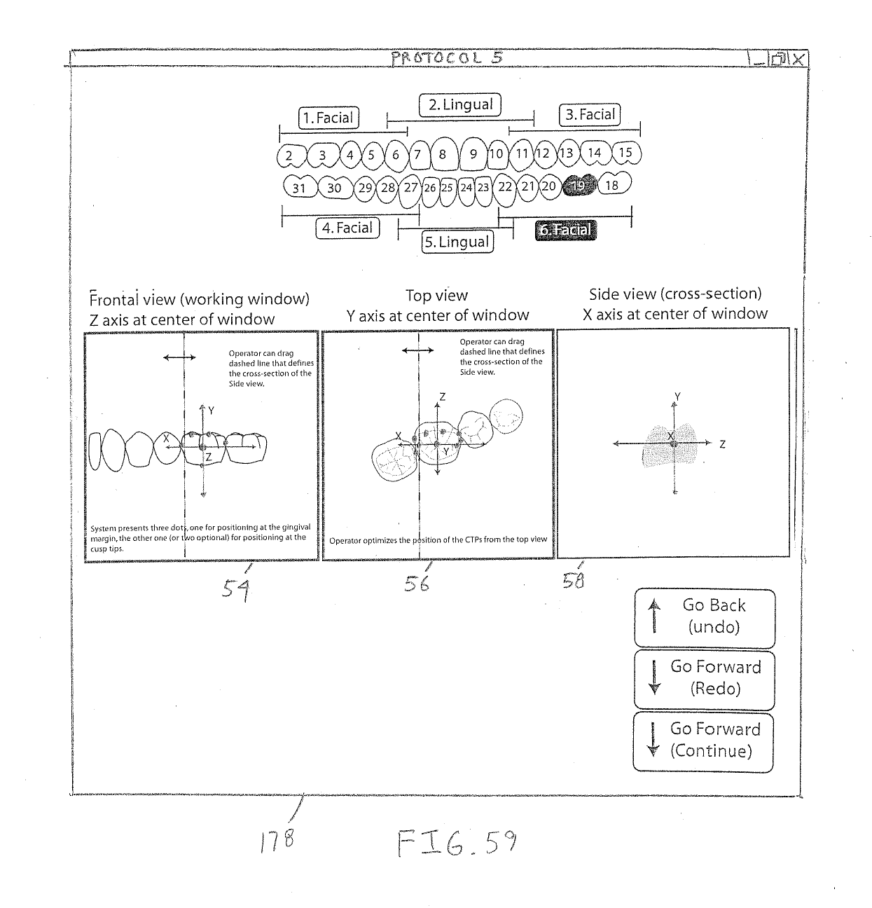

When the user clicks the “Continue” button to proceed, the position of virtual model 28 with respect to the reference system is recomputed, and the screen 176 illustrated in FIG. 58 is displayed. In the recomputed orientation, the X axis is parallel to a reference line (not shown) that intersects the two MRPs (as can be seen in window 56), and the Y axis is perpendicular to the reference line. The user can override this positioning, if desired, and drag the Y axis such that it rotates about the Z axis. If the user rotates the Y axis in this manner, the corresponding position of virtual model 28 with respect to the axes is recomputed.

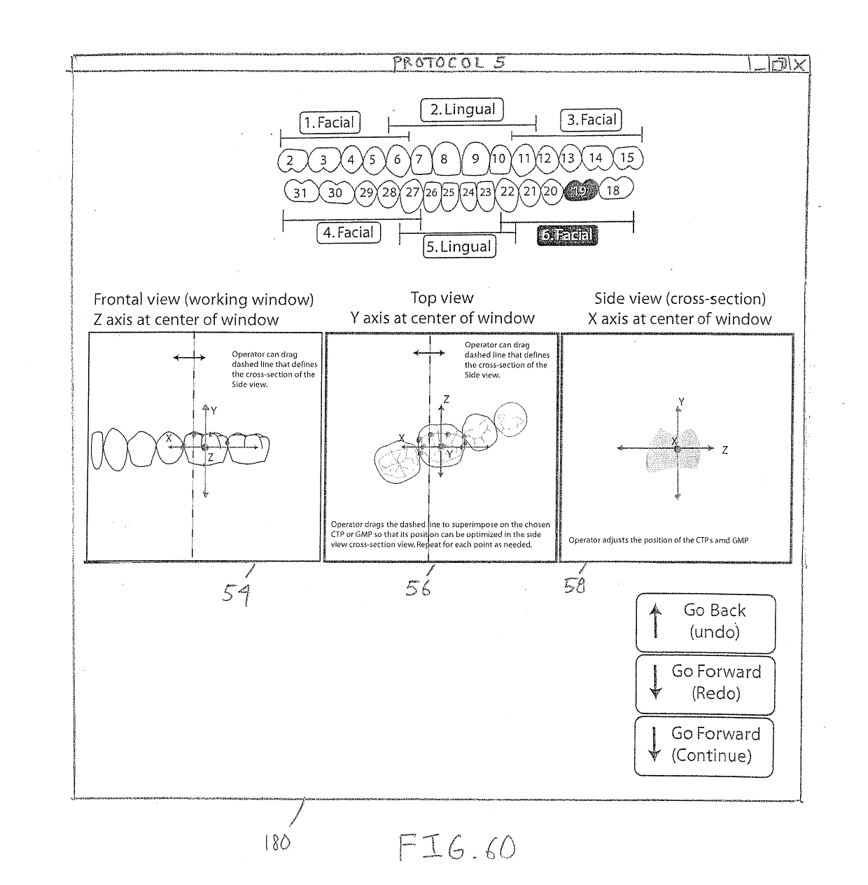

When the user clicks the “Continue” button to proceed, the screen 178 illustrated in FIG. 59 is displayed. Three additional dots are displayed. The user can drag one dot to the point the user judges to be the GMP and drag the other two dots to the points the user judges to be the CTPs. Both windows 54 and 56 are working windows, and the user can drag the dots in either window.

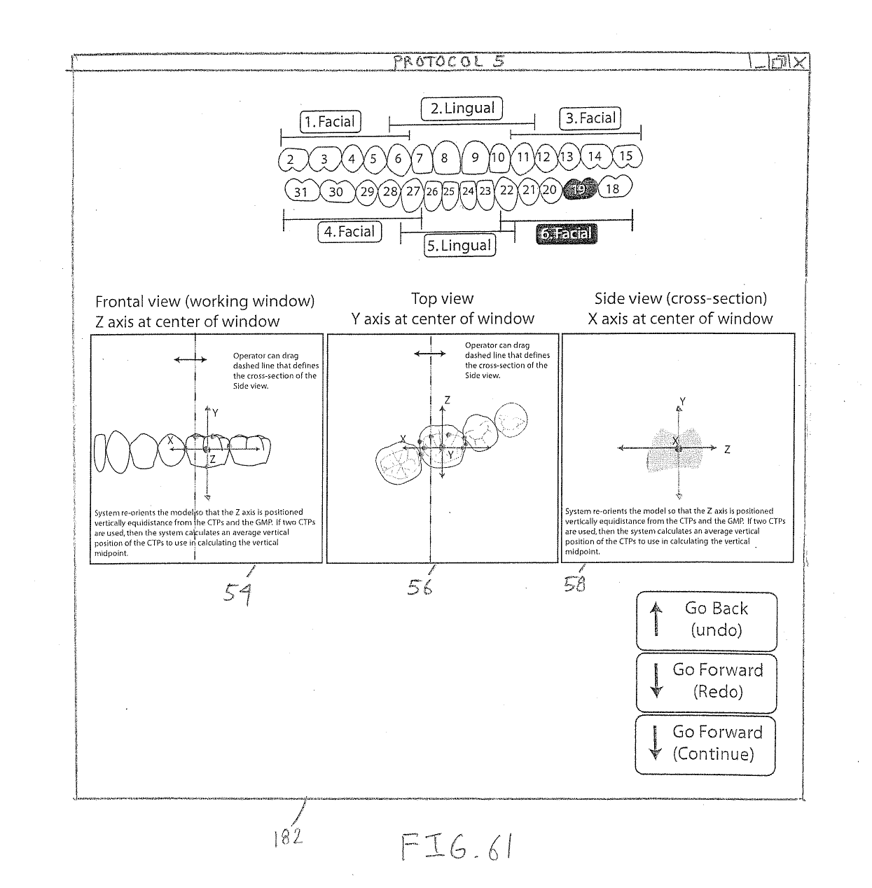

When the user clicks the “Continue” button to proceed, the screen 180 illustrated in FIG. 60 is displayed. If necessary, the user can adjust the CTP and GMP dots in window 58 to more accurately position them. The user can drag the dashed line to superimpose it on a CTP or GMP dot to provide a cross-section that aids positioning it in window 58.

When the user clicks the “Continue” button to proceed, the position of virtual model 28 with respect to the reference system is recomputed, and the screen 182 illustrated in FIG. 61 is displayed. In the recomputed orientation, the Z axis is equidistant along the Y axis from the GMP and a point positioned at the average of the two distances from the two CTPs. (In other embodiments of the invention, only a single CTP dot may be provided, and in such embodiments the Z axis would be equidistant from the GMP and the CTP.)

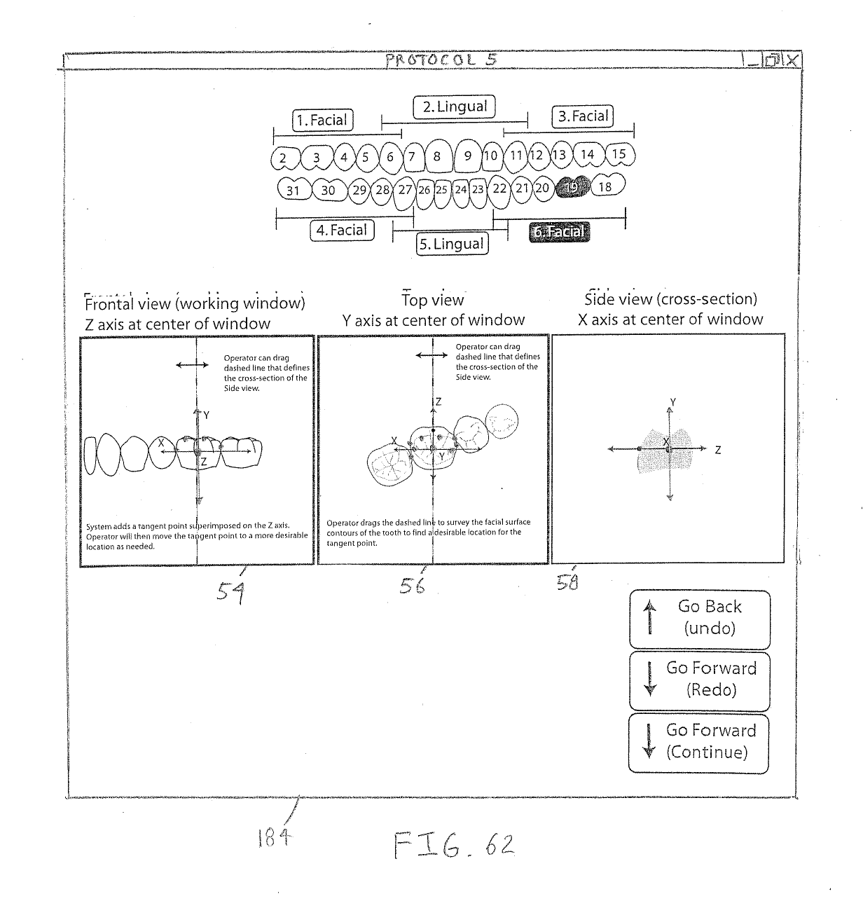

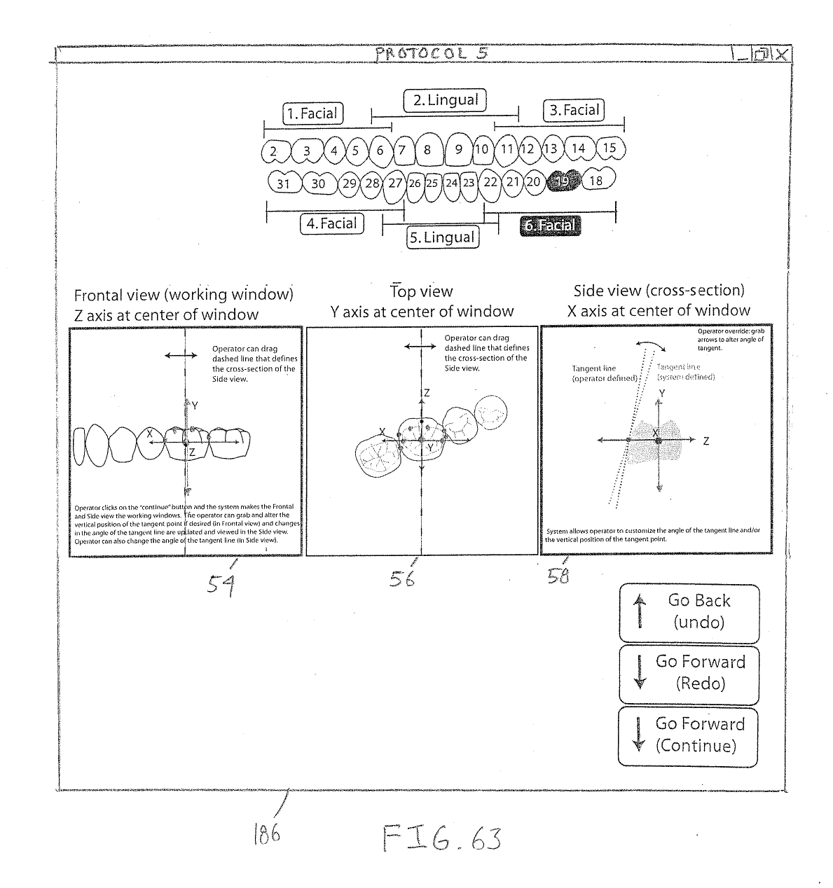

When the user clicks the “Continue” button to proceed, the screen 184 illustrated in FIG. 62 is displayed. A tangent point has been computed and is displayed in window 54 as superimposed on the Z axis. The user can drag the tangent point in window 54, if desired. Dragging the dashed line in window 56 to view the contours of the tooth in window 58 can aid the user in determining where to mark the tangent point.

When the user clicks the “Continue” button to proceed, the screen 186 illustrated in FIG. 63 is displayed. A tangent line has been computed, tangent to the surface of tooth #19 at the tangent point. The tangent line defines the facio-lingual angle or torque of tooth #19. The user can drag the tangent line to rotate it about the tangent point in window 58, if desired. The user can drag the tangent point in window 54, if desired to, for example, change its vertical position. As in every instance, changes made by the user in one window are automatically reflected in response in the other windows.

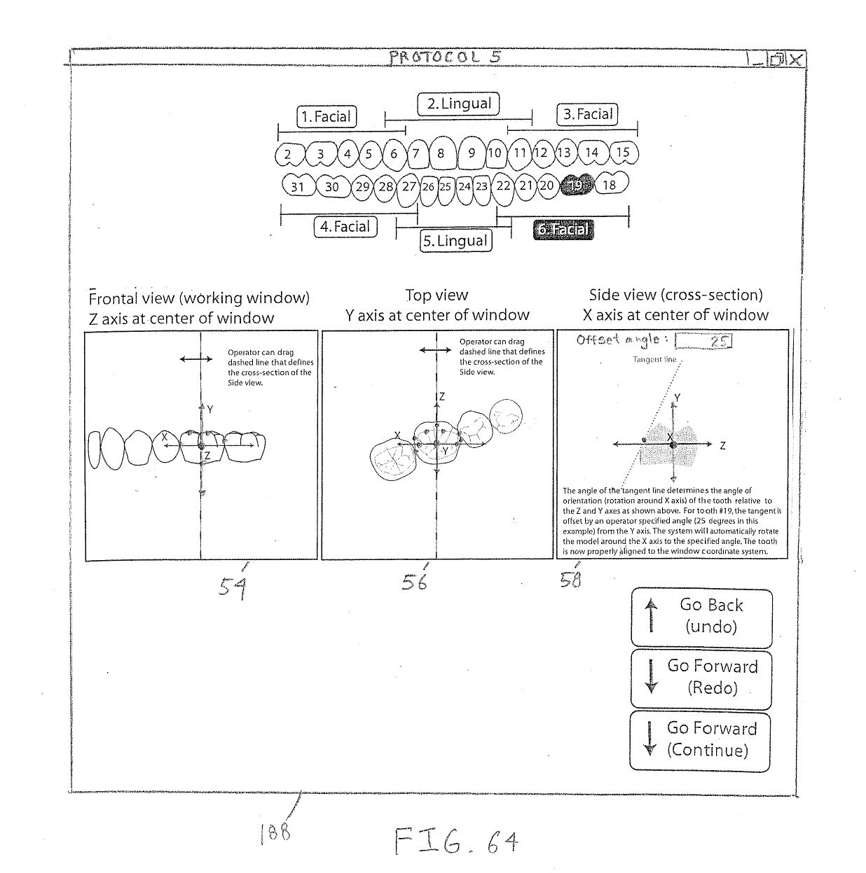

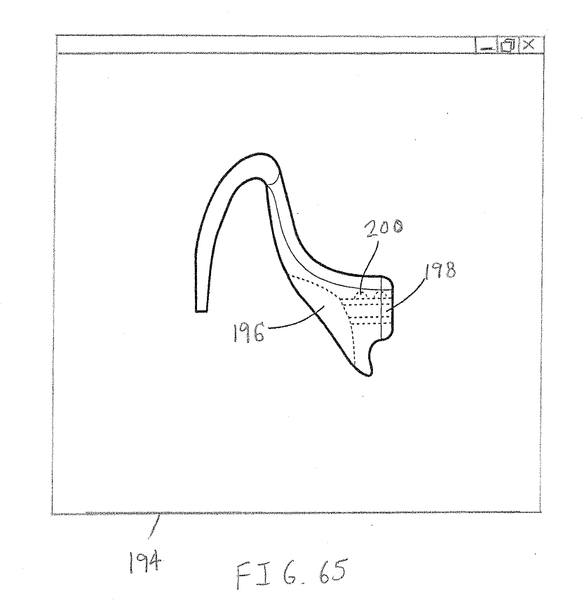

When the user clicks the “Continue” button to proceed, the screen 188 illustrated in FIG. 64 is displayed. In window 58, the user can enter an offset angle, which is the number of degrees by which the tangent line is to be offset from the Y axis. The angle of the tangent line determines the angle of orientation (rotation about the X axis) of the tooth relative to the Y and Z axes. If the user enters a nonzero offset angle, the orientation of virtual model 28 is recomputed such that it is rotated about the X axis by that number of degrees. An offset angle of 25 degrees has been entered as an example.

One or more of the five protocols described above can be used to position a tooth of any anatomical type with respect to a reference system. Nevertheless, the five protocols are intended only to be exemplary, and others may occur to persons skilled in the art in view of the teachings herein. Although each protocol is associated with a group of teeth to which it is believed the protocol can best be applied, a user can choose to apply any of the five protocols or other protocols to any tooth. User-defined protocols (not shown) can also be entered and used in other embodiments of the invention. As described above, the protocols involve instructing the user to mark reference features or landmarks on each tooth. The reference features are then used to orient the virtual model 28 with respect to the reference system. In the exemplary embodiment described above, the reference system is a system of three mutually perpendicular (X, Y, Z) axes, but in other embodiments any other suitable reference system can be used.

After each tooth of virtual model 28 has been oriented with respect to the reference system through the use of one of the above-described protocols or other suitable means, the brackets can be positioned on the virtual model as described above with regard to step 82 (FIG. 2) and FIGS. 16-17. After the brackets have been positioned, the user can have the system generate a data file (step 190, FIG. 2) representing the virtual model and brackets positioned thereon. The data file can be output via a network, stored on a disk, etc. (see FIG. 1). The user can also opt to simulate (step 192, FIG. 2) the outcome of orthodontic therapy if brackets positioned in the manner in which they are positioned on the virtual model were positioned in the same manner on the patient to whom the model corresponds. As described above, a “Simulate Therapy” button can be provided in the screen shown in FIG. 15 or other suitable screen. If the user is not satisfied with the outcome of the simulation, the user can reposition one or more brackets on the virtual model as described above. Although not shown, the system can generate a 3D depiction of the virtual model with the brackets positioned. The user can rotate the model in 3-space to view it from various angles and measure distances between points on the model.

The user can also opt, as indicated by the “Generate Transfer Tray” button shown in FIG. 15, to have the system generate a data file comprising a virtual transfer tray model, a portion of which is illustrated in FIG. 65 as displayed on a screen 194. The data file can be output via a network, stored on a disk, etc. (see FIG. 1). Generating such a data file is described in the above-referenced co-pending patent application and is therefore not described in similar detail herein. Nevertheless, it can be noted that the method can, in an exemplary embodiment, involve generating a virtual transfer tray model having voids 196 with slot-like openings 198 in the bracket positions. As described in the co-pending patent application, the virtual transfer tray model data file is provided to a rapid-prototyping machine or used in a similar process to produce a real, i.e., non-virtual, transfer tray (not shown). The real, i.e., non-virtual, brackets (not shown) are inserted into slot-like openings in the voids of the real transfer tray, and other portions of the voids are filled with adhesive. The (real) transfer tray, with brackets, adhesive, etc. disposed therein, is then transferred to a patient's mouth, where the adhesive is cured by exposing it to ultraviolet light or by other conventional means. When the transfer tray is removed, the brackets remain attached to the patient's teeth by the adhesive.

As described in the co-pending patent application, there can be other elements in addition to the (real) brackets and adhesive, such as a clip (not shown) that serves as a handle for holding the bracket precisely in position in the void until the appliance has been attached to the patient's teeth. The clip also has a portion that occludes the bracket opening during the attachment step to prevent adhesive from entering and blocking the opening. Virtual clips thus can be modeled and positioned along with the brackets during the bracket-positioning step (82, FIG. 2) so that the virtual transfer tray (FIG. 65) includes correspondingly shaped spaces or openings 198 corresponding to those in which the real clips are to be retained when a real transfer tray (not shown) is fabricated. As also described in the co-pending patent application, the openings 198 can include indentations 200 that, in the corresponding real transfer tray (not shown), engage mating dimples or detents that help hold the clip, and thus the bracket to which the clip is attached, in the precise position determined in the bracket-positioning step 82. As described in the co-pending patent application, the clips have handle portions that the orthodontist can grasp to aid inserting the brackets into the transfer tray through the openings. The orthodontist inserts the brackets until the dimples and indentations engage one another such that the clip snaps into the transfer tray. The clip suspends the bracket within the void in whatever position was defined through the use of the computer-implemented positioning method described above, and when adhesive is applied in the void, becomes encapsulated. As further described in the co-pending patent application, the final step after the brackets have been attached to the teeth is to thread the arch wires through the brackets to form the completed orthodontic appliance.

It is to be understood that this invention is not limited to the specific devices, methods, conditions, and/or parameters described and/or shown herein, and that the terminology used herein is for the purpose of describing particular embodiments by way of example only. Thus, the terminology is intended to be broadly construed and is not intended to be limiting of the claimed invention. In addition, as used in the specification including the appended claims, the singular forms “a,” “an,” and “the” include the plural, plural forms include the singular, and reference to a particular numerical value includes at least that particular value, unless the context clearly dictates otherwise. Furthermore, any methods described herein are not intended to be limited to the sequence of steps described but can be carried out in other sequences, unless expressly stated otherwise herein.

Moreover, while certain embodiments are described above with particularity, these should not be construed as limitations on the scope of the invention. It should be understood, therefore, that the foregoing relates only to exemplary embodiments of the present invention, and that numerous changes may be made therein without departing from the spirit and scope of the invention as defined by the following claims.

What is claimed is:

1. A computer-implemented method for positioning orthodontic brackets with respect to a virtual model of a set of teeth, comprising:
selecting a tooth from the virtual model;
displaying a depiction of the selected tooth;
determining a plurality of reference features with respect to the selected tooth;
determining a position of the virtual model with respect to a reference system in response to the plurality of reference features;
positioning a virtual bracket in a position determined with respect to the reference system; and
generating a data file comprising data representing determined positions of virtual brackets with respect to the position of the virtual model.

2. The computer-implemented method claimed in claim 1, wherein the step of selecting a tooth from the virtual model comprises selecting a tooth from a displayed depiction of the set of teeth.

3. The computer-implemented method claimed in claim 1, wherein the step of displaying a depiction of the selected tooth comprises displaying a depiction of a plurality of teeth adjacent the selected tooth.

4. The computer-implemented method claimed in claim 1, wherein the step of displaying a depiction of the selected tooth comprises displaying a first depiction of the selected tooth in a frontal view and displaying a second depiction of the selected tooth in a cross-sectional view.

5. The computer-implemented method claimed in claim 1, wherein the step of displaying a depiction of the selected tooth comprises displaying a first depiction of the selected tooth in a frontal view, displaying a second depiction of the selected tooth in a cross-sectional view, and displaying a third depiction of the selected tooth in a top view.

6. The computer-implemented method claimed in claim 4, wherein the step of displaying a depiction of the selected tooth comprises displaying a user-draggable line in the frontal view and displaying a cross-section taken along the user-draggable line in the cross-sectional view.

7. The computer-implemented method claimed in claim 1, wherein the step of determining a plurality of reference features comprises determining a plurality of points on the selected tooth.

8. The computer-implemented method claimed in claim 7, wherein the step of determining a plurality of points on the selected tooth comprises receiving user-input indications of a plurality of points on the depiction.

9. The computer-implemented method claimed in claim 1, wherein the step of determining a plurality of reference features with respect to the selected tooth comprises displaying the determined plurality of reference features on the depiction of the selected tooth.

10. The computer-implemented method claimed in claim 1, wherein:
the step of determining a plurality of reference features comprises determining a plurality of points on the selected tooth; and
the step of determining a position of the virtual model comprises computing the position of the virtual model with respect to at least one axis of a three-axis reference system in response to at least one of the plurality of points.

11. The computer-implemented method claimed in claim 10, further comprising computing a tangent line tangent to one of the plurality of points, the tangent line defining a facio-lingual angle.

12. The computer-implemented method claimed in claim 10, wherein the step of determining a position of the virtual model comprises computing a line intersecting a plurality of the points.

13. The computer-implemented method claimed in claim 1, wherein the step of positioning a virtual bracket comprises receiving a user-input positioning rule selection.

14. The computer-implemented method claimed in claim 1, wherein the step of positioning a virtual bracket comprises receiving a user-input distance from a tooth feature.

15. The computer-implemented method claimed in claim 1, wherein the step of positioning a virtual bracket comprises:
receiving user-input indicating moving a first virtual bracket; and
computing a position to which the first virtual bracket is moved with respect to the reference system.

16. The computer-implemented method claimed in claim 15, wherein the step of positioning a virtual bracket comprises computing a position to which a second virtual bracket is moved in response to moving the first virtual bracket.

17. The computer-implemented method claimed in claim 15, wherein the step of computing a position to which a second virtual bracket is moved in response to moving the first virtual bracket comprises computing a position for the second virtual bracket having at least one coordinate matching a corresponding coordinate of the position of the first virtual bracket, whereby the first and second virtual brackets are moved together in a coordinated manner in at least one direction.

18. The computer-implemented method claimed in claim 15, wherein the step of computing a position to which the first virtual bracket is moved comprises computing a coordinate indicating a distance along a first axis of a three-axis reference system between the first virtual bracket and a surface of a tooth of the virtual model in response to a coordinate on a second axis of the reference system, whereby the distance is maintained constant while the first virtual bracket is moved.

19. The computer-implemented method claimed in claim 1, wherein the step of positioning a virtual bracket comprises positioning a bracket suspended in free space and offset from the virtual model with no portion of the bracket in contact with a tooth of the virtual model.

20. The computer-implemented method claimed in claim 1, further comprising generating a data file comprising a virtual model of a transfer tray conforming to the set of teeth.

21. The computer-implemented method claimed in claim 20, wherein the step of generating a data file comprising a virtual model of a transfer tray comprises generating a virtual model of a transfer tray having voids for receiving the virtual brackets in the determined positions.

22. A computer program product for positioning orthodontic virtual brackets with respect to a virtual model of a set of teeth, the computer program product comprising a computer-readable medium on which is carried in computer-readable form:
a graphical user interface for allowing a user to select a tooth from the virtual model and for displaying a depiction of the selected tooth;
a virtual model positioner for determining a plurality of reference features with respect to the selected tooth and determining a position of the virtual model with respect to a reference system in response to the plurality of reference features;
a virtual bracket positioner for positioning a virtual bracket in a position determined with respect to the reference system; and
a data file generator for generating a data file comprising data representing determined positions of the virtual brackets with respect to the virtual model.

23. The computer program product claimed in claim 22, wherein the graphical user interface allows a user to select a tooth from a displayed depiction of the set of teeth.

24. The computer program product claimed in claim 22, wherein the graphical user interface displays a depiction of a plurality of teeth adjacent the selected tooth.

25. The computer program product claimed in claim 22, wherein the graphical user interface displays a first depiction of the selected tooth in a frontal view and displays a second depiction of the selected tooth in a cross-sectional view.

26. The computer program product claimed in claim 25, wherein the graphical user interface displays a user-draggable line in the frontal view and displays a cross-section taken along the user-draggable line in the cross-sectional view.

27. The computer program product claimed in claim 22, wherein the virtual model positioner determines a plurality of points on the selected tooth.

28. The computer program product claimed in claim 27, wherein virtual model positioner receives user-input indications of a plurality of points on the depiction via the graphical user interface.

29. The computer program product claimed in claim 27, wherein the virtual model positioner causes the graphical user interface to display the determined plurality of reference features on the depiction of the selected tooth.

30. The computer program product claimed in claim 27, wherein the virtual model positioner further computes a tangent line tangent to one of the plurality of points, the tangent line defining a facio-lingual angle.

31. The computer program product claimed in claim 22, wherein the virtual model positioner computes a line intersecting a plurality of the points.

32. The computer program product claimed in claim 22, wherein the virtual bracket positioner receives a user-input positioning rule selection via the graphical user interface.

33. The computer program product claimed in claim 22, wherein the virtual bracket positioner receives a user-input distance from a tooth feature via the graphical user interface.

34. The computer program product claimed in claim 23, wherein the virtual bracket positioner receives user-input indicating moving a first virtual bracket and computes a position to which the first virtual bracket is moved with respect to the reference system.

35. The computer program product claimed in claim 34, wherein the virtual bracket positioner computes a position to which a second virtual bracket is moved in response to moving the first virtual bracket.

36. The computer program product claimed in claim 34, wherein the virtual bracket positioner computes a position for the second virtual bracket having at least one coordinate matching a corresponding coordinate of the position of the first virtual bracket, whereby the first and second virtual brackets are moved together in a coordinated manner in at least one direction.

37. The computer program product claimed in claim 34, wherein the virtual bracket positioner computes a coordinate indicating a distance along a first axis of a three-axis reference system between the first virtual bracket and a surface of a tooth of the virtual model in response to a coordinate on a second axis of the reference system, whereby the distance is maintained constant while the first virtual bracket is moved.

38. The computer program product claimed in claim 22, wherein the virtual bracket positioner positions a bracket suspended in free space and offset from the virtual model with no portion of the bracket in contact with a tooth of the virtual model.

39. The computer program product claimed in claim 22, wherein the data file generator generates a data file comprising a virtual model of a transfer tray conforming to the set of teeth.

40. The computer program product claimed in claim 40, wherein the data file generator generates a virtual model of a transfer tray having voids for receiving the virtual brackets in the determined positions.
